(19) United States
(12) Patent Application Publication
(10) Pub. No.: US 2014/0121993 A1
(43) Pub. Date: May 1, 2014

(54) CONSIDERATION OF EVIDENCE

(71) Applicants: Roberto Puch-Solis, Teddington (GB); Lauren Rodgers, Teddington (GB)

(72) Inventors: Roberto Puch-Solis, Teddington (GB); Lauren Rodgers, Teddington (GB)

(73) Assignee: LGC LIMITED, Teddington, Middlesex (GB)

(21) Appl. No.: 14/126,615

(22) PCT Filed: Jun. 18, 2012
(86) PCT No.: PCT/GB2012/051395

§ 371 Date: Dec. 16, 2013

(30) Foreign Application Priority Data
Jun. 17, 2011 (GB) 1110302.5

(51) Int. Cl. G06F 19/22

(52) U.S. Cl. CPC G06F 19/22
USPC 702/20

(57) ABSTRACT

In many situations, particularly in forensic science, there is a need to consider one piece of evidence against one or more other pieces of evidence. For instance, it may be desirable to compare a sample collected from a crime scene with a sample collected from a person, with a view to linking the two by comparing the characteristics of their DNA, particularly by expressing the strength or likelihood of the comparison made, a so called likelihood ratio. The method provides a more accurate or robust method for establishing likelihood ratios through the definitions of the likelihood ratios used and the manner in which the probability distribution functions for use in establishing likelihood ratios are obtained The methods provide due consideration of stutter and/or dropout of alleles in DNA analysis, as well as taking into consideration one or more peak imbalance effects, such as degradation, amplification efficiency, sampling effects and the like.

This invention concerns improvements in and relating to the consideration of evidence, particularly, but not exclusively the consideration of DNA evidence.

In many situations, particularly in forensic science, there is a need to consider one piece of evidence against one or more other pieces of evidence.

For instance, it may be desirable to compare a sample collected from a crime scene with a sample collected from a person, with a view to linking the two by comparing the characteristics of their DNA. This is an evidential consideration. The result may be used directly in criminal or civil legal proceedings. Such situations include instances where the sample from the crime scene is contributed to by more than one person.

In other instances, it may be desirable to establish the most likely matches between examples of characteristics of DNA samples stored on a database with a further sample. The most likely matches or links suggested may guide further investigations. This is an intelligence consideration.

In both of these instances, it is desirable to be able to express the strength or likelihood of the comparison made, a so called likelihood ratio.

The present invention has amongst its possible aims to establish likelihood ratios. The present invention has amongst its possible aims to provide a more accurate or robust method for establishing likelihood ratios. The present invention has amongst its possible aims to provide probability distribution functions for use in establishing likelihood ratios, where the probability distribution functions are derived from experimental data. The present invention has amongst its possible aims to provide for the above whilst taking into consideration stutter and/or dropout of alleles in DNA analysis. The present invention has amongst its possible aims to provide for the above whilst taking into consideration one or more peak imbalance effects, such as degradation, amplification efficiency, sampling effects and the like in DNA analysis.

According to a first aspect of the invention we provide a method of comparing a test sample result set with another sample result set, the method including:
providing information for the first result set on the one or more identities detected for a variable characteristic of DNA;
providing information for the second result set on the one or more identities detected for a variable characteristic of DNA; and
comparing at least a part of the first result set with at least a part of the second result set.

The method of comparing may be used to considered evidence, for instance in civil or criminal legal proceedings. The comparison may be as to the relative likelihoods, for instance a likelihood ratio, of one hypothesis to another hypothesis. The comparison may be as to the relative likelihoods of the evidence relating to one hypothesis to another hypothesis. In particular, this may be a hypothesis advanced by the prosecution in the legal proceedings and another hypothesis advanced by the defense in the legal proceedings. The likelihood ratio may be of the form:

$$LR = \frac{p ( c , gs \vert {V}_{p} )}{p ( c , gs \vert {V}_{d} )} = \frac{f ( c \vert gs , {V}_{p} )}{fc \vert gs , {V}_{d} )}$$

where
c is the first or test result set from a test sample, more particularly, the first result set taken from a sample recovered from a person or location linked with a crime, potentially expressed in terms of peak positions and/or heights and/or areas;
gs is the second or another result set, more particularly, the second result set taken from a sample collected from a person, particularly expressed as a suspect's genotype;
Vₚ is one hypothesis, more particularly the prosecution hypothesis in legal proceedings stating “The suspect left the sample at the scene of crime”;
V_{d} is an alternative hypothesis, more particularly the defense hypothesis in legal proceedings stating “Someone else left the sample at the crime scene”.

The method may include a likelihood which includes a factor accounting for stutter. The factor may be included in the numerator and/or the denominator of a likelihood ratio, LR. The method may include a likelihood which includes a factor accounting for allele dropout. The factor may be included in the numerator and/or denominator of an LR. The method may include a likelihood which includes a factor accounting for one of more effects which impact upon the amount of an allele, for instance a height and/or area observed for a sample compared with the amount of the allele in the sample. The effect may be one or more effects which gives a different ratio and/or balance and/or imbalance between observed and present amounts with respect to different alleles and/or different loci. The effect may be and/or include degradation effects. The effect may be and/or include variations in amplification efficiency. The effect may be and/or include variations in amount of allele in a sub-sample of a sample, for instance, when compared with other sub-samples and/or the sample. The effect may be one whose effect varies with alleles and/or loci and/or allele size and/or locus size. The effect may be an effect which causes a reduction in the observed amount compared with that which would have occurred without the effect. The effect may exclude any stutter effect.

The method may include an LR which includes a factor accounting for stutter in both numerator and denominator. The method may include an LR which includes a factor accounting for allele dropout in both numerator and denominator. The method may include an LR which includes a factor accounting for one of more effects which impact upon the amount of an allele, for instance a height and/or area observed for a sample compared with the amount of the allele in the sample in both numerator and denominator.

In an initial embodiment, the method may consider one or more samples which are from a single source.

Particularly in the context of the initial embodiment, the invention may provided that the method is used in an evidential use.

The method may include a step including an LR. The LR may summarise the value of the evidence in providing support to a pair of competing propositions: one of them representing the view of the prosecution (Vₚ) and the other the view of the defense (V_{d}). The propositions may be:

1) Vₚ: The suspect is the donor of the DNA in the crime stain;

2) V_{d}: Someone else is the donor of the DNA in the crime stain.

$$The LR may be \text{:} LR = \frac{f ( c \vert {g}_{s} , {V}_{p} )}{f ( c \vert {g}_{s} , {V}_{d} )}$$

with the crime profile c in a case consists of a set of crime profiles, where each member of the set is the crime profile of a particular locus. The suspect genotype gₛ may be a set where each member is the genotype of the suspect for a particular locus. As a result, the notation may be used as:

c={c_{L(i)}:i=,2, . . . ,nᵢ} and gₛ={g_{s,L(i)}:=1,2, . . . ,nᵢ}

where nᵢ is the number of loci in the profile.

The method may include accounting for peak imbalance. The method may include conditioning on the sum per locus; χₗ₍ᵢ₎, the sum of peak heights in a locus.

The definition of the numerator may be or include:

$$Num = f ( c \vert {g}_{s} , {H}_{p} ) = {\prod }_{i = T}^{{n}_{l}} f ( {C}_{l ( i )} \vert {g}_{s , l ( i )} , {H}_{p} ) {χ}_{l ( i )} , δ )$$

where the peak heights are summed for loci i and δ is a parameter, such as an effect parameter or peak imbalance parameter.

The right-hand side factor of the above equation, ƒ(Cₗ₍ᵢ₎|g_{s,l(i)},H_{P},χₗ₍ᵢ₎,δ)

can be written as: ƒ(Cₗ₍ᵢ₎|gₗ₍ᵢ₎,χₗ₍ᵢ₎,δ) where it is assumed that gₗ₍ᵢ₎ is the genotype of the donor of Cₗ₍ᵢ₎, potentially with the donor varying according to the prosecution hypothesis and the defense hypothesis.

The comparison may include use of: ƒ(Cₗ₍ᵢ₎|gₗ₍ᵢ₎,χₗ₍ᵢ₎,δ).

The definition of the denominator may be or include:

$$Den = f ( c \vert {g}_{s} , {H}_{d} ) = {\prod }_{i = T}^{{n}_{l}} f ( {C}_{l ( i )} \vert {g}_{s , l ( i )} , {H}_{d} , {χ}_{l ( i )} , δ )$$

The right-hand side factor of the above equation, ƒ(Cₗ₍ᵢ₎|gₗ₍ᵢ₎,H_{d}χₗ₍ᵢ₎,δ) can be written as:

$$f ( {C}_{l ( i )} \vert {g}_{s , l ( i )} , {χ}_{l ( i )} , {H}_{d} , δ ) = {\sum }_{i}^{ } f ( {C}_{l ( i )} \vert {g}_{u ( i )} , {χ}_{l ( i )} , {H}_{d} , δ , {g}_{u , l ( i )} ) Pr ( {g}_{u , l ( i )} \vert {g}_{s , l ( i )} )$$

where the function ƒ(Cₗ₍ᵢ₎|gᵤ₍ᵢ₎,χₗ₍ᵢ₎,H_{d},δ,g_{u,l(i)}) can be written as: ƒ(Cₗ₍ᵢ₎|gₗ₍ᵢ₎,χₗ₍ᵢ₎,δ) where we assume that gₗ₍ᵢ₎ is the genotype of the donor of Cₗ₍ᵢ₎.

The factors in the right-hand-side of the equation may be computed using the model of Balding and Nichols. This can be computed using existing formula for conditional genotype probabilities given putative related and unrelated contributors with population structure or not, for instance using the approach defined in J. D. Balding and R. Nichols. DNA profile match probability calculation: How to allow for population stratification, relatedness, database selection and single bands. Forensic Science International, 64:125-140, 1994.

The factor ƒ(Cₗ₍ᵢ₎|gₗ₍ᵢ₎,χₗ₍ᵢ₎,δ) may be substituted by the factor ƒ(c^{(l)}|g₁^{(l)},ω,χ^{(l)}), particularly where g₁^{(l)} is the genotype of the donor of sample c^{(l)}, χ^{(l)} denotes the quantitative measure, for instance peak-height sum or peak area sum, for the locus i and ω is the mixing proportion and/or by the factor ƒ(c^{(l)}|g₁^{(l)},g₂^{(l)},ω,χ^{(l)}), particularly where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

Particularly in the context of the initial embodiment, the invention may provided that the method is used in an intelligence use.

The method of comparing may be used to gather information to assist further investigations or legal proceedings. The method of comparing may provide intelligence on a situation. The method of comparison may be of the likelihood of the information of the first or test sample result given the information of the second or another sample result. The method of comparison may provide a listing of possible another sample results, ideally ranked according to the likelihood. The method of comparison may seek to establish a link between a DNA profile from a crime scene sample and one or more DNA profiles stored in a database.

The method of comparing may provide a link between a DNA profile, for instance from a crime scene sample, and one or more profiles, for instance one or more profiles stored in a database.

The method of comparing may consider a crime profile with the crime profile consisting of a set of crime profiles, where each member of the set is the crime profile of a particular locus. The method may propose, for instance as its output, a list of profiles from the database. The method may propose a posterior probability for one or more or each of the profiles. The method may propose, for instance as its output, a list of profiles, for instance ranked such that the first profile in the list is the genotype of the most likely donor.

The method of comparing may compute posterior probabilities of the genotype given the crime profile for locus i. Given the crime stain, quantity of DNA and effect (such as peak imbalance/EQA parameter), the method may assign probabilities to the genotypes which could be behind the crime stain. The term χₗ₍ᵢ₎ may denotes the sum of peak heights in locus i bigger than reporting threshold Tᵣ. The term δ may denote the effect factor/parameter.

The posterior genotype probability for g*_{U,l(i)} given cₗ₍ᵢ₎,χₗ₍ᵢ₎ and δ may be calculated using Bayes theorem:

$$p ( {g}_{U , l ( i )}^{*} \vert {C}_{l ( i )} , {χ}_{l ( i )} , δ ) = \frac{f ( {c}_{l ( i )} \vert {g}_{U , l ( i )}^{*} , {χ}_{l ( i )} , δ ) p ( {g}_{U , l ( i )}^{*} )}{{\sum }_{{g}_{U , l ( i )}}^{ } f ( {c}_{i} \vert {g}_{U , l ( i )} , {χ}_{l ( i )} , δ ) p ( {g}_{U , l ( i )} )}$$

where p(g_{U,l(i)}) is the probability of genotype g_{U,l(i)} prior to observing the crime profile. The method may provide that its sets a uniform prior to all genotypes so that only the effect of the crime profile is considered. The formula above may be simplified to:

$$p ( {g}_{U , l ( i )}^{*} \vert {C}_{l ( i )} , {χ}_{l ( i )} , δ ) = \frac{f ( {c}_{l ( i )} \vert {g}_{U , l ( i )}^{*} , {χ}_{l ( i )} , δ )}{{\sum }_{{g}_{U , l ( i )}}^{ } f ( {c}_{i} \vert {g}_{U , l ( i )} , {χ}_{l ( i )} , δ )}$$

As above in the evidential uses, both numerator and denominator can be presented in a form based around the core pdf:

ƒ(Cₗ₍ᵢ₎|gₗ₍ᵢ₎,χₗ₍ᵢ₎,δ)

where we assume that gₗ₍ᵢ₎ is the genotype of the donor of Cₗ₍ᵢ₎ or around it substitution: ƒ(c^{(l)}|g₁^{(l)},ω,χ^{(l)}), particularly where g₁^{(l)} is the genotype of the donor of sample c^{(l)}, χ^{(l)} denotes the quantitative measure, for instance peak-height sum or peak area sum, for the locus i and ω is the mixing proportion and/or by the factor ƒ(c^{(l)}|g₁^{(l)},g₂^{(l)},ω,χ^{(l)}), particularly where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

The method may not compute all possible genotypes in a locus. The method may compute/generate genotypes that may lead to a non-zero posterior probability. Starting with the crime profile Cₗ₍ᵢ₎ in this locus, peaks may be designated either as a stutter or alleles. The set of designated alleles may be used for generating the possible genotypes. There may be three possibilities:
1. No peaks bigger than reporting threshold Tᵣ and/or no genotype is generated as there is no peak height information to inform them.
2. One peak bigger than Tᵣ as allele, denoted by a and/or the possible genotypes are {a,a} and {a, Q} where Q denotes any allele other than a.
3. Two peaks bigger than Tᵣ designated as alleles, denoted by a and b and/or the only possible genotype is {a,b}.

The method may consider the position where allele dropout is not involved given the suspect's genotype.

The method may include, for instance where all the expected peaks given the genotype, including any stutter peaks present, are above the detection threshold limit T, the construction of a pdf according to one or more of the following steps:
Step 1 The peak-height sum may be denoted by χₗ₍ᵢ₎. The corresponding means for the peak heights of the alleles and the stutters of the putative donor gₗ₍ᵢ₎ may be denoted by μ_{a,1,l(i)} and μ_{s,1,l(i)} respectively. They may be a function of χₗ₍ᵢ₎. For each allele a of the donor, we may assign the allele mean μ_{a,1,l(i)} to the position of allele a, and the stutter mean μ_{s,1,l(i)} to a position a−1. If the donor is homozygote, we may do the assignment twice.
Step 2 If the donor is a heterozygote, the means may be modified using the factor δ to take into account factors, such as PCR efficiency and degradation, that affect the resulting peak heights. For example, if the donor is a heterozygote in locus l(i) the mean for his/her alleles and stutters may be: δ₁xμ_{a,1,l(i)} and δ₁xμ_{s,1,l(i)} for the low-molecular-weight allele and δ₂xμ_{a,1,l(i)} and δ₂xμ_{s,1,l(i)} for the high-molecular-weight allele.
Step 4 The variances for each allele and stutter may be obtained as a function of their corresponding means. In another step we may add random Gamma variables. A condition for a close form calculation of this addition may be that the β-parameters are the same. Also in a later step, we may divide each Gamma by the overall sum of peak height to account for using the sum of peak heights in this locus. A closed form calculation can be done if all β parameters may be the same. The conditioned on the β-parameters may be obtained by estimating a line between the points form by the means, in the x-axis, and the variances, in the y-axis. A regression line with zero intercept may be fitted to obtain:

\hat{σ}²=κ₂xμ

So, if peak i has mean and variance (μᵢ,ρᵢ²),

β=μ₁/σᵢ²=μᵢ/κ₂xμᵢ)=1/κ₂

may be true, regardless of the value of μ_{I}.
Step 5 The shape (α) and rate (β) parameters may be obtained from the mean and the variances.
Step 6 The alpha parameters for alleles and stutters in the same allele position may be added to obtain an overall α for that allele position. This may provide the parameters of a Gamma distribution for each allele position.
Step 7 To account for using the sum of peak height in the locus, the collection of Gamma pdfs whose peak heights are above the peak-height reporting limit may be converted to a Dirichlet pdf. This may be achieved in closed form because all β's are the same. The resulting Dirichlet pdf may inherit the α parameters of the Gammas.

In a second consideration, below, we consider the position where allele dropout is involved given the suspect's genotype. The consideration may reflect one or more of the heights in the profile being below the threshold T. In such a case, the peak which is below the threshold may not form part of the value of χₗ₍ᵢ₎ and the correction may only applied to those peaks above the threshold.

In the case of a non-adjacent heterozygous alleles case, when h_{s,1,l(i)}<T then the PDF may be given by:

ƒ(h_{s,1,l(i)}<T,h_{a,1,l(i)},h_{s,2,l(i)}|gₗ₍ᵢ₎={a_{1,l(i)},a_{2,1,l(i)}},χₗ₍ᵢ₎,δ)

which can be expressed as:

F(T|α_{s,1,l(i)},β)ƒ_{Dir}(π_{a,1,l(i)},π_{s,2,l(i)}π_{a,2,l(i)},|α_{a,1,l(i)},α_{s,2,l(i)},α_{a,2,l(i)},)

where F is the cdf of a gamma distribution with parameters α_{s,1,l(i)} and β.

If there is more than one peak below the threshold T, then there may be a corresponding number of f.

The method may include a consideration of whether the peaks in the crime profile are either bigger or smaller than the reporting threshold Tᵣ, or not present at all. The method may treat missing peaks and peaks smaller than Tᵣ as peaks that have dropped out. We may partition the crime profile for a given pair of genotype as:

cₗ₍ᵢ₎={h:hεcₗ₍ᵢ₎,h<Tᵣ}∪{h:hεcₗ₍ᵢ₎,h≧T}

The resulting pdf may be given by:

$$f ( {c}_{l ( i )} \vert {g}_{1 , l ( i )} , {g}_{2 , l ( i )} , {χ}_{l ( i )} , δ , ω ) = f ( π \vert α ) x {\prod }_{\{ h \text{:} h ∈ {c}_{l ( i )} , h < {T}_{r} \}}^{ } F ( T \vert {α}_{h} , {β}_{h} )$$

ƒ(π|α) is a Dirichlet pdf with parameters:

α=∪{αₕ:hεcₗ₍ᵢ₎,h≧Tᵣ} and

π=∪{(h/χ′ₗ₍ᵢ₎: hεcₗ₍ᵢ₎,h≧Tᵣ}

where aₕ is the alpha parameter of the associated Gamma pdf in the corresponding position of height h.

*χ′ₗ₍ᵢ₎=Σ_{hεc}_{ₗ₍ᵢ₎}_{,h≧T}_{ᵣ}h is the sum of peak heights bigger than reporting threshold Tᵣ.
F(Tᵣ|αₕ,βₕ) is the CDF of a Gamma distribution with parameters αₕ and βₕ for the peak in the position of h calculated as described above.

The method may include the use of a peak imbalance parameter/effective amplified quanitity (EQE) parameter, δ, particularly in the form of a set of δ's, such that there is for instance one for each of the alleles. Each of the peak imbalance parameters in the set can be used to adjust the means for the alleles.

The approach preferably models the effect, such as degradation and other peak imbalance effects, prior to any knowledge of the suspect's genotype. For each locus, the molecular weight of the peaks in the profile may be associated with the sum of the heights. As the molecular weight of the locus increase, a reduction in the sum of the peak heights may be estimated.

The method may provide that for locus l(i), there are a set of peak heights:
hₗ₍ᵢ₎={h_{j,l(i)}): j=1, . . . nₗ₍ᵢ₎}. Each height may have an associated base pair count:
bₗ₍ᵢ₎={b_{j,l(i)}: j=1, . . . nₗ₍ᵢ₎}. An average base pair count may be used as a measure of molecular weight for the locus, weighted by peak heights. This may be defined as:

$${\overline{b}}_{l ( i )} = \frac{{\sum }_{j = 1}^{n} {b}_{j , l ( i )} {h}_{j , l ( i )}}{{χ}_{l ( i )}}$$

where

$${χ}_{l ( i )} = {\sum }_{j = 1}^{{n}_{l ( i )}} {h}_{j , l ( i )}$$

and so the degradation model may be defined as: χₗ₍ᵢ₎=d₁+d₂ b̅ₗ₍ᵢ₎ where d₁ and d₂ are the same for all loci.

The parameters d₁ and d₂ may be calculated using the least squared estimation. As some loci may behave differently to degradation etc, the sum of the peak heights for these loci may be treated as outliers. To deal with these outliers, a Jacknife method may be used. If there are n_{L} loci with peak height and base pair information, then the approach may include one or more or all of:
1. fitting a regression model n_{L} times, removing the i^{th} value of the sets {χₗ₍ᵢ₎: i=1, . . . n_{L}} and { b̅ₗ₍ᵢ₎:i=1, . . . n_{L}}
2. using the regression model to produce a prediction interval, \hat{χ}ₗ₍ᵢ₎=/−2σ where σ is the standard deviation of the residuals in the fitted regression line.
3. when the sum of the peak height χᵢ, which is not used for the estimation of the regression line, does not lie within the prediction interval, then consider it as an outlier.
4. removes any outliers from the data set and refits the model, after the n_{L} models have been produced.
5. the values of d₁ and d₂ being extracted from the model estimated without outliers.

If the effect on in the profile is negligible, peak height variability may cause the estimated value of d₂ to be greater than zero. In such cases, d₂ may be set as 0 and/or d₁ as 1.

In the deployment of the model of the parameter, at locus l(i) there may be a crime profile with peaks having allele designations α_{j,l(i)} and base pair counts bₗ₍ᵢ₎={b_{j,l(i)}: j=1, . . . nₗ₍ᵢ₎}. If degradation were not being accounted for, then given the sum of the peak heights χₗ₍ᵢ₎ it is possible to obtain a mean and a variance from a Gamma distribution.

When considering the effect, the same Gamma distribution may be used, but the model may be used to adapt the Gamma pdf to account for the molecular weight of the allele.

As previously mentioned, peak heights increase with the sum of peak heights χₗ₍ᵢ₎ and therefore the mean and variance may also increase accordingly. If an allele is of high molecular weight, a reduction of χₗ₍ᵢ₎ may result in a reduction in the mean and variance. The model may reduce or increases the χₗ₍ᵢ₎ associated with an allele according to the effect by using an appropriate δ for that allele.

The appropriate δ's may be calculated as follows using the degradation model χₗ₍ᵢ₎=d₁+d₂.

The degradation parameter associated with alleles α_{j,l(i)} may be defined as δ_{j,l(i)} so that the sum of peak heights associated with this allele are δ_{j,l(i)}·χₗ₍ᵢ₎.

For each allele the model may be used to estimate the associated peak height sum:

\hat{χ}_{j,l(i)}+d₁+d₂b_{j,l(i)}

The calculations of δ may be made such that the ratio of the estimated peak height sums are preserved; that is:

$$\frac{{\hat{χ}}_{j , l ( i )}}{{\hat{χ}}_{j + 1 , l ( i )}} = \frac{{δ}_{j , l ( i )} \cdot {χ}_{l ( i )}}{{δ}_{j + 1 , l ( i )} \cdot {χ}_{l ( i )}}$$

To do this, a set of nₗ₍ᵢ₎−1 equations with nₗ₍ᵢ₎ unknowns, may be provided:

$$\frac{{\hat{χ}}_{j , l ( i )}}{{\hat{χ}}_{j + 1 , l ( i )}} = \frac{{δ}_{j , l ( i )}}{{δ}_{j + 1 , l ( i )}}$$

The ratios on the left-hand side may be obtained from the degradation model and the δ's may be the unknown variables. A restriction is set, such that the average peak height sum in the locus remains the same after the application of the δ's, may be:

$$\frac{{\sum }_{j = 1}^{{n}_{l ( i )}} {δ}_{j , l ( i )} \cdot {χ}_{l ( i )}}{{n}_{l ( i )}} = {χ}_{l ( i )}$$

which gives a further equation with the δ's as unknown quantities. This may allow a solution to be found as there are nₗ₍ᵢ₎ equations in the system and nₗ₍ᵢ₎ unknowns.

The ratio of the estimated peak height sum may be denoted:

$${r}_{j , l ( i )} = \frac{{\hat{χ}}_{j , l ( i )}}{{\hat{χ}}_{j + 1 , l ( i )}} , \\ j = 1 , 2 , … {n}_{l ( i )} - 1$$

$${r}_{j , l ( i )} = 1 , \\ j = {n}_{l ( i )}$$

The degradation parameters δ's, may be given by:

$${δ}_{j , l ( i )} = \frac{{n}_{l ( i )} {\prod }_{k = j}^{{n}_{l ( i )}} {r}_{k , l ( i )}}{{\sum }_{k = 1}^{{n}_{l ( i )}} {\prod }_{k}^{{n}_{l ( i )}} {r}_{k , l ( i )}}$$

The stutter associated with an allele, may have the same degradation parameter δ as the allele because the starting DNA molecule is the same in each case.

In another embodiment, the method may consider one or more samples which are from multiple sources. Two and/or three and/or more sources for the sample may be present.

Particularly in the context of an initial embodiment, the invention may provided that the method is used in an evidential use.

The method may provide that the comparison includes a numerator stated as:

$$Num = f ( c \vert {g}_{U 1} , {g}_{U 2 s} , {H}_{p} ) = {\prod }_{i = T}^{{n}_{l}} f ( {c}_{l ( i )} \vert {g}_{U 1 , l ( i )} , {g}_{U 2 , l ( i )} , {H}_{P} , {χ}_{l ( i )} , δ )$$

The method may provide that the comparison includes a denominator stated as:

$$Den = f ( c \vert {g}_{U 1} , {g}_{U 2 } , {H}_{d} ) = {\prod }_{i = T}^{{n}_{l}} f ( {C}_{l ( i )} \vert {g}_{U 1 , l ( i )} , {g}_{U 2 , l ( i )} , {H}_{d} , {χ}_{l ( i )} , δ )$$

The method may include the consideration of the pdf: ƒ(cₗ₍ᵢ₎|g_{U,1,l(i)},g_{U,2,l(i)},χₗ₍ᵢ₎,δ)

Particularly in the context of the initial embodiment, the invention may provided that the method is used in an intelligence use.

The method may compute the posterior probability p(g_{U,1,l(i)},g_{U,2,l(i)}|Cₗ₍ᵢ₎,χₗ₍ᵢ₎,δ) of pair of genotypes given the peak heights in the profile. This probability may be computed using theorem. The probability may be computed as:

$$p ( {g}_{U , 1 , l ( i )}^{*} , {g}_{U , 2 , l ( i )}^{*} \vert {C}_{l ( i )} , {χ}_{l ( i )} , δ ) = \frac{f ( {c}_{l ( i )} \vert {g}_{U , 1 , l ( i )}^{*} , {g}_{U , 2 , l ( i )}^{*} , {χ}_{l ( i )} , δ ) p ( {g}_{u , 1 , l ( i )}^{*} , {g}_{U , 2 , l ( i )}^{*} )}{{\sum }_{{g}_{U , 1 , l ( i ) , {g}_{U , 2 , l ( i )}}}^{ } f ( {c}_{l ( i )} \vert {g}_{U , 1 , l ( i )} , {g}_{U , 2 , l ( i )} , {χ}_{l ( i )} , δ ) p ( {g}_{U , 1 , l ( i )} , {g}_{U , 2 , l ( i )} )}$$

The method may assume that the prior probability for the pair of genotypes is the same for any genotype combination in the locus. The method may state the probability as:

$$p ( {g}_{U , 1 , l ( i )}^{*} , {g}_{U , 2 , l ( i )}^{*} \vert {C}_{l ( i )} , {χ}_{l ( i )} , δ ) = \frac{f ( {c}_{l ( i )} \vert {g}_{U , 1 , l ( i )}^{*} , {g}_{U , 2 , l ( i )}^{*} , {χ}_{l ( i )} , δ )}{{\sum }_{{g}_{U , 1 , l ( i ) , {g}_{U , 2 , l ( i )}}}^{ } f ( {c}_{l ( i )} \vert {g}_{U , 1 , l ( i )} , {g}_{U , 2 , l ( i )} , {χ}_{l ( i )} , δ )}$$

The pdf for the peak heights given a pair of putative genotypes may be calculated using the formula below:

$$f ( {c}_{l ( i )} \vert {g}_{U , 1 , l ( i )} , {g}_{U , 2 , l ( i )} , {χ}_{l ( i )} , δ ) = {\sum }_{ω}^{ } f ( {c}_{l ( i )} \vert {g}_{U , 1 , l ( i )} , {g}_{U , 2 , l ( i )} , {χ}_{l ( i )} , δ , ω ) p ( ω )$$

where ω is the mixing proportion.

The method may provide that not all pair of genotypes will have a non-zero probability and/or be calculated. The method may use the crime profile to guess pair of genotypes that may have zero probability. The method may designate peaks in the crime profile as alleles or stutters. The genotypes may be produced based on the peaks designated as alleles. One or more of the following cases may be considered in the method:
1. No peaks bigger than the reporting threshold Tᵣ and/or no genotypes are generated.
2. One peak bigger than Tᵣ is designated as allele, denoted by a and/or there are two possible genotypes {a, a} and a, Q} where Q denoted any allele other than a and/or any pairing of these genotypes is possible: ({a, a}, {a, a}), ({a, a}, {a, Q}) and ({a, Q}, {a, Q}).
3. Two peaks bigger than Tᵣ designated as alleles, denoted by a and b and/or the possible genotypes are {a, a}, {a, b}, {a, Q}, {b, b}, {b, Q} and {Q, Q} where Q is any allele other than a and b and/or any combination of pair of genotypes whose union contains a, b is a possible pair of genotypes: {a, a} with any genotype that contains b; {a, b} with any genotype in the list; {a, Q} with any genotype that contains b; {b, b} with any genotype that contains a; {b, Q} with any genotype that contains a; and {Q, Q} with {a, b}.
4. Three peaks bigger than Tᵣ, denoted by a, b and/or this case follows exactly the same logic as in the case above and/or there are 10 genotypes that are possible from allele set: a, b, c and Q, where Q denotes any allele other than a, b and/or all genotype pairs whose union contains a, b, c.
5. Four peaks bigger than Tᵣ are designated as alleles, denoted by a, b, c and d and/or in this case there are 10 possible pair of genotypes and/or any genotype pair whose union is a, b, c, d is considered as a possible genotype pair.

The interest may lie on genotype pairs such that the first and second genotype corresponds to the major and minor contributor respectively. The calculation of the posterior probabilities in this section may be done for all possible combinations of genotypes and mixing proportions. Moving from all combinations of genotypes to major minor may require folding the space of all combinations of genotypes and mixing proportions in two.

The method may consider:

$$Pr ( {G}_{M} = {g}_{1} , {G}_{m} = {g}_{2} \vert {c}_{l ( i )} ) = {\sum }_{ω ∈ Ω \geq 0.5}^{ } Pr ( {G}_{M} = {g}_{1} , {G}_{m} = {g}_{2} \vert {c}_{l ( i )} , ω ) p ( ω )$$

where Ω≧0.5 is a discreet set of mixing proportions greater or equal to 0.5. When ω>0.5 the first factor in the summation in the above equation may be:

$$\begin{matrix}Pr ( {G}_{M} = {g}_{1} , {G}_{m} = {g}_{2} \vert {c}_{l ( i )} ω ) = Pr ( {G}_{1} = {g}_{1} , {G}_{2} = {g}_{1} \vert {c}_{l ( i )} ω ) + \\ Pr ( {G}_{1} = {g}_{2} , {G}_{2} = {g}_{1} \vert {c}_{l ( i )} , 1 - ω ) \\ = 2 \times Pr ( {G}_{1} = {g}_{1} , {G}_{2 m} = {g}_{2} \vert {c}_{l ( i )} , ω )\end{matrix}$$

$$If ω = 0.5 ;$$

$$Pr ( {G}_{M} = {g}_{1} , {G}_{m} = {g}_{2} \vert {c}_{l ( i )} ω ) = Pr ( {G}_{1} = {g}_{1} , {G}_{2} = {g}_{2} \vert {c}_{l ( i )} , ω ) .$$

The method, particularly for mixed source samples, may consider the mixing proportion involved. The posterior probability of the mixing proportion given the peaks heights across all loci may be used, and may be expressed as:

$$f ( {c}_{l ( i )} \vert {g}_{U , 1 , l ( i )} , {g}_{U , 2 , l ( i )} ) = {\sum }_{ω}^{ } f ( {c}_{l ( i )} \vert {g}_{U , 1 , l ( i )} , {g}_{U , 2 , l ( i )} , ω ) p ( ω \vert {c}_{l ( 1 )} , {c}_{l ( 2 )} , … {c}_{l ( n Loci )} )$$

The method may provide that for each locus l(i) it generates a set of possible genotype pairs of potential contributors of the crime profile cₗ₍ᵢ₎. The j-th instance of the genotype of the contributor 1 and 2 may be denoted by g_{U1,j,l(i)} and g_{U2,j,l(i)}, respectively, where n_{g} is the number of genotype pairs. The method may calculate the posterior probability of pair of genotypes given the peak heights in the crime profile cₗ₍ᵢ₎. The calculation may use a probability distribution for mixing proportion. A sequential method for calculating the posterior distribution of mixing proportion given peak heights across loci may be used.

The mixing proportion may be a continuous quantity in the interval (0, 1). A discrete probability distribution may be used. Assume that we have mixing proportions ω={ωₖ: k=1, . . . , n_{ω}}, where n_{ω} is the number of mixing proportions considered, the method may set a prior distribution for mixing proportion as uniform over the discrete values. Using Bayes theorem, the posterior distribution for mixing proportion given the peak heights in locus i may be:

$$p ( {ω}_{k} \vert {c}_{l ( i )} , {χ}_{l ( i )} , δ ) = \frac{f ( {c}_{l ( 1 )} \vert {χ}_{l ( 1 )} , {ω}_{k} , δ ) p ( {ω}_{k} )}{{\sum }_{m = 1}^{{n}_{ω}} f ( {c}_{l ( 1 )} \vert {χ}_{l ( 1 )} , δ , {ω}_{m} ) p ( {ω}_{m} )}$$

The posterior distribution of mixing proportion for locus i, i=2, 3, . . . , n_{L} may be given by:

$$p ( {ω}_{k} \vert {c}_{l ( 1 )} , … , {c}_{l ( i )} , {χ}_{l ( 1 )} , … {χ}_{l ( i )} , δ ) = \frac{f ( {c}_{l ( i )} \vert {χ}_{l ( i )} , {ω}_{k} , δ ) p ( {ω}_{k} ) \vert \vert {c}_{l ( i )} , … , {c}_{l ( i - 1 )} , {χ}_{l ( 1 )} , … {χ}_{l ( i - 1 )} , δ}{\begin{matrix}{\sum }_{m = 1}^{{n}_{ω}} f ( {c}_{l ( i )} \vert {χ}_{l ( i )} , δ , {ω}_{m} ) \\ p ( {ω}_{m} \vert {c}_{l ( 1 )} , … , {c}_{l ( i - 1 )} , {χ}_{l ( i - 1 )} , … {χ}_{l ( i - 1 )} , δ )\end{matrix}}$$

where ƒ(ωₖ|cₗ₍ᵢ₎,χₗ₍ᵢ₎, i=1, 2, . . . n_{L} is defined in the following paragraph. If there are any loci with no information they may be ignored in the calculation as having no information.

The probability density of the peak height in the crime profile cₗ₍ᵢ₎ at locus l(i) for a given mixing proportion ωₖ may be given by:

$$f ( {c}_{l ( i )} \vert {χ}_{l ( i )} , {ω}_{k} ) = {\sum }_{j = 1}^{{n}_{g}} f ( {c}_{l ( i )} \vert {g}_{U 1 , j , l ( i )} , {g}_{U 2 , j , l ( i )} , {χ}_{l ( i )} , {ω}_{k} ) p ( {g}_{U 1 , j , l ( i )} , {g}_{U 2 , j , l ( i )} )$$

where p(g_{U1,j,l(i)},g_{U2,j,l(i)}) is the probability of the two genotypes prior to observing the crime profile. This may be based on the assumption of an equal probability of all genotype pairs:

$$p ( {g}_{U 1 , j , l ( i )} , {g}_{U 2 , j , l ( i )} ) = \frac{1}{{n}_{g}}$$

This

$$\frac{1}{{n}_{g}}$$

may cancel out in the following equations and it may thus be ignored. Then the probability density in the above equation may simplify to:

$$f ( {c}_{l ( i )} \vert {χ}_{l ( i )} , {ω}_{k} ) = {\sum }_{j = 1}^{{n}_{g}} f ( {c}_{l ( i )} \vert {g}_{U 1 , j , l ( i )} , {g}_{U 2 , j , l ( i )} , {χ}_{l ( i )} , {ω}_{k} )$$

The consideration may include the use of the function ƒ(cₗ₍ᵢ₎|gₗ₍ᵢ₎,g_{2,l(i)},ω,χₗ₍ᵢ₎,δ)

The method may construct the pdf using one or more or all of the following steps:
Step 1 The associated peak-height sum for donor 1 may be ωxχₗ₍ᵢ₎. The corresponding means for the peak height of the alleles and the stutters of this donor may be denoted by μ_{a,1,l(i)} and μ_{s,1,l(i)}, respectively. They may be obtained as a function of χ_{D2}. For each allele a of donor 1, we may assign the allele mean μ_{a,1,l(i)} to the position of allele a, and the stutter mean μ_{s,1,l(i)} to position a−1. If the donor is homozygote, we may do the assignment twice.
Step 2 The associated peak-height sum for donor 2 may be (1−ω)xχₗ₍ᵢ₎ with associated mean for allele and stutters: μ_{a,2,l(I)} and μ_{s,2,l(I)}. The assignment of means may be done as in step 1.
Step 3 If a donor is a heterozygote, the means may be modified to take into account factors, such as PCR efficiency and degradation, that affect the resulting peak heights. For example, if donor 1 is a heterozygote in locus l(i), the mean for his/her alleles and stutters may be: δ₁xμ_{a,1,l(I)} and δ₁xμ_{s,1,l(I)} for the low-molecular-weight allele and δ₂xμ_{a,1,l(I)} and δ₂μ_{s,1,l(I)} for the high-molecular-weight allele.
Step 4 The variances for each allele and stutter may be obtained as a function of means. In later step we may need to add random Gamma variables. A condition for a close form calculation may be that the β-parameters are the same. Also in a later step, we may divide each Gamma by the overall sum of peak height to account for using the sum of peak heights in this locus. A closed form calculation can be done if all β parameters are the same. The conditioned on the β-parameters can be obtained by estimating a line between the points formed by the means, in the x-axis, and the variances, in the y-axis. A regression line with zero intercept may be fitted to obtain:

\hat{σ}²=κ₂xμ

So, if peak i has mean and variance (μᵢ,σᵢ²),

β=μᵢ/σᵢ²=μᵢ/(κ₂xμᵢ)=1/κ₂

regardless of the value of μᵢ.
Step 5 The shape (α) and rate (β) parameters may be obtained from the mean (μ) and the variances (\hat{σ}²) using the known formulae α=(μ/\hat{σ}²)² and β=μ/\hat{σ}².
Step 6 The alpha parameters for alleles and stutters in the same allele position may be added to obtain an overall α for that position.
Step 7 To account for using the sum of peak height in the locus, the collection of Gamma pdfs whose peak heights are above the peak-height reporting limit may be converted to a Dirichlet pdf. This may be achieved in closed form because all β's are the same. The resulting Dirichlet pdf may inherit the α parameters of the Gammas.

The method may include that the peaks in the crime profile are either bigger or smaller than the reporting threshold Tᵣ, or not present at all. The method may treat missing peaks and peaks smaller than Tᵣ as peak that has dropped out. The method may consider the crime profile for a given pair of genotype as:

cₗ₍ᵢ₎={h:hεcₗ₍ᵢ₎,h<Tᵣ}∪{h:hεcₗ₍ᵢ₎,h≧Tᵣ}

The resulting pdf may be given by:

$$f ( {c}_{l ( i )} \vert {g}_{1 , l ( i )} , {g}_{2 , l ( i )} , {χ}_{l ( i )} , δ , ω ) = f ( π \vert α ) \times {\prod }_{\{ h : h ∈ {c}_{l ( i )} , h < {T}_{r} \}} F ( T \vert {α}_{h} , {β}_{h} )$$

The terms are explained below:
ƒ(π|α) may be a Dirichlet pdf with parameters

α=∪{αₕ:hεcₗ₍ᵢ₎,h≧Tᵣ} and

π=∪{h/χ′ₗ₍ᵢ₎:hεcₗ₍ᵢ₎,h≧Tᵣ}
where aₕ may be the alpha parameter of the associated Gamma pdf in the corresponding position of height h. χ′ₗ₍ᵢ₎=Σ_{hεc}_{ₗ₍ᵢ₎}_{,h≧T}_{ᵣ}h may be the sum of peak heights bigger than reporting threshold Tᵣ.
F(Tᵣ|αₕ,βₕ) may be the CDF of a Gamma distribution with parameters αₕ and βₕ for the peak in the position of h calculated as described above.

The method may provide that in locus l(i) there are the set of peak heights hₗ₍ᵢ₎={h_{j,l(i)}: j=1, . . . , nₗ₍ᵢ₎}. Each height may have an associated base pair count bₗ₍ᵢ₎={b_{j,l(i)}: j=1, . . . , nₗ₍ᵢ₎}. An average base pair count, weighted by peak heights, may be used as a measure of molecular weight for the locus. More specifically, this may be defined as:

$${\overline{b}}_{l ( i )} = \frac{{\sum }_{j = 1}^{n} {b}_{j , l ( i )} {h}_{j , l ( i )}}{{χ}_{l ( i )}}$$

$$where$$

$${χ}_{l ( i )} = {\sum }_{j = 1}^{{n}_{l ( i )}} {h}_{j , l ( i )}$$

We may define the EAQ model as: χₗ₍ᵢ₎=d₁+d₂ b̅ₗ₍ᵢ₎ where d₁ and d₂ are the same for all loci.

The sum of peak heights χₗ₍ᵢ₎ may be assumed to be a linear function of the weighted base-pair average,

$${\overline{b}}_{l ( i )} = \frac{{\sum }_{j = 1}^{n} {b}_{j , l ( i )} {h}_{j , l ( i )}}{{χ}_{l ( i )}} .$$

The method may provide a calculation of the parameters d₁ and d₂, for instance by calculated using least squared estimation. However some loci may behave differently, and therefore the sum of peak heights of these loci can be treated as outlier. We may use a Jackknife method to deal with this problem. If there are n_{L} loci with peak height and base pair information, then the method may use one or more or all of the following steps.
1. Fit the regression model n_{L} times, removing the i^{th} value of the sets

{χₗ₍ᵢ₎:i=1, . . . n_{L}} and { b̅ₗ₍ᵢ₎:i=1, . . . n_{L}}.
2. Use least-squares estimation to produce a prediction interval, \hat{χ}ₗ₍ᵢ₎±2σ, where σ is the standard deviation of the residuals in the fitted regression line.
3. If the sum of peak height χᵢ which was not used for the estimation of the regression line, does not lie within the prediction interval then we consider it an outlier.
4. After the n_{L} models have been produced we remove any outliers from the dataset and re-fit the model.
5. The values of d₁ and d₂ are extracted from the model estimated without outliers.
6. If the degradation in the profile is negligible, peak height variability may cause the estimated value of d₂ to be greater than zero. In this case we set d₂=0 and d₁=1.

The method may include use of the peak imbalance parameter or EAQ model for taking into account EAQ within a locus. EAQ between loci may be taken into account by conditioning on the sum of peak height per locus. The EAQ model may be used when the pdf of the peak heights for single and two-person profiles is deployed. More specifically, it may be deployed for each heterozygote donor.

Assume that at locus l(i) we have a putative heterozygote donor with alleles a₁,l(i) and a₂,l(i) with corresponding molecular weights in base pairs bᵢ,l(i) and a₂,l(i), respectively, the method may include one or more of: if we were not considering EAQ, given the sum of peak heights χₗ₍ᵢ₎ for this locus we can obtain a mean μₗ₍ᵢ₎ and variance σₗ₍ᵢ₎² of a Gamma distribution that models the behaviour of a peak height; if H_{j,l(i)} denotes the random variable for the height corresponding the allele s_{j,l(i)}, then:

H_{j,l(i)}˜Γ(μₗ₍ᵢ₎,σₗ₍ᵢ₎²|χₗ₍ᵢ₎),j=1,2.

The same Gamma pdf may be used for any allele in the locus. The EAQ model issued may adapt the Gamma pdf by taking into account the molecular weight of the allele. The EAQ model may be used to calculate a pair of factors δ₁ and δ₂ so that the mean values of the Gamma distribution are adjusted accordingly. The new mean may be given by:

μ_{j,l(i)}=δxμₗ₍ᵢ₎,j=1,2.

The method may include a method for calculating δ₁ and δ₂ using the slope d₂ of the EAQ regression line. The first condition that the δ's must fulfil may be that the slope of a line going through the coordinates (b_{1,l(i)},μ_{1,l(i)}) and (b_{2,l(i)},μ_{2,l(i)}) is the same as the slope d₂ of the EAQ regression line, i.e.:

$$\frac{{μ}_{1 , l ( i )} - {μ}_{2 , l ( i )}}{{b}_{1 , l ( i )} - {b}_{2 , l ( i )}} = {d}_{2}$$

The second condition that the δ's must fulfilled may be the preservation of the mean μₗ₍ᵢ₎:

μ_{1,l(i)}−μ_{2,l(i)}/2=μₗ₍ᵢ₎

### Substituting

$${μ}_{j , l ( i )} = δ x {μ}_{l ( i )} , j = 1 , 2 \cdot in \frac{{μ}_{1 , l ( i )} - {μ}_{2 , l ( i )}}{{b}_{1 , l ( i )} - {b}_{2 , l ( i )}} = {d}_{2} and$$

$$\frac{{μ}_{1 , l ( i )} - {μ}_{2 , l ( i )} }{2} = {μ}_{l ( i )}$$

we obtain two equations with two unknowns δ₁ and δ₂. The solution of the equations may be:

$${δ}_{1} = \frac{{d}_{2} ( {b}_{1 , l ( i )} - {b}_{2 , l ( i )} + 2 {μ}_{l ( i )}}{2 {μ}_{l ( i )}}$$

$${δ}_{2} = 2 - {δ}_{1}$$

The stutter associated with the allelic peak may be treated as having the same degradation factor because it is the starting DNA molecules of the allele that is affected by degradation.

The invention, including any and all of its aspects, may alternatively and/or additionally provided from the following options and possibilities.

The method may include a consideration of the size of the alleles in and/or across the loci and/or the identity of the loci and the provision of an adjustment arising there from. The adjustment may be provided to account for degradation and/or amplification efficiency and/or inhibition, for instance arising from the quantity of DNA present in the sample, and/or chemical inhibition, for instance when this arises from the environment the sample was collected from, for instance the presence of a particular dye.

The method may provide the use of a Gamma distribution as the form of the distribution used to represent a peak in the method. This may be in the operation of the method and/or in a method used to obtain the model used in the method. The Gamma distribution may be defined by one or more parameters, such as a shape parameter α and/or a rate parameter β. Preferably the β parameter is the same for one or more or all the alleles in a locus. Preferably the β parameter is different between one or more or all loci. Preferably the α parameter is different between one or more or all alleles and/or one or more or all loci. Preferably the α parameter and/or the β parameter has the same characteristics for an allele peak and stutter peak at one or more or all of the allele sizes and/or at one or more or all of the loci.

The method may provide that the construction of ƒ(c^{(l)}|g₁^{(l)},g₂^{(l)},ω,χ^{(l)}) includes two or more steps. In a first step, the α parameters for the alleles and stutters of genotypes g₁^{(l)} and g₂^{(l)} may be calculated. In a second step, the factors of the probability density functions, pdf's, may be determined.

The method may provide that the genotypes of the major and minor donors in the mixture are denoted as gₗ₍ᵢ₎={a_{gi,1},a_{gi,2}}, i=1,2 respectively. The base pair counts of the alleles may be denoted with the same indices, i.e. bp_{gi,j} is the base count of a_{gi,j}. A total of eight α parameters may be obtained, for instance of the form:

A_{g1,g2}^{(l)}={α_{a,g1,1}^{(l)},α_{s,g1,1}^{(l)}α_{a,g1,2}^{(l)}α_{s,g1,2}^{(l)}α_{a,g2,1}^{(l)}α_{s,g2,1}^{(l)}α_{a,g2,2}^{(l)}α_{s,g2,2}^{(l)}},

where a_{i,gi,k}^{(l)} is the α parameter for either an allele (i=a) or a stutter (i=s), for the major (j=1) or the minor (j=2) donors for the first (k=1) or second (k=2) allele of the corresponding genotype.

The method may provide that the method defined for the calculation of α_{a,g1,1} and α_{s,g,1,1} is used in an equivalent manner to provide the parameters for other alleles and/or loci and/or genotypes.

The method may provide that the major donor contributes with (ω×100) % of the DNA, and preferably for the calculation of ωχ/bp_{g1,1}. If the number from this calculation is greater than the upper limit of the dropout region for alleles then the α parameter is preferably calculated using equation:

$${α}_{i}^{( l )} = \frac{{κ}_{1 , i}^{( l )}}{{κ}_{2 }^{( l )}} \times \frac{{χ}^{( l )}}{{bp}_{a}^{( l )}} , i = a , s and {β}_{a}^{( l )} = {β}_{s}^{( l )} = \frac{1}{{κ}_{2}^{( l )}} .$$

If the number from this calculation is otherwise, then preferably the α parameter is preferably calculated using equation:

$${α}_{i}^{( l )} = intercept + slope \times \frac{{χ}^{( l )}}{{bp}_{a}^{( l )}} .$$

The method may provide that the major donor contributes with (χ×100) % of the DNA, and preferably for the calculation of ωχ/bp_{g1,1}. If the number from this calculation is greater than the upper limit of the dropout region for stutter, then the α parameter is preferably calculated using equation:

$${α}_{i}^{( l )} = \frac{{κ}_{1 , i}^{( l )}}{{κ}_{2}^{( l )}} \times \frac{{χ}^{( l )}}{{bp}_{a}^{( l )}} , i = a , s and {β}_{a}^{( l )} = {β}_{s}^{( l )} = \frac{1}{{κ}_{2}^{( l )}} .$$

If the number from this calculation is otherwise, then preferably the α parameter is preferably calculated using equation:

$${α}_{i}^{( l )} = intercept + slope \times \frac{{χ}^{( l )}}{{bp}_{a }^{( l )}} .$$

The upper limit of the drop out region for alleles and/or the upper limit of the drop out region for stutters, in respect of one or more or all of the loci being considered, may be the value in this table.

| | Stutter | Allele |
|---|---|---|
| Locus | Upper Limit | Upper Limit |
| D3 | 22.57 | 1.38 |
| VWA | 20.13 | 2.19 |
| D16 | 12.14 | 0.37 |
| D2 | 6.15 | 0.66 |
| Amelo | — | 2.82 |
| D8 | 16.0 | 2.82 |
| D21 | 15.17 | 1.64 |
| D18 | 10.2 | 0.53 |
| D19 | 15.87 | 1.21 |
| THO | — | 0.68 |
| FGA | 9.53 | 0.93 |

The upper limit may be the value in the table +/−5% or +/−10% or +/−25%.

The method may provide that the α parameters for the minor donor are calculated using the same method as in the previous four paragraphs, but with the substitution of (1−ω)χ/bp_{g2,k} instead of ωχ/bp_{g1,k},k=1,2.

The method may provide that the α parameters are grouped, according to the shared positions of alleles and stutters of the donor genotypes. The method may provided that the cover of g₁^{(l)} and g₂^{(l)} is defined as:

cover(g₁^{(l)},g₂⁽¹⁾∪_{j=1,2; k=1,2}{a_{gi,k},a_{gi,k}−1}

The method may provide that for an allelic position a in cover(g₁⁽¹⁾,g₂^{(l)}), αₐ^{(l)}=Σ{αεA_{g1,g2}^{(l)}: a=a_{gi,j}^{(l)} or a_{gi,j}^{(l)}=s_{gi,j}^{(l)}, i,j=1,2} and/or that the α parameters for alleles and stutters that fall in allelic position a are added up to overall αₐ^{(l)} for this position.

The method may provide that the set of peaks in c^{(l)} correspond to a subset of allelic positions in cover(g₁^{(l)},g₂^{(l)}), i.e. a_{c}^{(l)}⊂cover(g₁^{(l)},g₂^{(l)}). The method may provide that the allelic positions in cover(g₁^{(l)},g₂^{(l)})\\dot{a}_{c}^{(l)} correspond to peaks that have dropped out. The method may provide that one or more or all of the pdfs are of the form: ƒ(c^{(l)}|g₁^{(l)},g₂^{(l)},ω,χ^{(l)}=

$$[ {\prod }_{a ∈ cover ( {g}_{1}^{( l )} , {g}_{2}^{( l )} ) \backslash {a}_{c}^{( l )}} F ( 30 \vert {α}_{a}^{( l )} , {β}^{( l )} ) ] \times f ( \{ {π}_{a} \text{:} a ∈ {a}_{{c}^{( l )}} \} \vert {α}_{a} \text{:} a ∈ {a}_{{c}^{( l )}} \} )$$

where F is a Gamma cumulative density function and f is the pdf of a Dirichlet distribution.

The stutter intercept and/or stutter slope and/or allele intercept and/or allele slope, in respect of one or more or all of the loci being considered, may be the value in this table:

| | Stutter | Stutter | Allele | Allele |
|---|---|---|---|---|
| Locus | Intercept | Slope | Intercept | Slope |
| D3 | 0.4 | 0.75 | 2.65 | 9.33 |
| VWA | 0.83 | 0.88 | 2.1 | 13.48 |
| D16 | 0.01 | 1.13 | 3.08 | 11.92 |
| D2 | 0.96 | 2.12 | 3.14 | 27.56 |
| Amelo | — | — | 2.53 | 12.5 |
| D8 | 0.43 | 0.8 | 2.18 | 14.03 |
| D21 | 0.8 | 1.18 | 2.47 | 19.71 |
| D18 | 0.69 | 1.56 | 3.37 | 15.27 |
| D19 | 0.63 | 0.97 | 4.1 | 10.25 |
| THO | — | — | 5.26 | 27.09 |
| FGA | 0.26 | 2.09 | 3.86 | 24.89 |

One or more or all of the values in the table, for instance the values for one or more of the loci, may be the value in the table +/−5% or +/−10% or +/−25%.

The method may provide that linear regression is used to define one or more of the parameters. The method may include a factor defined by the mean and the variance of the peak heights observed increasing at the same rate for both allelic and stutter peaks heights. The factor may provide:

$${α}_{i}^{( l )} = \frac{{κ}_{1 , i}^{( l )}}{{κ}_{2}^{( l )}} \times \frac{{χ}^{( l )}}{{bp}_{a}^{( l )}} , i = a , s and {β}_{a}^{( l )} = {β}_{s}^{( l )} = \frac{1}{{κ}_{2}^{( l )}}$$

The method may include an estimate of one or more of the κ parameters.

The method may provide the values for the parameters for one or more experimental protocols and/or multiplexes. Preferably the values for the parameters are specific to an experimental protocol and/or multiplex.

The method may include the use of shape a and/or rate β parameters in the model of a peak, preferably whether it is allelic or stutter. The Gamma distribution may be defined as:

Hₐ₍ₗ₎˜Gamma(αₐ^{(l)},β^{(l)}) and Hₛ^{(l)}˜Gamma(αₛ^{(l)},βₛ^{(l)})

where Hₐ^{(l)} and Hₛ^{(l)} are the heights of an allelic and stutter peaks respectively. The corresponding pdf's to the distributions may be denoted ƒₐ and ƒₛ.

The parameters may be obtained from the mean μ and the standard deviation σ, preferably using the equations:

$$α = \frac{{μ}^{2}}{{σ}^{2}} and β = \frac{μ}{{σ}^{2}} .$$

The means and variance may be modelled with the linear equations:

$${μ}_{a}^{( l )} = {κ}_{1 , a}^{( l )} \times \frac{{χ}^{( l )}}{{bp}_{a}^{( l )}} , and \text{/} or {μ}_{s}^{( l )} = {κ}_{1 , s}^{( l )} \times \frac{{χ}^{( l )}}{{bp}_{s}^{( l )}}$$

and/or (σₐ^{(l)})²=κ₂^{(l)}xμₐ^{(l)}, and/or (σₛ^{(l)}, preferably where χ^{(l)} is the peak height sum at the locus l; bpₐ^{(l)} is the number of base pairs of allele a; and s is the stutter of a.

The method may provide that κ_{1,a}^{(l)}, κ_{1,s}^{(l)} and κ₂^{(l)} are the parameters that drive the model and/or that these are estimated from the profile data.

The method may provide that the alleles that are not in a_{c}^{(l)} are collected into allele q^{(l)}. The base count for q^{(l)} may be the average base count of alleles that have non-zero count in at least one of the ethnic appearance databases known for the multiplex.

The method may provide for the model for stutter to work in tandem with the model for alleles and/or use the base pair counts to account for molecular weight.

The method may provide that the model incorporates the assumption that Hₐ^{(l)} is independent of Hₛ^{(l)} given χ^{(l)} and bpₐ^{(l)} where Hₛ^{(l)} is the stutter of parent allele Hₐ^{(l)}.

The α and β parameters may be obtained to give:

$${α}_{i}^{( l )} = \frac{{κ}_{1 , i}^{( l )}}{{κ}_{2}^{( l )}} \times \frac{{χ}^{( l )}}{{bp}_{a}^{( l )}} , i = a , s and {β}_{a}^{( l )} = {β}_{s}^{( l )} = \frac{1}{{κ}_{2}^{( l )}}$$

The method may provide that sharing a common β parameter allows the construction of a pdf for a questioned profile c^{(l)}, preferably through the addition of independent Gamma variables and the analytic construction of a Dirichlet pdf:

if χᵢ˜Gamma(αᵢ,β),i=1,2, . . . ,n,

$${\sum }_{i = 1}^{n} {X}_{i} \sim Gamma ( {\sum }_{i = 1}^{n} {α}_{i} , β ) and \\ ( {π}_{1} , {π}_{2} , … , {π}_{n} ) \sim Dirichlet ( {α}_{1} , {α}_{2} , … , {α}_{1} , ) ,$$

where πⱼ=χⱼ/Σᵢ₌₁ⁿXᵢ.

The method may provide that the dropout probabilities are obtained from the cumulative probability distribution (cdf) of a Gamma distribution. The κ parameters of the model may be estimated using the whole data set, which contains peak heights where allelic dropout is possible. The method may provide, for instance to address the accuracy of dropout probabilities, that the κ parameters are adjusted for the dropout region. The method may provide that the κ parameters are estimated from experimental data, for instance a set of profiles produced under laboratory conditions using the protocol applicable and the multiplex which is applicable.

The method may provide that the experimental data is used to estimate the variability of peak heights of stutters and alleles separately, for instance by considering the peak height data only from non-adjacent heterozygotes

The method may provide that, for each locus where the genotype of the donor is {aₐ,a₂} the data consisted of {h_{a,1}^{(l)},h_{s,1}^{(l)},bp_{a,1}^{(l)},h_{a,2}^{(l)},h_{s,2}^{(l)},bp_{a,2}^{(l)}} where h_{a,i} and h_{s,i} is the height of the alleles and stutters, respectively and bp_{a,i} is the base pair count of allele aᵢ, i=1,2. The data may be augmented with χ^{(l)} calculated as the sum of the peak heights i.e. χ^{(l)}=h_{a,1}+h_{s,1}+h_{a,2}+h_{s,2}. The data set may be split into two: one for alleles and the other for stutters. Preferably each locus contributes to two rows in these data sets: {h_{a,1},bp_{a1,},χ^{(l)}} and {h_{a,2},bp_{a,2},χ^{(l)}} for alleles and {h_{s,1},bp_{a,1},χ^{(l)}} and {h_{s,2},bp_{a,2},χ^{(l)}} for stutters. The method may provide that the allele and the stutter data are denoted: {h_{a,i}^{(l)},bp_{a,i}^{(l)},χᵢ^{(l)}: i=1, 2, . . . , nₐ} and {h_{s,i}^{(l)},bp_{a,i}^{(l)},χᵢ^{(l)}: i=1, 2, . . . , nₛ} respectively, where the index h_{a,i} now denotes a row number.

The method may provide that the estimation of the κ parameters is achieved iteratively using the EM algorithm (Dempster et al., Maximum likelihood from incomplete data via the EM algorithm. Journal of the Royal Statisitcal Society, Series B, 39(1):1-38, 1977).

The method may provide that in a first iteration, that peak heights recorded as zeros, in both the allele and stutter data sets, are replaced with a random sample from a continuous uniform distribution. Preferably this is in respect of the interval (0, 30) according to the Gamma distributions estimated in the previous iteration.

The method may provide an estimation of κ_{1,a} and κ_{1,s}. Parameter κ_{1,a}^{(l)} may be estimated from the allele data set using least squared estimation, where Hₐ is the response variable and χ^{(l)}/bpₐ^{(l)} is the covariate and the intercept is set to zero. The regression line through the data may be determined by κ_{1,a}^{(l)}. The method may provide that parameter κ_{1,s} is estimated in the same way using the stutter data set.

The method may provide an estimation of κ₂^{(l)}. Parameter κ₂^{(l)} may be calculated by minimising a joint negative log-likelihood function

$$NLL ( {κ}_{2}^{( l )} ) = - {\sum }_{{h}_{a}^{( l )}} log \{ {f}_{a} ( {h}_{a}^{( l )} \vert {α}_{a}^{( l )} , {β}_{a}^{( l )} ) \} - {\sum }_{{h}_{s}^{( l )}} log \{ {f}_{s} ( {h}_{s}^{( l )} \vert {α}_{s}^{( l )} , {β}_{s}^{( l )} ) \}$$

where ƒₐ and ƒₛ are Gamma pdfs for allelic and stutter peak heights, respectively, and the α and β parameters are as given in:

$${α}_{i}^{( l )} = \frac{{κ}_{1 , i}^{( l )}}{{κ}_{2}^{( l )}} \times \frac{{χ}^{( l )}}{{b}_{a}^{( l )}} , i = a , s and {β}_{a}^{( l )} = {β}_{s}^{( l )} = \frac{1}{{κ}_{s}^{( l )}} .$$

The method may provide that the κ parameter estimates have the values given in the following table with respect to one or more or all of the loci and/or one or more or all of the parameters:

| Locus | κ_{1,a}^{(l)} | κ_{1,s}^{(l)} | κ₂^{(l)} |
|---|---|---|---|
| D3 | 60.76 | 4.15 | 5.4 |
| VWA | 85.22 | 5.46 | 5.9 |
| D16 | 123.91 | 6.92 | 6.1 |
| D2 | 145.38 | 10.23 | 4.5 |
| Amelo | 54.95 | | 4.1 |
| D8 | 69.59 | 3.89 | 4.7 |
| D21 | 99.72 | 5.78 | 4.7 |
| D18 | 138.23 | 10.39 | 6.4 |
| D19 | 58.65 | 4.34 | 4.3 |
| THO | 89.96 | 1.85 | 3.1 |
| FGA | 111.34 | 6.77 | 3.2 |

One or more or all of the values in the table, for instance the values for one or more of the loci, may be the value in the table +/−5% or +/−10% or +/−25%.

The method may provide that the model provides an estimate based on the whole of the distribution. Preferably, the method provides that the model provides an estimate in which the tail of the distribution, preferably the dropout region, is separately considered. Ideally a modified distribution is provided for the dropout region. The method may provide that in and/or near the dropout region a modification is applied. The modification may involve fixing the β parameter and/or adjusting the α parameter, for instance to get a better fit. The method may include the provision of a pivot point in the mean line and/or the provision of a different gradient, for instance below that pivot point.

The method may provide that the model for alleles is estimated from data set {χᵢ^{(l)}/bp_{a,i}^{(l)},h_{a,i}^{(l)}: i=1, 2, . . . , n}, where n is the number of data pairs. Dropout probabilities from the model and estimated from the data may be compared in the dropout region:

(0,1.5×max{χᵢ^{(l)}/bp_{a,i}^{(l)}:h_{a,i}^{(l)}<30,for_all_{—}i})

A factor of 1.5 may be selected to look at the transition from the dropout to non-dropout regions.

The method may provide that the modification includes one or more of the following steps:
1. The dropout probabilities from the model being obtained form the cdf of a Gamma distribution, for instance of form F(30|α,β). The α and β parameters may be obtained from the κ parameters.
2. The dropout probabilities from the data may be calculated from discrete intervals of the dropout region.
The intervals may be selected using the method of Friedman et al., On the histogram as a density estimator: L2 theory. Probability Theory and Related Fields 57:453-476, 1981, 10.1007/BF01025868.
3. The calculation of adjusted model dropout probabilities may involve one or more of the following steps:
   a. For each dropout probability \hat{p} estimated from data, an α parameter may be obtained so that \hat{p}≈F(30,\hat{α},β) where β=1/κ₂^{(l)}.
   b. The α parameters for the midpoint of the discrete intervals may be obtained and/or plotted.
   c. To correct the α parameters, a straight line may be anchored at the α from the model corresponding to the last midpoint plus, for instance, twice the bin size. This may be done to cover an area of transition. The intercept of the line may be selected so as to minimise the Euclidean distance of the α from the line and the \hat{α}.

The method preferably provides the same process as applied to allelic and stutter peaks.

The method may provide that the adjusted α parameters are calculated from the intercept and the slope of the fitted line in the dropout region. If χ^{(l)}/bpₐ^{(l)} is smaller than the upper limit of the dropout region for alleles, this may be according to the form

$${α}_{i}^{( l )} = intercept + slope \times \frac{{χ}^{( l )}}{{bp}_{a}^{( l )}}$$

where i=a and intercept and slope are estimated as described above. Similarly, if χ^{(l)}/bpₐ^{(l)} is smaller than the upper limit of the dropout region for the stutters, the method may use the same equation with i=s and intercept and slope.

According to a second aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses in the definition of the likelihood ratio the factor: ƒ(Cₗ₍ᵢ₎|gₗ₍ᵢ₎,χₗ₍ᵢ₎,δ) or its substitution ƒ(c^{(l)}|g₁^{(l)},ω,χ^{(l)}), particularly where g₁^{(l)} is the genotype of the donor of sample c^{(l)}, χ^{(l)} denotes the quantitative measure, for instance peak-height sum or peak area sum, for the locus i and ω is the mixing proportion and/or by the factor ƒ(c^{(l)}|g₁^{(l)},g₂^{(l)},ω,χ^{(l)}), particularly where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

The second aspect of the invention may include any of the features, options or possibilities set out elsewhere in this document, including in the other aspects of the invention.

According to a third aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses as the definition of the likelihood ratio the factor:
   ƒ(cₗ₍ᵢ₎|g_{U,1,l(i)},g_{U,2,l(i)},χₗ₍ᵢ₎,δ) or its substitution ƒ(c^{(l)}|g₁^{(l)},ω,χ^{(l)}), particularly where g₁^{(l)} is the genotype) of the donor of sample c^{(l)}, χ^{(l)} denotes the quantitative measure, for instance peak-height sum or peak area sum, for the locus i and ω is the mixing proportion and/or by the factor ƒ(c^{(l)}|g₁^{(l)},g₂^{(l)}),ω,χ^{(l)}), particularly where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

The third aspect of the invention may include any of the features, options or possibilities set out elsewhere in this document, including in the other aspects of the invention.

According to a fourth aspect of the invention we provide a method of comparing a first, potentially test, sample result set with a second, potentially another, sample result set, the method including:
providing information for the first result set on the one or more identities detected for a variable characteristic of DNA;
providing information for the second result set on the one or more identities detected for a variable characteristic of DNA; and
   wherein the method uses in the definition of the likelihood ratio the factor:
   ƒ(cₗ₍ᵢ₎|g_{1,l(i)},g_{2,l(i)},ω,χₗ₍ᵢ₎,δ) or its substitution ƒ(c^{(l)}|g₁^{(l)},ω,χ^{(l)}), particularly where g₁^{(l)} is the genotype of the donor of sample c^{(l)}, χ^{(l)} denotes the quantitative measure, for instance peak-height sum or peak area sum, for the locus i and ω is the mixing proportion and/or by the factor ƒ(c^{(l)}|g₁^{(l)},g₂^{(l)},ω,χ^{(l)}), particularly where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

The fourth aspect of the invention may include any of the features, options or possibilities set out elsewhere in this document, including in the other aspects of the invention.

According to a fifth aspect of the invention we provide a method for generating one or more probability distribution functions relating to the detected level for a variable characteristic of DNA, the method including:

a) providing a control sample of DNA;

b) analysing the control sample to establish the detected level for the at least one variable characteristic of DNA;

c) repeating steps a) and b) for a plurality of control samples to form a data set of detected levels;

d) defining a probability distribution function for at least a part of the data set of detected levels.

The method may particularly be used to generate one or more of the probability distribution functions provided elsewhere in this document.

The method may be used to generate one or more probability distributions related to the effect of one or more of: a factor accounting for one of more effects which impact upon the amount of an allele, for instance a height and/or area observed for a sample compared with the amount of the allele in the sample; the effect may be one or more effects which gives a different ratio and/or balance and/or imbalance between observed and present amounts with respect to different alleles and/or different loci; the effect may be and/or include degradation effects; the effect may be and/or include variations in amplification efficiency; the effect may be and/or include variations in amount of allele in a sub-sample of a sample, for instance, when compared with other sub-samples and/or the sample, the effect may be one whose effect varies with alleles and/or loci and/or allele size and/or locus size; the effect may be an effect which causes a reduction in the observed amount compared with that which would have occurred without the effect; the effect may exclude any stutter effect; and in particular their variation with DNA quantity. The DNA quantity may be with respect to an allele and/or allele and stutter and/or two or more alleles and/or two or more stutters and/or the alleles and/or stutters for one or more loci.

The one or more probability distributions may be generated from feed data.

The feed data may be obtained experimentally. The feed data may be obtained by computer modelling.

The experimental determination of the feed data may include one or more of a sampling step; a dilution step, preferably to provide a range of different dilutions; a purification step; a pooling of samples step; a division of samples step; an amplification step, such as PCR; a detection step, for instance of one of more characteristic units introduced to the amplification products, such as dyes; an electrophore is step; an interpretation step; a peak identification step; a peak height and/or area determination step.

The number of samples may be greater than 30, preferably greater than 50 and ideally greater than 100. The number of profiles obtained from samples may be greater than 500, preferably greater than 750 and ideally greater than 1000. The samples may be diluted to less than 1000 picograms per microlitre. The samples may be at least 25 picograms per microlitre. The dilution range may be between preferably 10 to 1000 picograms per microlitre, more preferably 50 to 500 picograms per microlitre. The dilutions may be provided in increments of between 10 and 100 pg/μl, for instance of 25 pg/μl. One or more process protocols may be used to process samples.

The experimental determination may include or further include combining, for instance through addition, one or more of the heights and/or areas for one or more of the loci. The combination may be used to provide a measure of DNA quantity. All of the heights and/or areas from one or more loci may be combined. All of the heights and/or areas from all of the loci, or all bar one of the loci, may be combined.

The experimental determination may include or may further include combining, for instance through addition, all of the heights and/or areas for a locus. The combination may provide a measure of DNA quantity for the locus. The combination may provide a mean height and/or area for the locus and/or one or more alleles of the locus.

The experimental determination may include or may further include obtaining a mean height and/or area for one or more alleles and/or one or more loci. Such a separate mean height and/or area may be obtained for each locus.

The experimental determination may include or may further include a consideration and/or plot of mean height and/or area against DNA quantity, preferably on a locus basis. Such a consideration and/or plot may be provided for two or more and preferably all loci. The DNA quantity may be subject to a scaling factor, such as a multiplier.

The experimental determination may include or may further include fitting a distribution to the feed data, particularly a consideration and/or plot of mean height and/or area against DNA quantity. The fitted distribution may be a linear Gamma distribution. The fitted distribution may pass through the origin. The distribution may be specified through two parameters, preferably the shape parameter α and the rate parameter β.

The experimental determination may include or may further include fitting one or more distributions to the feed data, particularly a consideration and/or plot of mean height and/or area against DNA quantity for one or more of the alleles and/or one or more of the stutters of alleles.

The experimental determination may include or may further include a consideration and/or plot of variance against mean height and/or area, preferably on a locus basis. Such a consideration and/or plot may be provided for two or more and preferably all loci.

The experimental determination may include or may further include fitting one or more distributions to the feed data, particularly a consideration and/or plot of variance against mean height. The fitted distribution may be one or more a Gamma distributions. The fitted distribution may pass through the origin. The distribution may be specified through two parameters, preferably the shape parameter α and the rate parameter β. The fitted distribution may be provided by two different distributions, for instance connected by a knot. The distributions may be two quadratic polynomials, preferably joined in a chosen knot. The knot may chosen through experimenting with several candidates and selecting candidates that give a best and/or good fit. The distribution may be of the form, if μ≦knot: σ²=κ_{2,1,l(i)}xμ+κ_{3,1l(i)}xμ² and/or if μ>knot: σ²=κ_{2,2,l(i)}xμ+κ_{3,2l(i)}xμ².

The experimental determination may include or may further include fitting one or more distributions to the feed data, particularly a consideration and/or plot of variance against mean height and/or area for one or more of the alleles and/or one or more of the stutters of alleles.

The experimental determination may include or may further include providing that the β values for one or more of the distributions be the same. In particular, the β values for the distribution(s) of variance against mean height and/or area may be the same across two or more loci, and preferably all the loci or all bar one loci. The condition:

$${σ}^{2} = {k}_{2} x μ and \text{/} or β = \frac{μ}{{σ}^{2}} = \frac{μ}{{k}_{2} \cdot μ} = \frac{1}{{k}^{2}}$$

may be met for one or more of the distributions and/or one or more loci.

The method may include or further include use of an algorithm to estimate the parameters of the mean and variance models. The values of the parameters in iteration m of the algorithm may be denoted by:

κ_{1,a,l(i)}[m],κ_{2,1,l(i)}[m],κ_{2,2,l(i)}[m],κ_{3,2l(i)}[m],

Preferably in the first iteration of the algorithm zeros (for instance those heights and/or areas smaller than a threshold) may be ignored. Preferably in and/or from the second iteration of the algorithm onwards, the zeros are replaced by samples obtained from the tail of the Gamma pdfs estimated in the previous step. In particular, one or more of the following may be applied:
1. Parameter k_{1,a,l(i)}[1] is estimated using standard linear regression methods where the response variable are non-zero allele heights and the covariate is the corresponding χ.
2. Parameters k_{2,1,l(i)}[1], k_{3,1,l(i)}[1], k_{2,2,l(i)}[1], k_{3,2,l(i)}[1] are estimated by using the estimated mean μ_{a,l(i)} as the mean and computing the variance of the heights around these mean according to a window size.
3. In iteration m, zeros are replaced by samples taken from the family of Gamma distribution estimated in the previous iteration.
4. For a zero corresponding to χ, we first obtain a μ_{a,l(i)}[m−1] from χ and σ_{a,l(i)}²[m−1] from μ_{a,l(i)}[m−1].
5. Parameter α[m−1] and β[m−1] can be computed from μ_{a,l(i)}[m−1] and σ_{a,l(i)}²[m−1].
6. A sample is then taken in the interval (0, 30) from the tail of the distribution using the CDF inverse method using uniform samples in the interval (0, F(30, α[m−1], β[m−1])) where F is the CDF of a Gamma distribution.
7. Parameter k_{1,a,l(i)}[m] is also estimated using standard linear regression methods where the response variable are allele heights and the covariate are the corresponding χ's.
8. Zeros are replaced using the method described above.
9. Parameters k_{2,1,l(i)}[m], k_{3,1l(i)[m], k}_{2,2,l(i)}[m], k_{3,2,l(i)}[m] are estimated by using the estimated mean μ_{a,l(i)}[m] as the mean and computing the variance of the heights around these mean according to a window size.
10. The process is repeated until the parameters converge according to the rules:
   (a) |k_{1,a,l(i)}[m]−k_{1,a,l(i)}[m−1]|<0.0001;
   (b) |k_{2,a,l(i)}[m]−k_{2,a,l(i)}[m−1]|<0.01; and
   (c) |k_{3,a,l(i)}[m]−k_{3,a,l(i)}[m−1]|<0.001.

The method may include or further include use of an algorithm to estimate the parameters of the mean and variance models for both the alleles and stutters, with one or more of the same features being used for both and/or the same algorithm being used for both.

The fifth aspect of the invention may include any of the features, options or possibilities set out elsewhere in this document, including in the other aspects of the invention.

Any of the proceeding aspects of the invention may include the following features, options or possibilities or those set out elsewhere in this document.

The terms peak height and/or peak area and/or peak volume are all different measures of the same quantity and the terms may be substituted for each other or expanded to cover all three possibilities in any statement made in this document where one of the three are mentioned.

The method may be a computer implemented method.

The method may involve the display of information to a user, for instance in electronic form or hardcopy form.

The test sample, may be a sample from an unknown source. The test sample may be a sample from a known source, particularly a known person. The test sample may be analysed to establish the identities present in respect of one or more variable parts of the DNA of the test sample. The one or more variable parts may be the allele or alleles present at a locus. The analysis may establish the one or more variable parts present at one or more loci.

The test sample may be contributed to by a single source. The test sample may be contributed to by an unknown number of sources. The test sample may be contributed to by two or more sources. One or more of the two or more sources may be known, for instance the victim of the crime.

The test sample may be considered as evidence, for instance in civil or criminal legal proceedings. The evidence may be as to the relative likelihoods, a likelihood ratio, of one hypothesis to another hypothesis. In particular, this may be a hypothesis advanced by the prosecution in the legal proceedings and another hypothesis advanced by the defense in the legal proceedings.

The test sample may be considered in an intelligence gathering method, for instance to provide information to further investigative processes, such as evidence gathering. The test sample may be compared with one or more previous samples or the stored analysis results therefore. The test sample may be compared to establish a list of stored analysis results which are the most likely matches therewith.

The test sample and/or control samples may be analysed to determine the peak height or heights present for one or more peaks indicative of one or more identities. The test sample and/or control samples may be analysed to determine the peak area or areas present for one or more peaks indicative of one or more identities. The test sample and/or control samples may be analysed to determine the peak weight or weights present for one or more peaks indicative of one or more identities. The test sample and/or control samples may be analysed to determine a level indicator for one or more identities.

Various embodiments of the invention will now be described, by way of example only, and with reference to the accompanying drawings, in which:

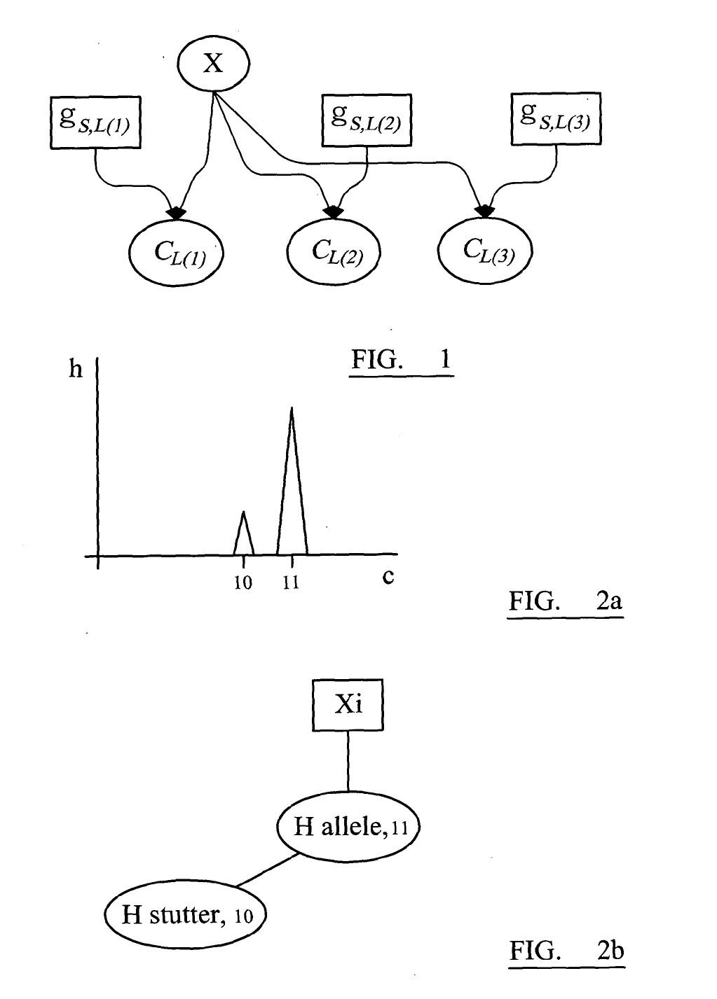

FIG. 1 shows a Bayesian network for calculating the numerator of the likelihood ratio; the network is conditional on the prosecution view Vₚ. The rectangles represent know quantities. The ovals represent probabilistic quantities. Arrows represent probabilistic dependencies, e.g. the PDF of C_{L(1)} is given for each value of g_{s,L(1)} and χ.

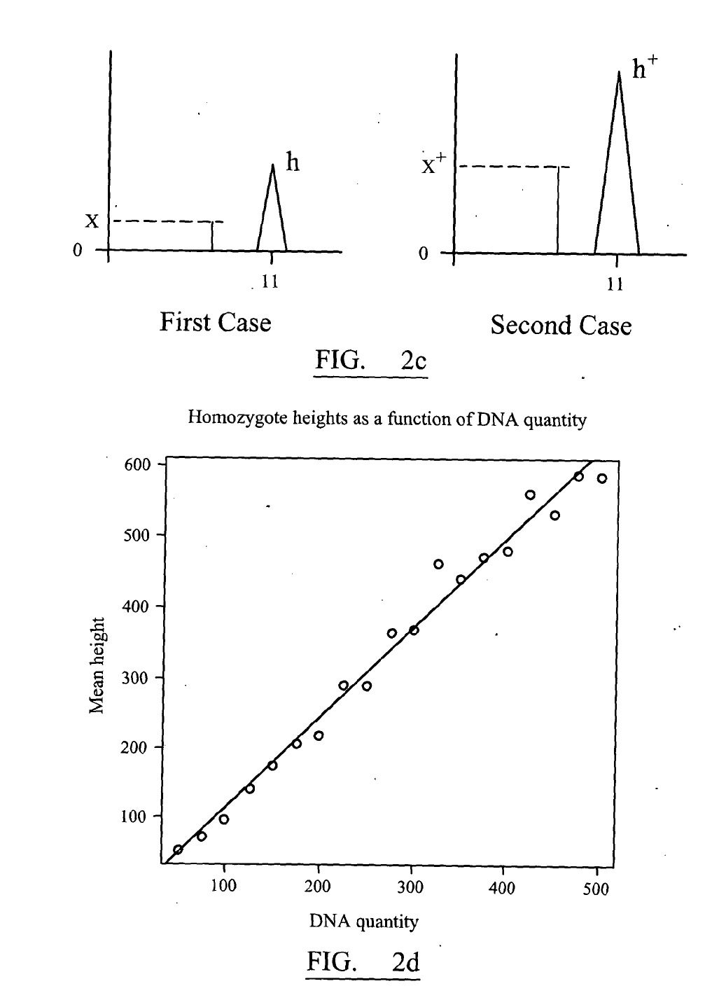

FIG. 2a illustrates an example of a profile for a homozygous source;

FIG. 2b is a Bayesian Network for the homozygous position;

FIG. 2c is a further Bayesian Network for the homozygous position;

FIG. 2d shows homozygote peak height as a function of DNA quantity; with the straight line specified by h̅=−12.94+1.27×χ.

FIG. 2e shows the parameters of a Beta PDF that model stutter proportion πₛ conditional on parent allele height h.

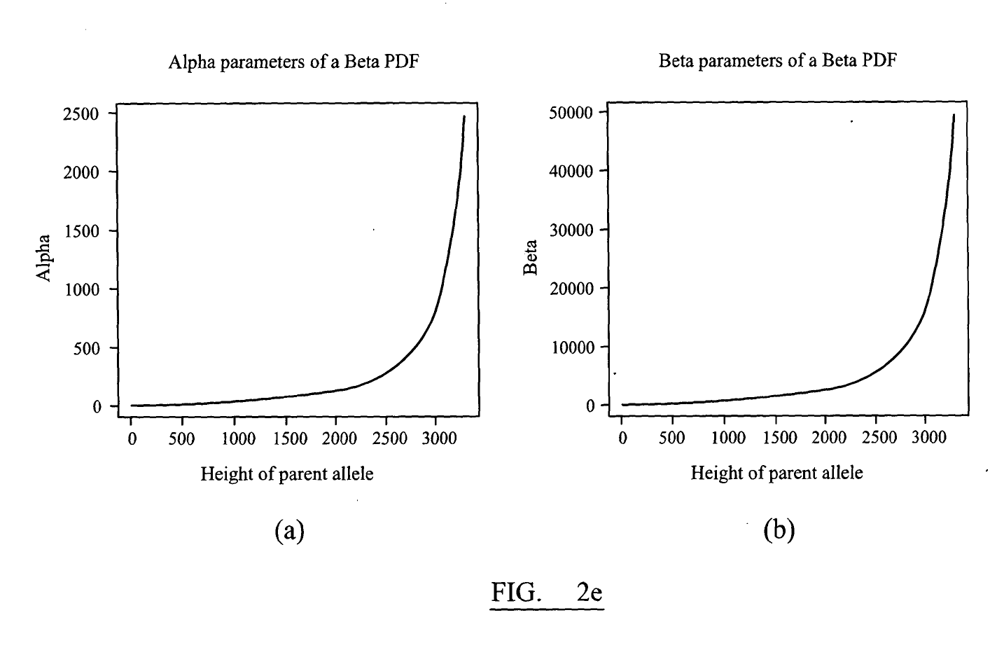

FIG. 3a illustrates an example of a profile for a heterozygous source whose alleles are in non-stutter positions relative to one another;

FIG. 3b is a Bayesian Network for the heterozygous position with non-overlapping allele and stutter peaks;

FIG. 3c is a further Bayesian Network for the heterozygous position with non-overlapping allele and stutter peaks;

FIG. 3d

FIG. 3e shows the variation in density with mean height for a series of Gamma distributions;

FIG. 3f shows the variation of parameter σ as a function of mean height m;

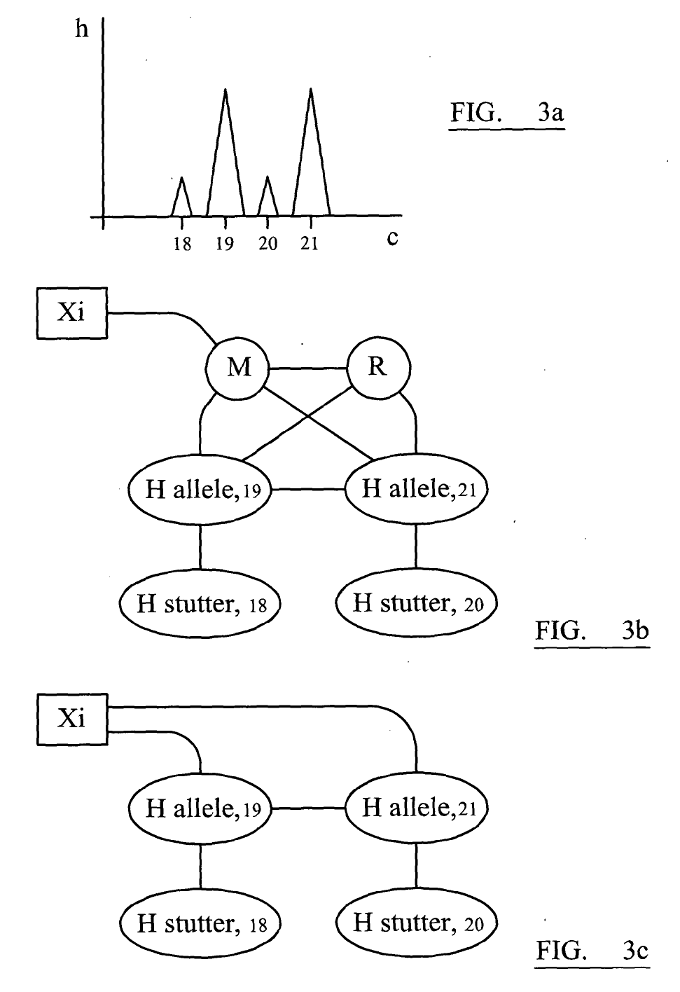

FIG. 4a illustrates an example of a profile for a heterozygous source whose alleles include alleles in stutter positions relative to one another;

FIG. 4b is a Bayesian Network for the heterozygous position with overlapping allele and stutter peaks;

FIG. 4c is a further Bayesian Network for the heterozygous position with overlapping allele and stutter peaks;

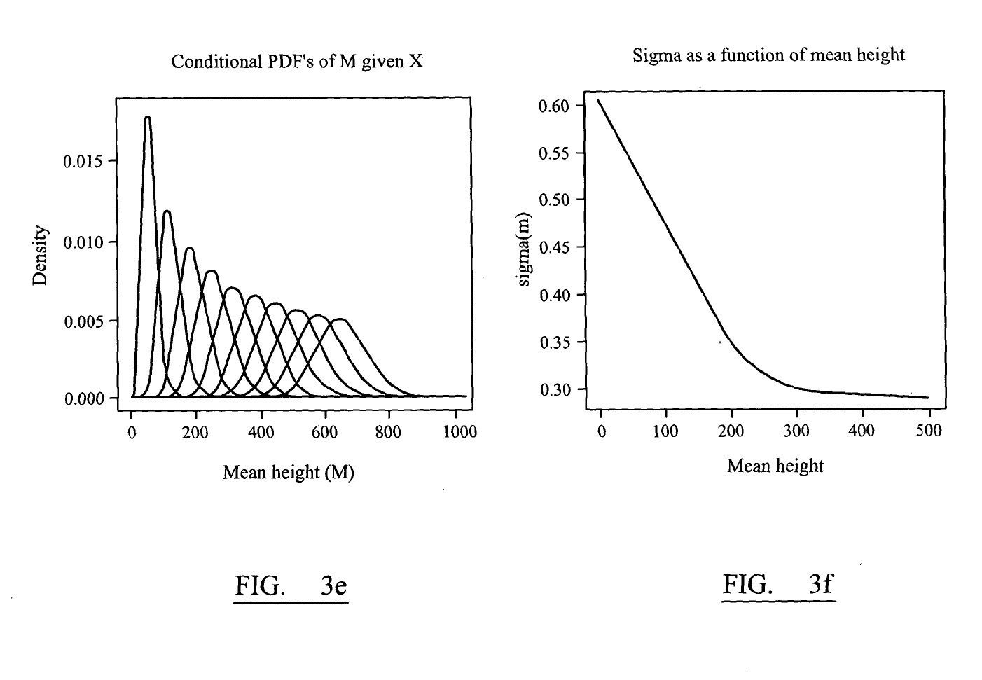

FIG. 5 shows a Bayesian network for calculating the denominator of the likelihood ratio. The network is conditional on the defense hypothesis V_{d}. The oval represent probabilistic quantities whilst the rectangles represent known quantities. The arrows represent probabilistic dependencies;

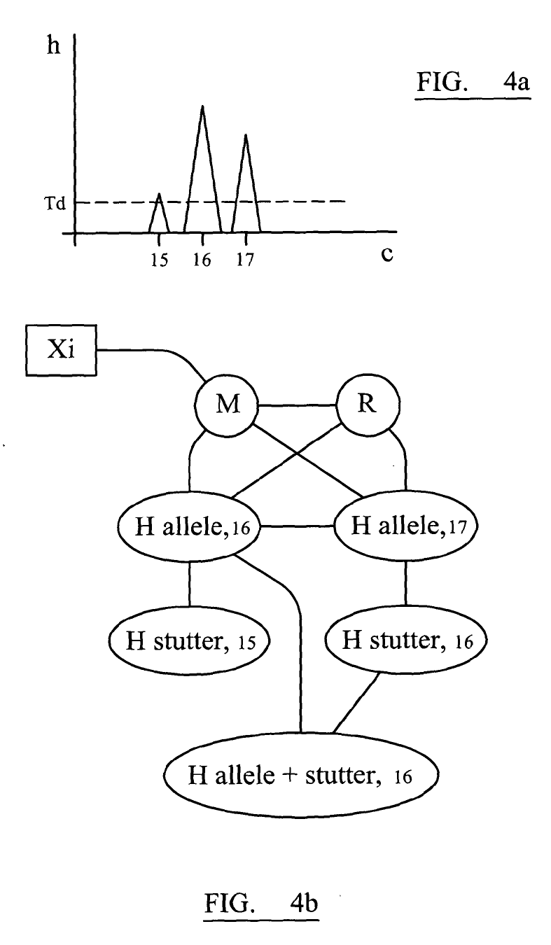

FIG. 6 shows a Bayesian Network for calculating likelihood per locus in a generic example;

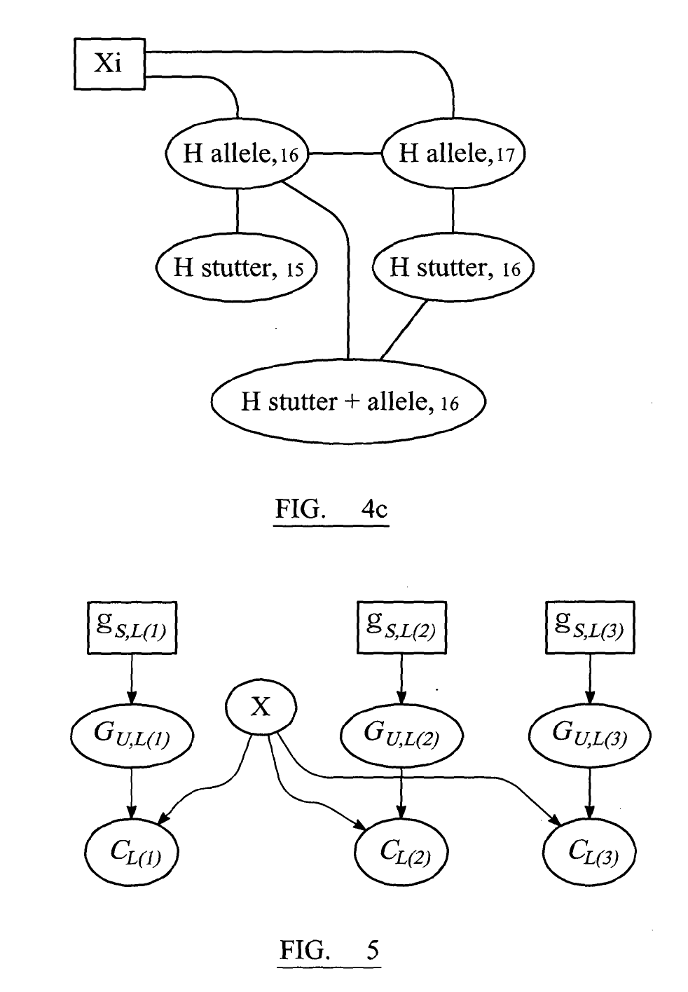

FIG. 7 shows Bayesian Networks for three allele situations;

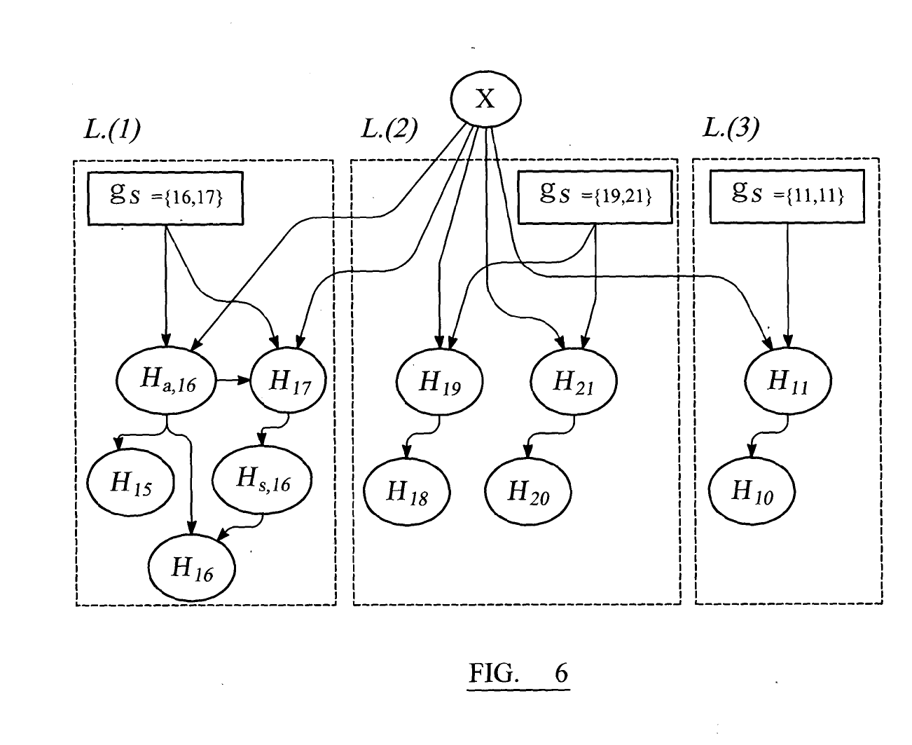

FIG. 8a is a plot of profile mean against profile standard deviation;

FIG. 8b is a plot of mean height against DNA quantity;

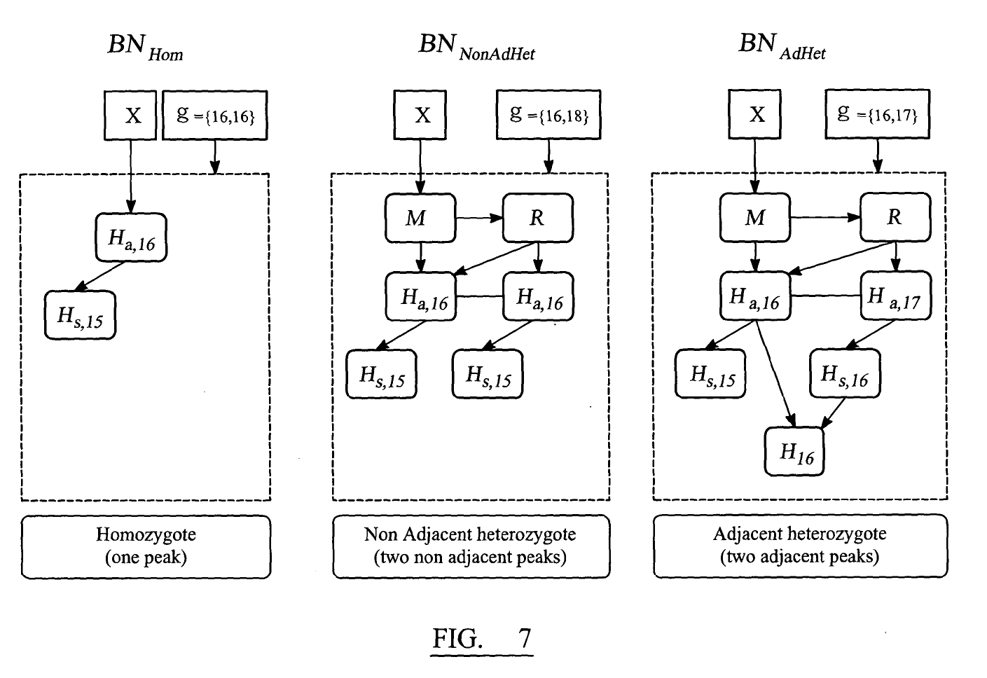

FIG. 9 a pdf for R/M=m;

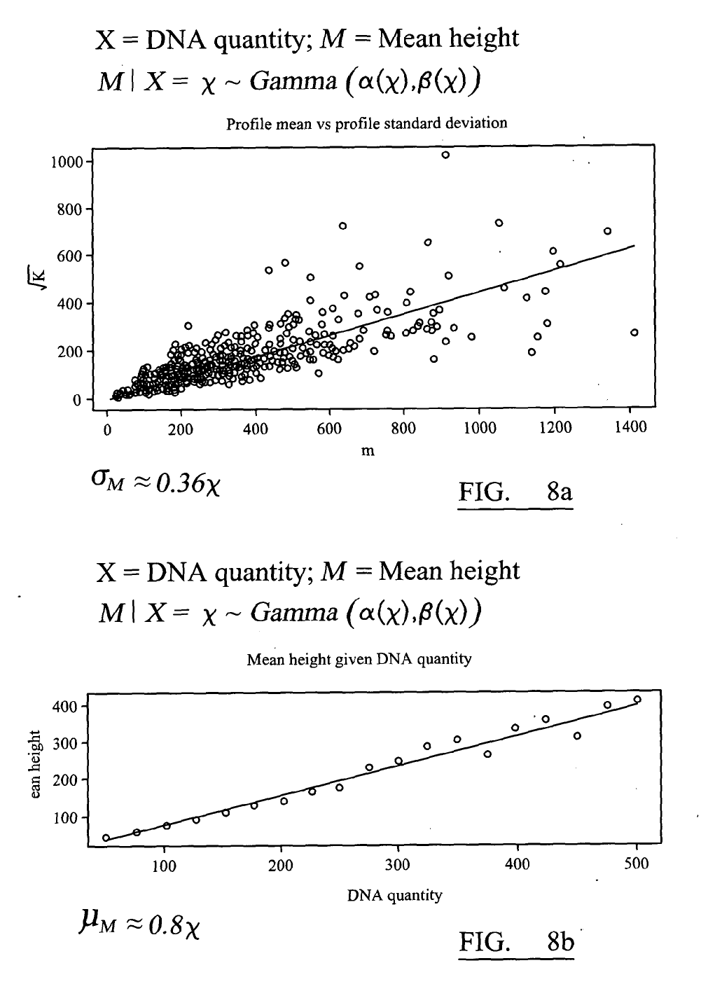

FIG. 10 shows a Bayesian Network for part of the degradation consideration;

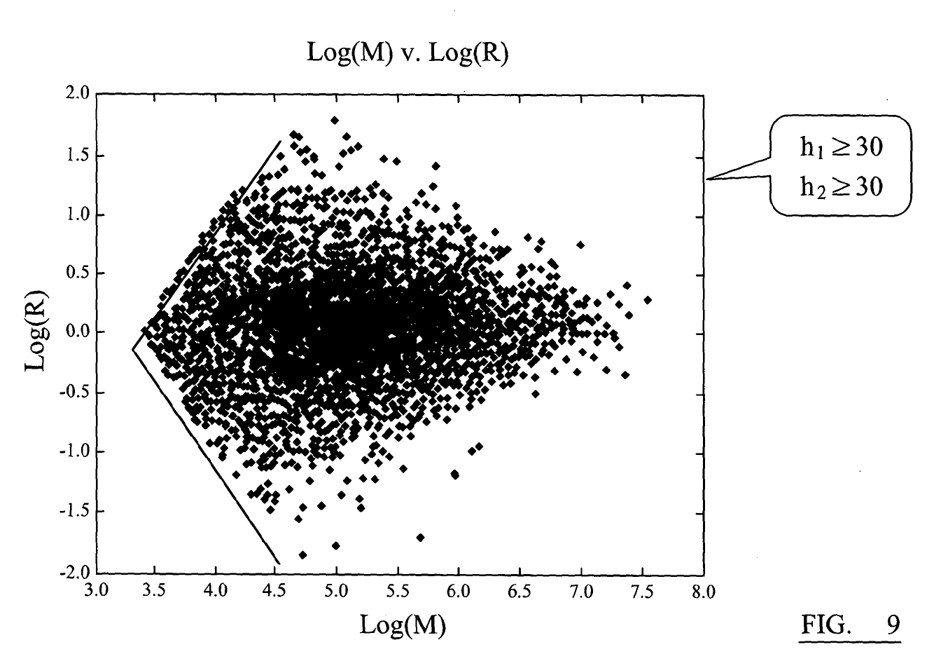

FIG. 11a is a plot of mean peak height against DNA quantity×10;

FIG. 11b is a plot of variance against mean height;

FIG. 11c is a plot of variance against mean height with a regression fitted;

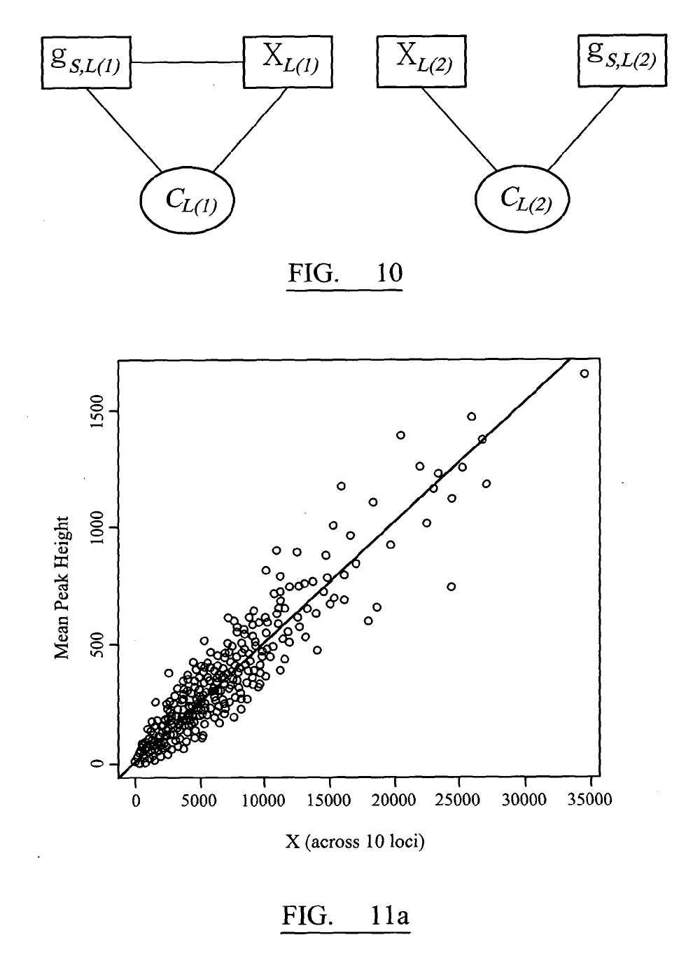

FIG. 12 shows plots of allele mean peak height against DNA quantity×10, stutter mean peak height against DNA quantity×10, variance against mean height and coefficient of variation as a function of mean for locus D3;

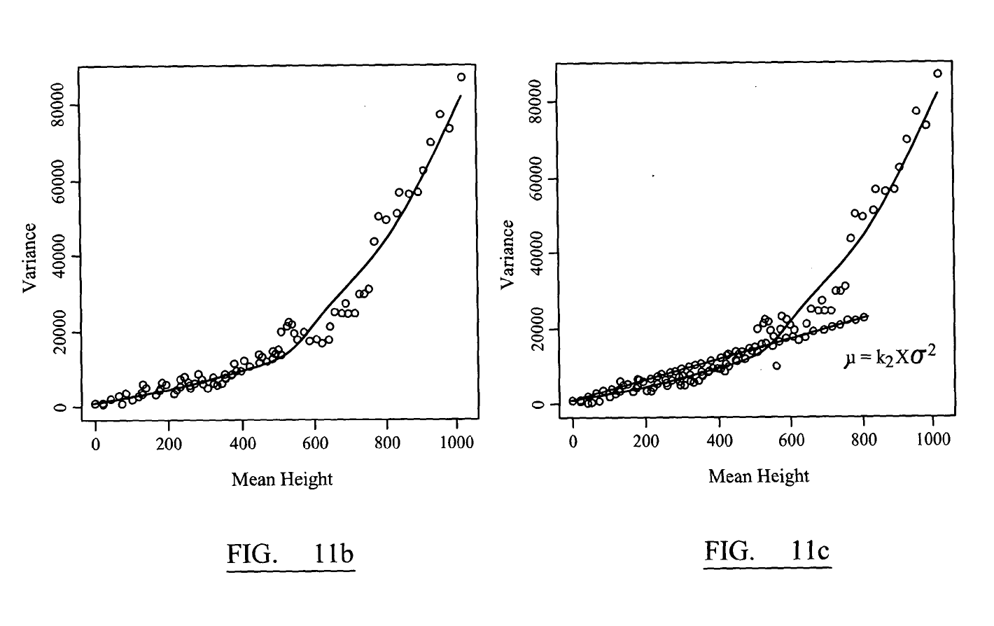

FIG. 13 shows the plots of FIG. 12 for locus vWA;

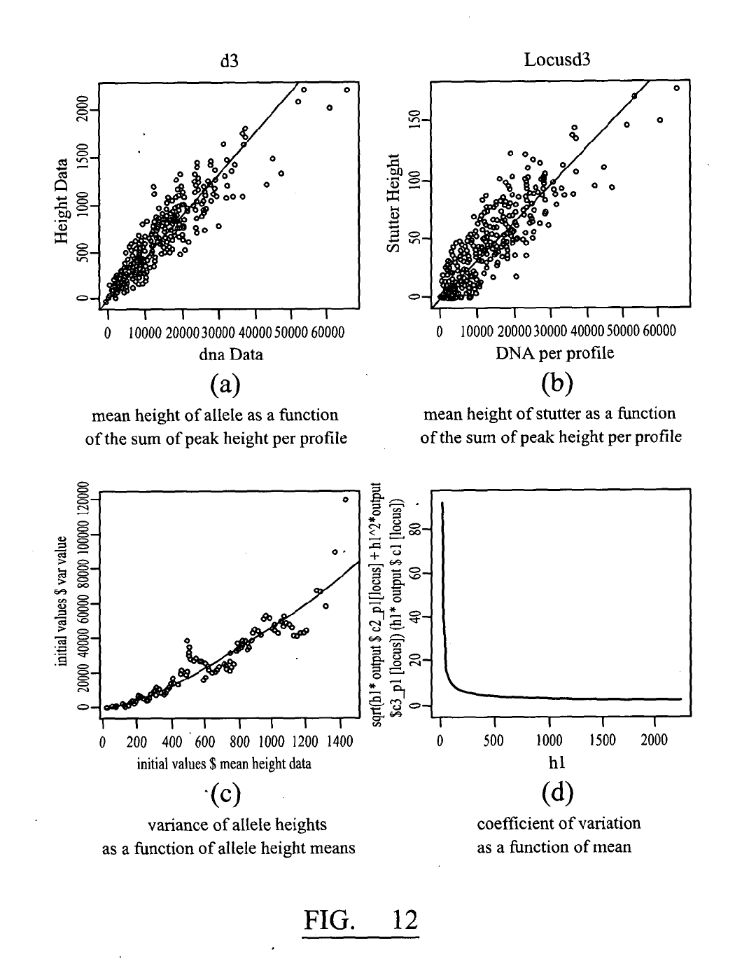

FIG. 14 shows the plots of FIG. 12 for locus D16;

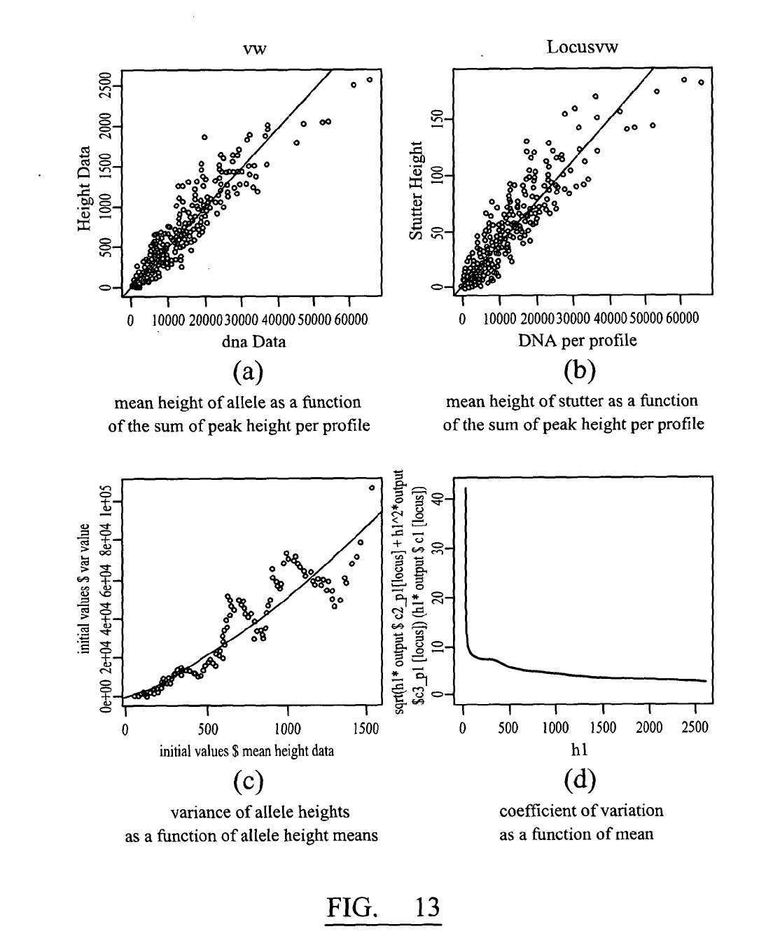

FIG. 15 shows the plots of FIG. 12 for locus D2;

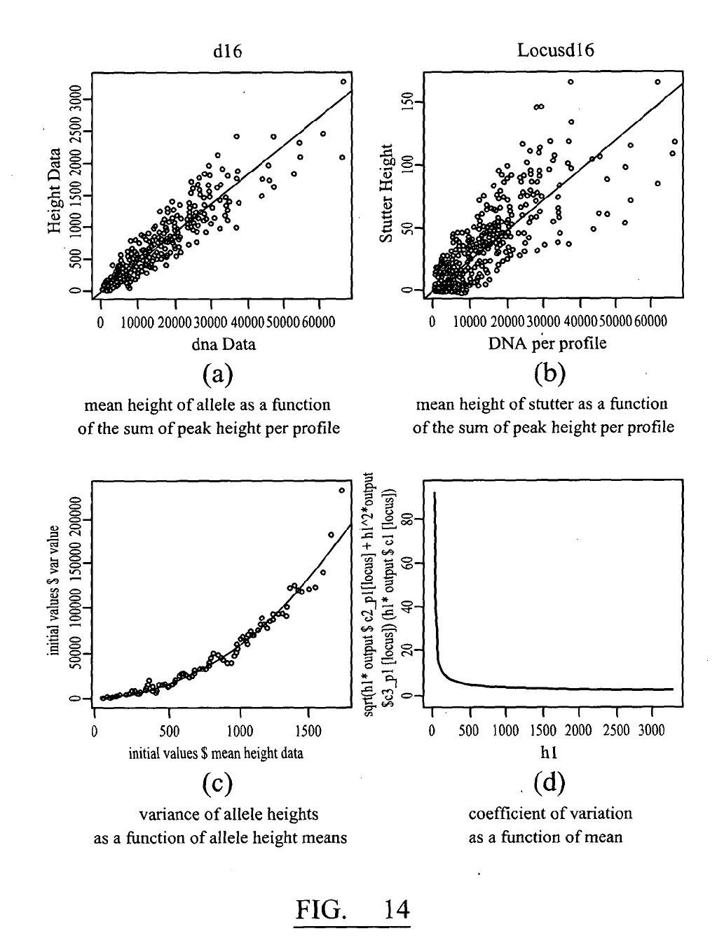

FIG. 16 shows the plots of FIG. 12 for Amelogenin;

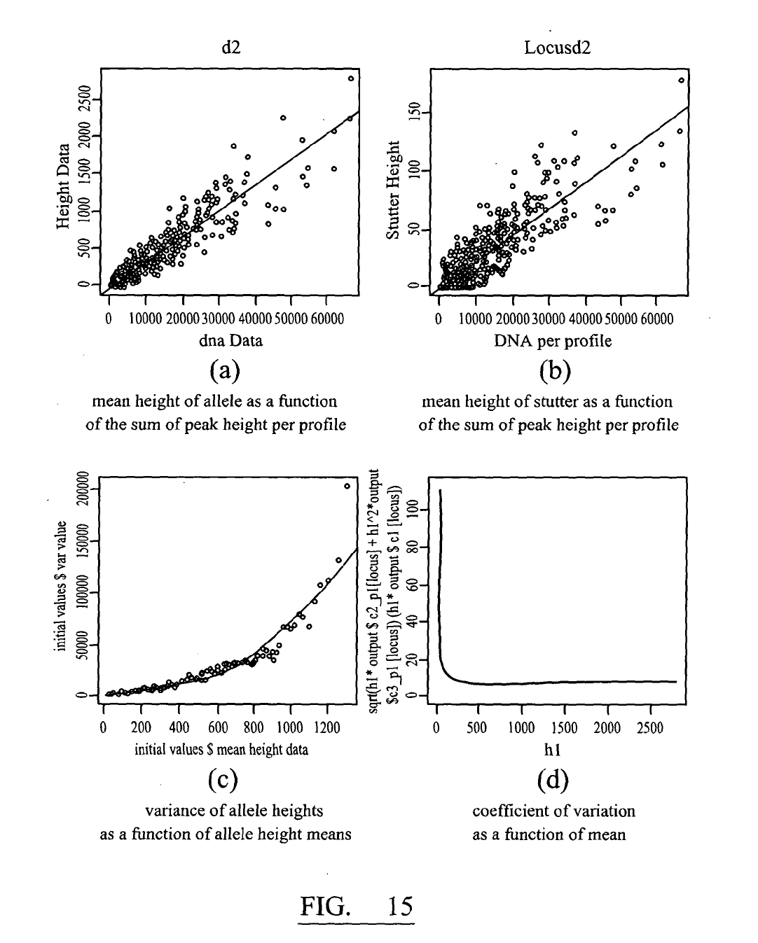

FIG. 17 shows the plots of FIG. 12 for locus D8;

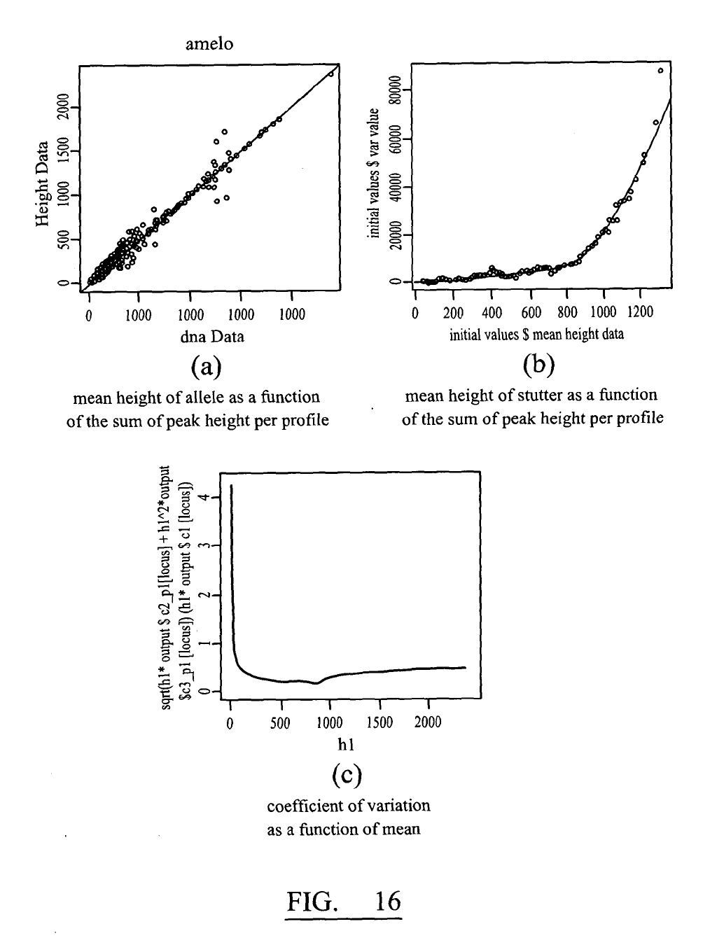

FIG. 18 shows the plots of FIG. 12 for locus D21;

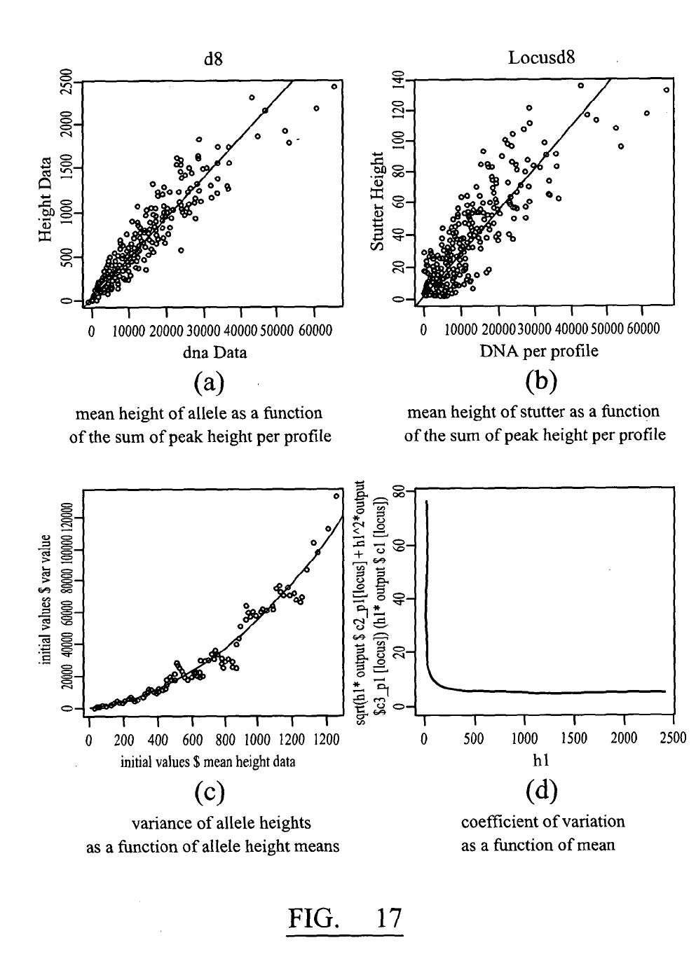

FIG. 19 shows the plots of FIG. 12 for locus D18;

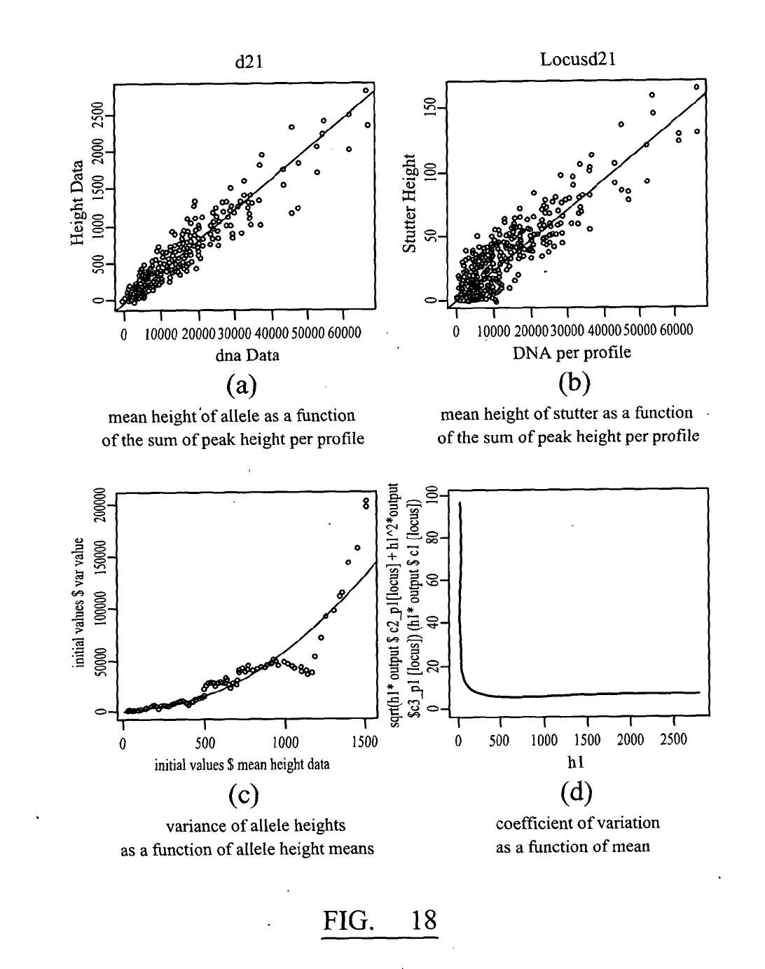

FIG. 20 shows the plots of FIG. 12 for locus D19;

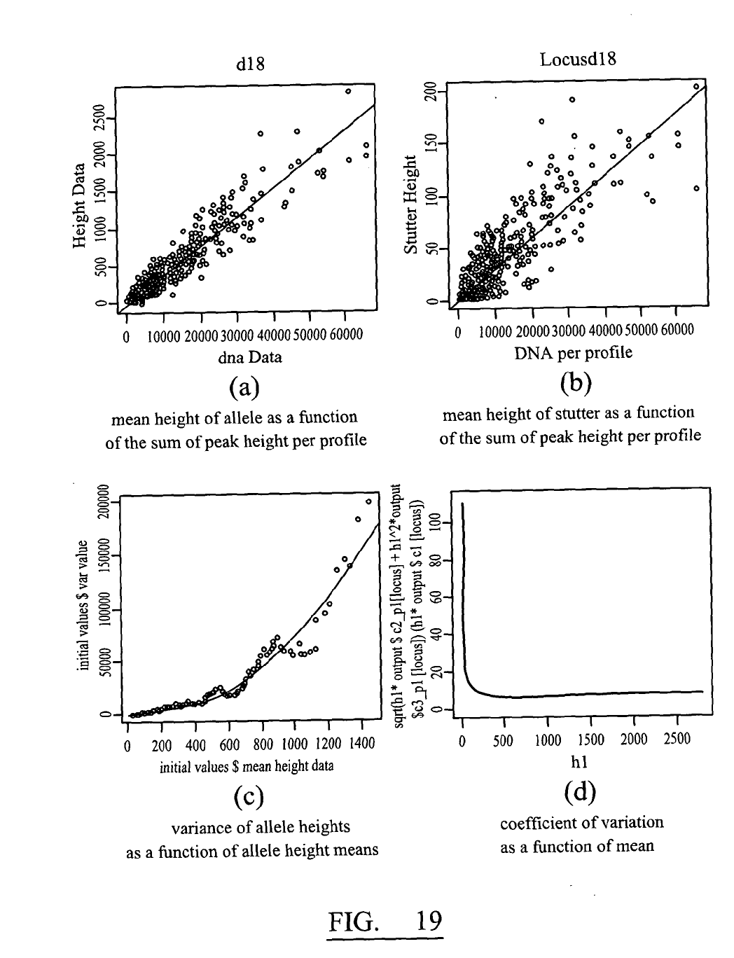

FIG. 21 shows the plots of FIG. 12 for locus THO;

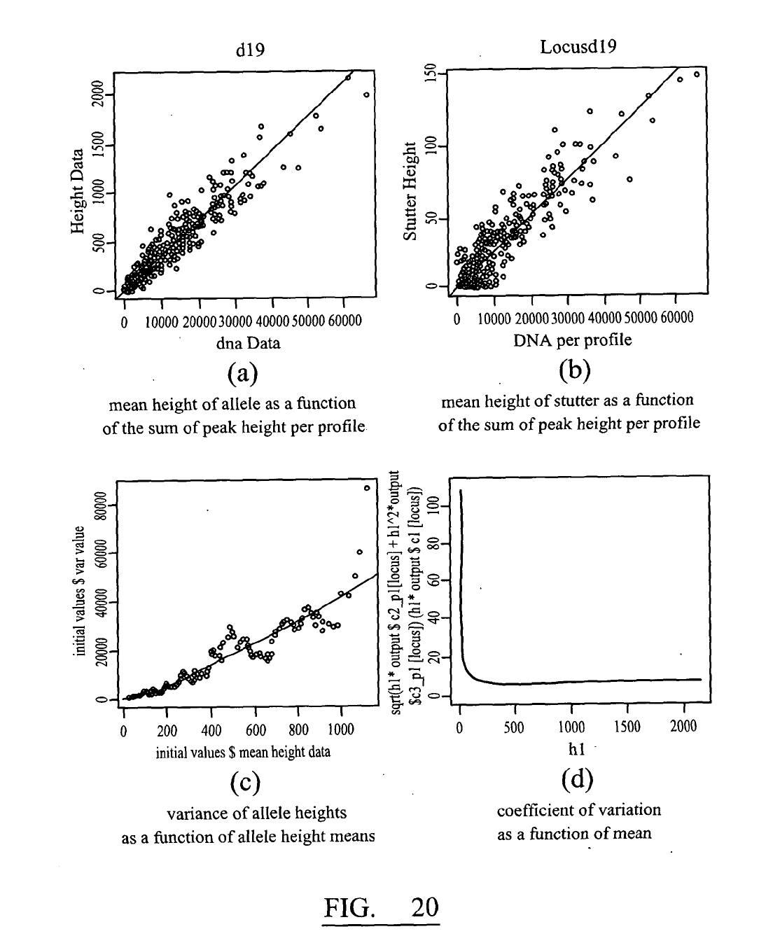

FIG. 22 shows the plots of FIG. 12 for locus FGA;

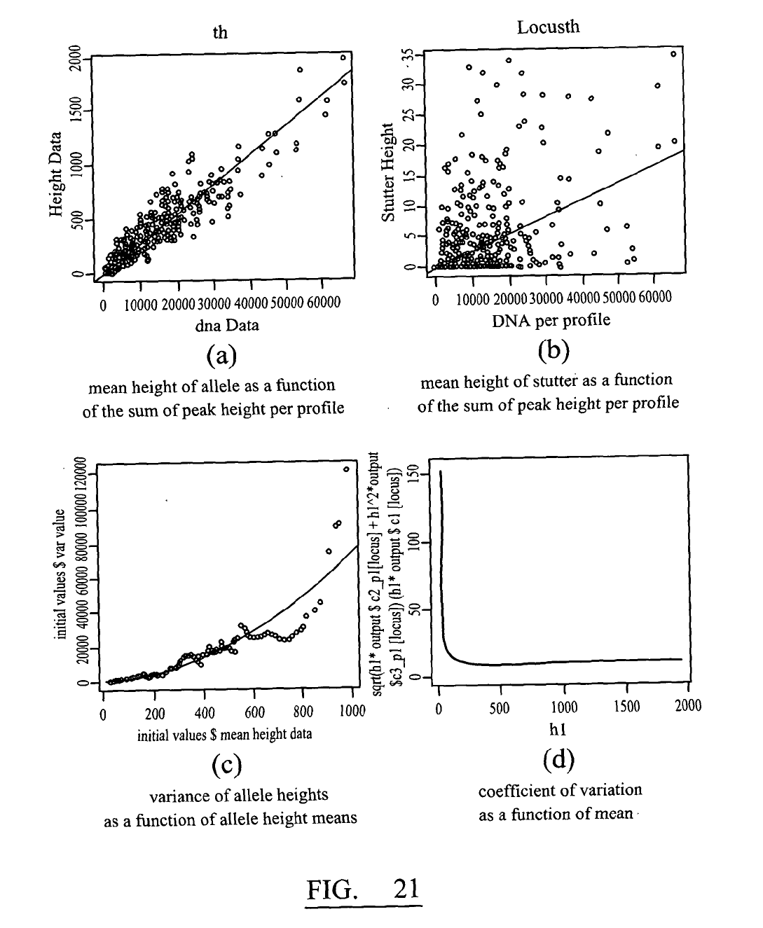

FIG. 23 is a table showing degraded profile information;

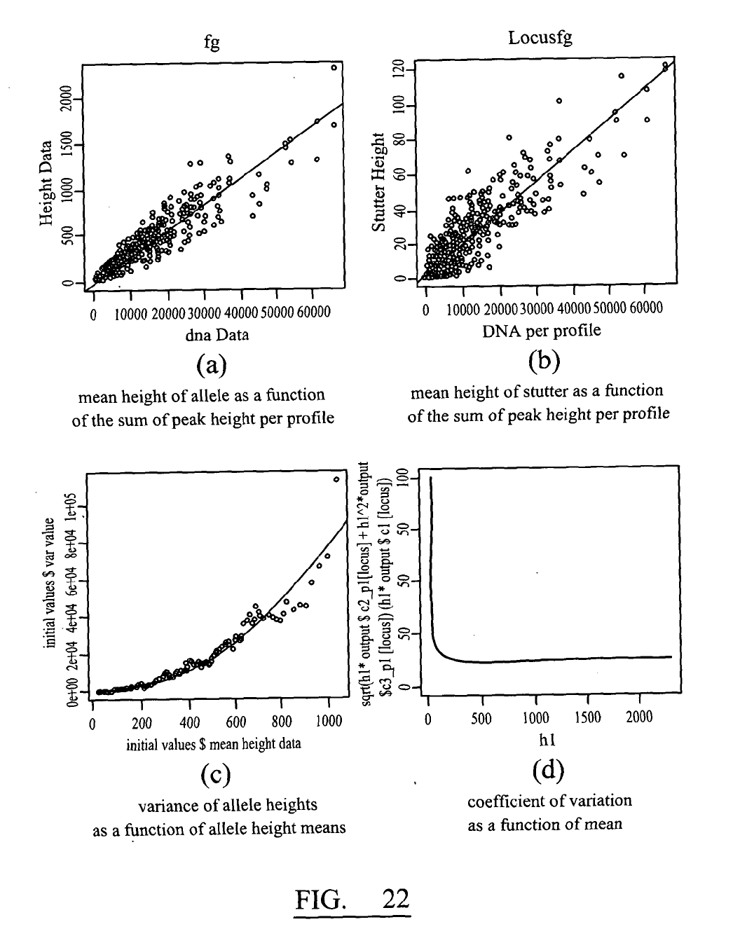

FIG. 24 is a plot of DNA quantity in a locus against allele base pairs;

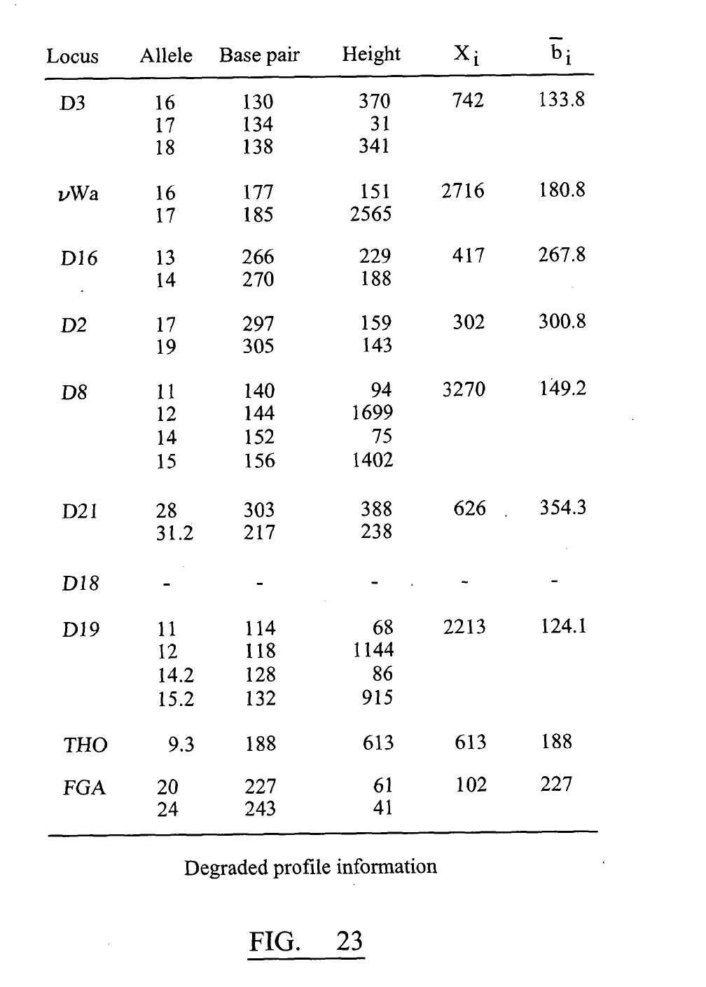

FIG. 25 is a table showing two examples of the degradation model as deployed;

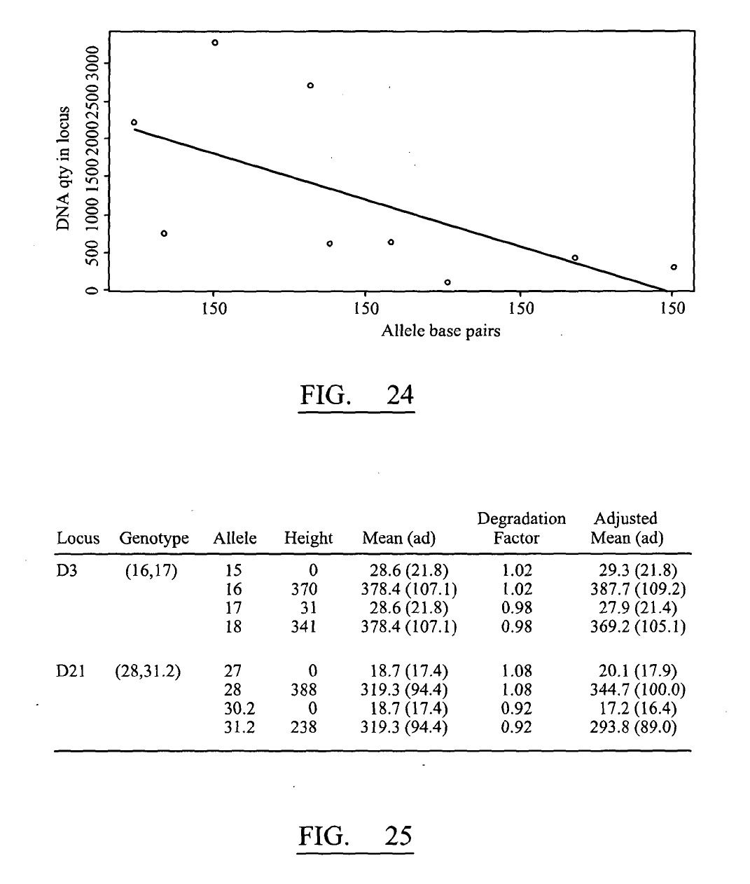

FIGS. 26a,b,c and d show developing Bayesian Networks

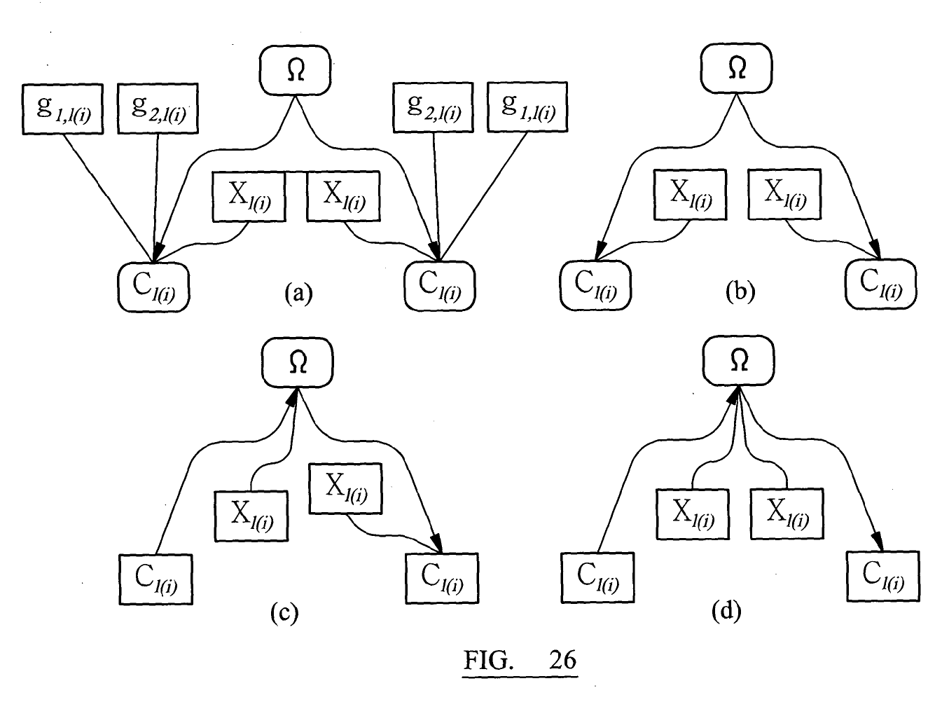

FIGS. 27a and b illustrate the variation in allele and stutter data sets with their corresponding means and 99% probability intervals;

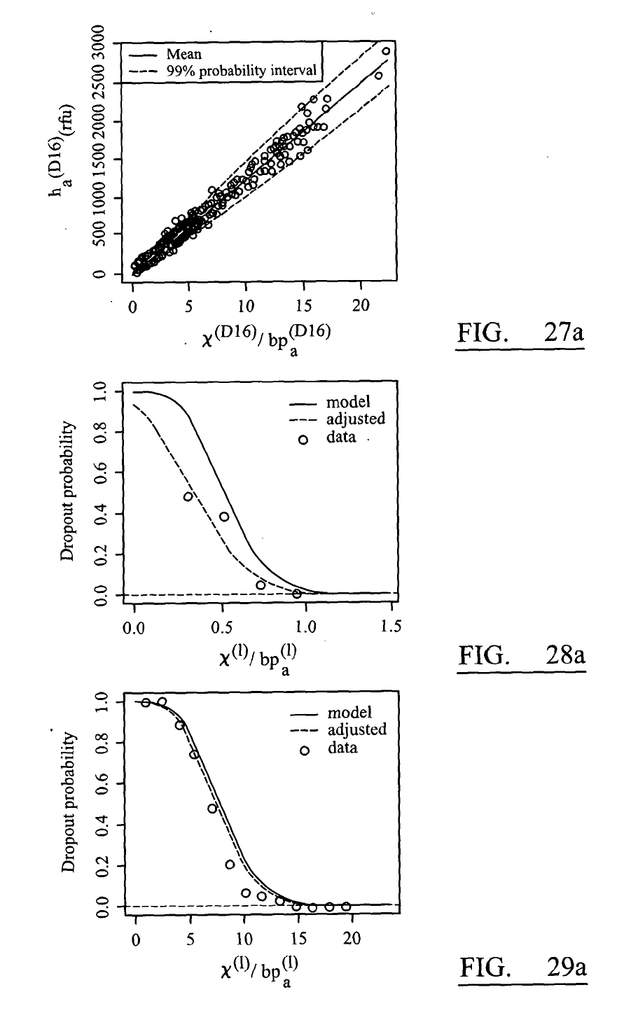

FIGS. 28a and b illustrate the adjustment of the dropout probability and a parameter for allelic peaks;

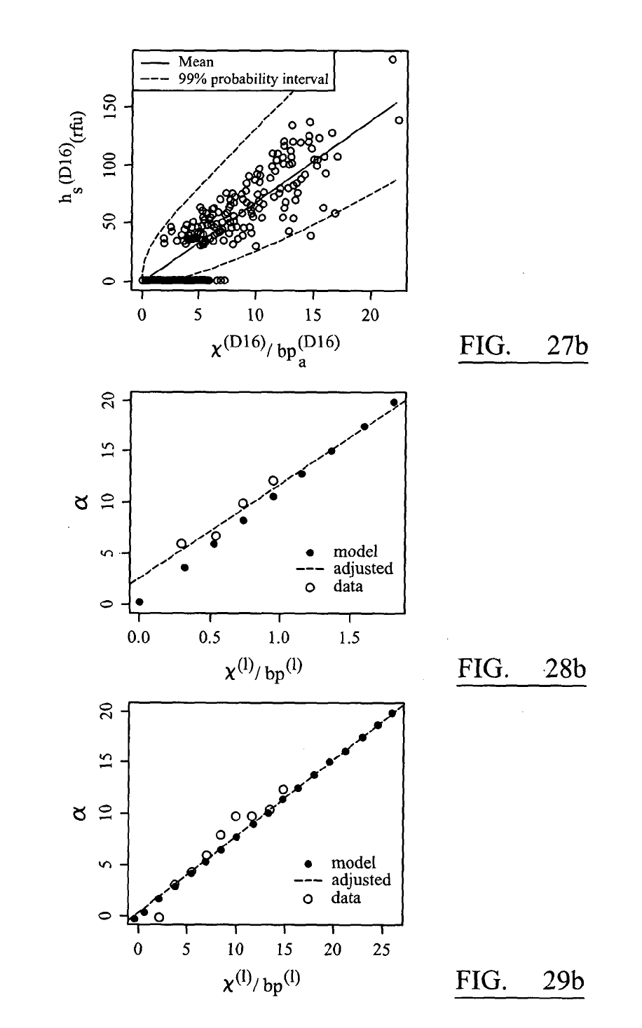

FIGS. 29a and b illustrate the adjustment of the dropout probability and a parameter for stutter peaks;

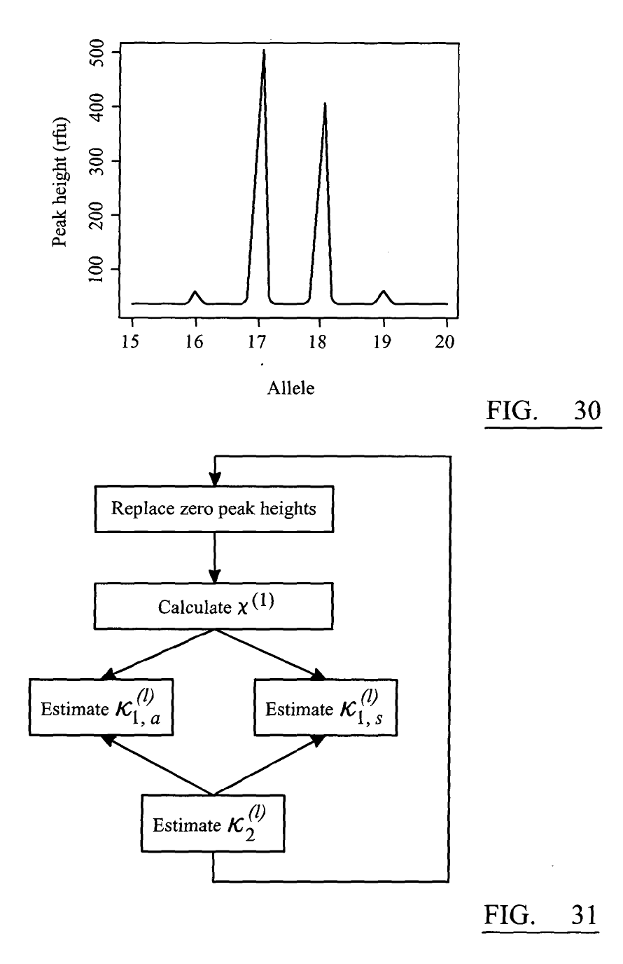

FIG. 30 illustrates a profile; and

FIG. 31 is a diagrammatic representation of an estimation process of use in the invention.

### 1. BACKGROUND

The present invention is concerned with improving the interpretation of DNA analysis. Basically, such analysis involves taking a sample of DNA, preparing that sample, amplifying that sample and analysing that sample to reveal a set of results. The results are then interpreted with respect to the variations present at a number of loci. The identities of the variations give rise to a profile.

The extent of interpretation required can be extensive and/or can introduce uncertainties. This is particularly so where the DNA sample contains DNA from more than one person, a mixture.

The profile itself has a variety of uses; some immediate and some at a later date following storage.

There is often a need to consider various hypotheses for the identities of the persons responsible for the DNA and evaluate the likelihood of those hypotheses, evidential uses.

There is often a need to consider the analysis genotype against a database of genotypes, so as to establish a list of stored genotypes that are likely matches with the analysis genotype, intelligence uses.

Previously the generally accepted method for assigning evidential weight of single profiles is a binary model. After interpretation, a peak is either in the profile or is excluded from the profile.

When making the interpretation, quantitative information is considered via thresholds which determine decisions and via expert opinion. The thresholds seek to deal with allelic dropout, in particular; the expert opinion seeks to deal with heterozygote imbalance and stutters, in particular. In effect, these approaches acknowledged that peak heights and/or areas and/contain valuable information for assigning evidential weight, but the use made is very limited and is subjective.

The binary nature of the decision means that once the decision is made, the results only include that binary decision. The underlying information is lost.

Previously, as exemplified in International Patent Application no PCT/GB2008/003882, a specification of a model for computing likelihood ratios (LRs) that uses peak heights taken from such DNA analysis has been provided. This quantified and modelled the relationship between peaks observed in analysis results. The manner in which peaks move in height (or area) relative to one another is considered. This makes use of a far greater part of the underlying information in the results.

### 2. OVERVIEW

The aim of this invention is to describe in detail the statistical model for computing likelihood ratios for single profiles while considering peak heights, but also taking into consideration allelic dropout and stutters. The invention then moves on to describe in detail the statistical model for computing likelihood ratios for mixed profiles which considering peak heights and also taking into consideration allelic dropout and stutters.

The present invention provides a specification of a model for computing likelihood ratios (LR's) given information of a different type in the analysis results. The invention is useful in its own right and in a form where it is combined with the previous model which takes into account peak height information.

One such different type of information considered by the present invention is concerned with the effect known as stutter.

Stutter occurs where, during the PCR amplification process, the DNA repeats slip out of register. The stutter sequence is usually one repeat length less in size than the main sequence. When the sequences are separated using electrophoresis to separate them, the stutter sequence gives a band at a different position to the main sequence. The signal arising for the stutter band is generally of lower height than the signal from the main band. However, the presence or absence of stutter and/or the relative height of the stutter peak to the main peak is not constant or fully predictable. This creates issues for the interpretation of such results. The issues for the interpretation of such results become even more problematic where the sample being considered is from mixed sources. This is because the stutter sequence from one person may give a peak which coincides with the position of a peak from the main sequence of another person. However, whether such a peak is in part and/or wholly due to stutter or is nothing to do with stutter is not a readily apparent position.

A second different type of information considered by the present invention is concerned with dropout.

Dropout occurs where a sequence present in the sample is not reflected in the results for the sample after analysis. This can be due to problems specific to the amplification of that sequence, and in particular the limited amount of DNA present after amplification being too low to be detected. This issue becomes increasingly significant the lower the amount of DNA collected in the first place is. This is also an issue in samples which arise from a mixture of sources because not everyone contributes an equal amount of DNA to the sample.

The present invention seeks to make far greater use of a far greater proportion of the information in the results and hence give a more informative and useful overall result.

To achieve this, the present invention includes the use of a number of components. The main components are:
1. An estimated PDF for homozygote peaks conditional on DNA quantity; discussed in detail in LR Numerator Quantification Category 1;
2. An estimated PDF for stutter heights conditional on the height of the parent allele; discussed in detail in LR Numerator Quantification Category 1;
3. An estimated joint probability density function (PDF) of peak height pairs conditional on DNA quantity; discussed in detail in LR Numerator Quantification Category 2. The peak heights are right censored by the limit of detection threshold T_{d}. Below this threshold it is not safe to designate alleles, as the peaks are too close to the baseline to be distinguished from other elements in the signal. Threshold T_{d} can be different to the limit-of-detection threshold at 50 rfu suggested by the manufacturers of typical instruments analysing such results.
4. A latent variable X representing DNA quantity that models the variability of peak heights across the profile. It does not consider degradation, but degradation can be incorporated by adding another latent variable Δ that discounts DNA quantity according to a numerical representation of the molecular weight of the locus.
5. The calculation of the LR is done separately for the numerator and the denominator. The overall joint PDF for the numerator and the denominator can be represented with Bayesian networks (BNs).

### 3. DETAILED DESCRIPTION SINGLE PROFILE

### 3.1—The Calculation of the Likelihood Ratio

The explanation provides:
a definition of the Likelihood Ratio, LR, to be considered;
then considers the numerator, its component parts and the manner in which they are determined;
then considers the denominator, its component parts and the manner in which they are determined;
then combines the position reached in a further discussion of the LR.

The explanation is supplemented by the specifics of the approach in particular cases.

An LR summarises the value of the evidence in providing support to a pair of competing propositions: one of them representing the view of the prosecution (Vₚ) and the other the view of the defense (V_{d}). The usual propositions are:
1) Vₚ: The suspect is the donor of the DNA in the crime stain;
2) V_{d}: Someone else is the donor of the DNA in the crime stain.

The possible values that a crime stain can take are denoted by C, the possible values that the suspect's profile can take are denoted by Gₛ. A particular value that C takes is written as c, and a particular value that Gₛ takes is denoted by gₛ. In general, a variable is denoted by a capital letter, whilst a value that a variable takes is denoted by a lower-case letter.

We are interested in computing:

$$LR = \frac{p ( c , {g}_{s} \vert {V}_{p} )}{p ( c , {g}_{s} \vert {V}_{d} )} = \frac{f ( c , {g}_{s} \vert {V}_{p} )}{f ( c , {g}_{s} \vert {V}_{d} )}$$

In effect ƒ is a model of how the peaks change with different situations, including the different situations possible and the chance of each of those.

The crime profile c in a case consists of a set of crime profiles, where each member of the set is the crime profile of a particular locus. Similarly, the suspect genotype gₛ is a set where each member is the genotype of the suspect for a particular locus. We use the notation:

c={c_{L(i)}:i=,2, . . . ,n_{Loci}} and gs={gs,_{L(i)}:=1,2, . . . ,n_{Loci}}

where n_{Loci} is the number of loci in the profile.

### 3.2—The LR Numerator Form

The calculation of the numerator is given by:

Lₚ=ƒ(c|gₛ,Vₚ)

Because peak height is dependent between loci and needs to be rendered independent, the likelihood Lₚ is factorised conditional on DNA quantity χ. This is because the peak height between loci is also dependent on DNA quantity. This gives:

L_{P}=ƒ(cₕ|gₛ,h,χ,Vₚ)

It will be recalled, that c is a crime profile across loci consisting of per locus profiles, so for a three locus form c={c_{L(1)}, c_{L(2)}, c_{L(3)}} and similarly for gₛ. We can therefore write the initial equation as:

Lₚ=ƒ(c_{L(1)},c_{L(2)},c_{L(3)},|g_{s,L(1)},g_{s,L(2)},g_{s,L(3)},Vₚ)

The combination of the two previous equations, to give conditioning on quantity and expansion per locus gives:

Lₚ=ƒ(c_{L(1)},|g_{s,L(1)},χᵢ,Vₚ)xƒ(c_{L(2)}|g_{s,L(2)},χᵢ,Vₚ)xƒ(c_{L(3)}|g_{s,L(3)},χᵢ,Vₚ)

which can be stated as:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

where L_{p,L(j)}(χᵢ) is the likelihood for locus j conditional on DNA quantity, this assumes the abstracted form:

L_{p,L(j)}(χ)=ƒ(c_{L(j)}|g_{s,L(j)},Vₚ,χⱼ)

or:

L_{p,L(j)}(χ)=ƒ(c_{L(j)}|gₕ₍ⱼ₎,V,χⱼ)

A pictorial description of this calculation is given by the Bayesian Network illustrated in FIG. 1. The Bayesian network is for calculating the numerator of the likelihood ratio; hence, the network is conditional on the prosecution view Vₚ. The rectangles represent know quantities. The ovals represent probabilistic quantities. Arrows represent probabilistic dependencies, e.g. the PDF of C_{L(1)} is given for each value of g_{s,L(1)} and χ.

Here we assume that the crime profile C_{L(i)} is conditionally independent of C_{L(j)} given DNA quantity X for i≠j,i,jε{1, 2, . . . , n_{L}}. It can be written as:

C_{L(1)} [symbol] C_{L}_{ⱼ}_{|}X

In the Bayesian Network we can see that a path from C_{L(1)} to C_{L(2)} passes through χ.

We also assume that is sufficient to use a discrete probability distribution on DNA quantity as an approximation to a continuous probability distribution. This discrete probability distribution is written as {Pr(χ=χᵢ): i=1, 2, . . . , nₓ}. It can be written simply by {p(χᵢ): i=1, 2, . . . , n_{χ}}.

The likelihood in L_{p,L(j)}(χ)=ƒ(c_{L(j)|}g_{s,L(j)},Vₚ,X) specified a likelihood of the heights in the crime profile given the genotype of a putative donor, and so, they can be written as:

L_{L(i)}(χ)=ƒ(c_{L(j)|}g_{L(j)},V,χ)

where V states that the genotype of the donor of crime profile c_{L(i)} is g_{L(j)}. The calculation of the likelihood is discussed below after the discussion of the denominator.

In general terms, the numerator can be stated as:

$${\sum }_{{χ}_{i}} [ {Π}_{j}^{n loci} f ( {c}_{h ( j )} \vert {g}_{s , L ( j )} , {V}_{p} , {χ}_{i} ) ] p ( {χ}_{i} )$$

where the consideration is in effect, the genotype (gₛ) is the donor of (cₕ₍ⱼ₎) given the DNA quantity (χᵢ).

The general statements provided above for the numerator enable a suitable numerator to be established for the number of loci under consideration.

### 3.3—The LR Numerator Quantification

All LR calculations fall into three categories. These apply to the numerator and, as discussed below, the denominator. The genotype of the profile's donor is either:
1) a heterozygote with adjacent alleles; or
2) a heterozygote with non-adjacent alleles; or
3) a homozygote.
   A Bayesian Network for each of these three forms is shown in FIG. 7; left to right, homozygote; non-adjacent heterozygite; adjacent heterozygote.

### 3.3.1—Category 1: Homozygous Donor

### 3.3.1.1—Stutter

FIG. 2a illustrates an example of such a situation. The example has a profile, C_{L(3)}={h₁₀,h₁₁} arising from a genotype, g_{L(3)}={11,11}. The consideration is of a donor which is homozygous giving a two peak profile, potentially due to stutter.

This position can be stated in the Bayesian Network of FIG. 2b. The stutter peak height for allele 10, H_{stutter,10}, is dependent upon the allele peak height 11, H_{allele,11}, which in turn is dependent upon the DNA quantity, χ.

In this context, χ, is assumed to be a known quantity. H_{stutter,10} is a probability distribution function, PDF, which represents the variation in height of the stutter peak with variation in height of the allele peak, H_{allele,11}. H_{allele,11} is a probability distribution, PDF, which represent the variation in height of the allele peak with variation in DNA quantity. In effect, there is a PDF for stutter peak height for each value within the PDF for the allele peak height. The concept is illustrated in FIG. 2c. In the first case shown in FIG. 2c, the allele peak has a height h and the stutter PDF has a range from 0 to x. In the second case shown, the allele peak has a greater height, h+ and the stutter PDF has a range of 0 to x+. Different values within the range have different probabilities of occurrence.

### 3.3.1.2—PDF for Allele Peak Height with DNA Quantity

### Details

The PDF for allele peak height, H_{allele,11} in the example, can be obtained from experimental data, for instance by measuring allele peak height for a large number of different, but known DNA quantities.

The model for peak height of homozygote donors is achieved using a Gamma distribution for the PDF, ƒ(h|χ), for peak heights of homozygote donors given DNA quantity χ.

A Gamma PDF is fully specified through two parameter: the shape parameter α and the rate parameter β. These parameters are specified through two parameters: the mean height h̅, which models the mean value of the homozygote peaks, and parameter k that models the variability of peak heights for the given DNA quantity χ.

The mean value h̅ is calculated through a linear relationship between mean heights and DNA quantity, as shown in FIG. 2d. The equation of the straight line is given by:

h̅=−12.94+1.27×χ

The line was estimated and plotted using fitHomPDFperX.r. The plot was produced with plot_HomHgivenXPDFs.r.

The variance is modelled with a factor k which is set to 10. The parameters α and β of the Gamma distribution are:

α= h̅/k and β=α/ h̅

### 3.3.1.3—PDF for Stutter Peak Height with Allele Peak Height

### Details

The PDF for stutter peak height, H_{stutter,10} in the example, can also be obtained from experimental data, for instance by measuring the stutter peak height for a large number of different, but known DNA quantity samples, with the source known to be homozygous. These results can be obtained from the same experiments as provide the allele peak height information mentioned in the previous paragraph.

For each parent height there is a Beta distribution describing the probabilistic behaviour of the stutter height. The generic formula for a Beta PDF is:

$$f ( y \vert α , β ) = \frac{Γ ( α + β )}{Γ ( α ) Γ ( β )} {{y}^{α - 1} ( 1 - y )}^{β - 1}$$

The conditional PDF ƒ_{H}_{ₛ}_{|}_{_{H}} is in fact specified through the parameters of the Beta distribution that models stutter proportions, that is, stutter height divided by parent allele height. More specifically

$${f}_{{H}_{s}} {\vert}_{H} ( {h}_{s} \vert h ) = \frac{1}{h} \times f π {}_{s} {\vert}_{H} ( π {}_{s} \vert α ( h ) , β ( h ) )$$

where α(h) and β(h) are the parameters of a Beta PDF. Notice that α(h) and β(h) are dependent, or

functions of the height h of the parent allele. FIG. 2e shows a plot of the parameters as a function of h. These values will be stored digitally.

### 3.3.1.4 Further Details

The methodology can be applied with a PDF for allele height for all loci, but preferably with a separate PDF for allele height for each locus considered. A separate PDF for each allele at each locus is also possible. The methodology can be applies with a PDF for stutter height for all loci, but preferably with a separate PDF for stutter height at each locus considered. A separate PDF for each allele at each locus is also possible.

In an example where locus three is under consideration and the allele peak is 11 and stutter peak is 10, the PDF for this case is given by the formula:

ƒ_{L(3)}(h₁₀,h₁₁)=ƒₛ(h₁₀|h₁₁)ƒₕₒₘ(h₁₁)

This formula can be abstracted to give the generic form:

ƒ_{L(j)}(hₛₜᵤₜₜₑᵣ,hₐₗₗₑₗₑ)=ƒₛ(hₛₜᵤₜₜₑᵣ|hₐₗₗₑₗₑ)ƒₕₒₘ(hₐₗₗₑₗₑ)

with the manner for obtaining the PDF's as described above.

### 3.3.1.5—Extension to Possible Dropout

The formula ƒ_{L(3)}(h₁₀,h₁₁), more generically, ƒ_{L(j)}(hₐₗₗₑₗₑ₁,hₐₗₗₑₗₑ₂), gives density values for any positive value of the arguments. In many occasions either technical dropout or dropout has occurred and therefore we need to perform some integrations. Three possible cases are considered.

Possible Case One—h₁₀≧T_{d},h₁₁≧T_{d}

If both heights in c_{L(3)} are taller than the limit of detection threshold T_{d}, then the numerator is given by

L_{L(3)}(χ)=ƒ_{L(3)}(h₁₀,h₁₁)

Or generically as:

L_{L(j)}(χ)=ƒ_{L(j)}(hₐₗₗₑₗₑ₁,hₐₗₗₑₗₑ₂)

Possible Case Two—h₁₀ [symbol] T_{d},h₁₁≧T_{d}

In this case the height of the stutter is less than the limit-of-detection threshold and so, we need to perform one integral.

L_{L(3)}(χ)=∫₀^{T}^{_{d}}ƒ_{L(3)}(h₁₀,h₁₁)dh₁₀

It can be approximated by:

$${L}_{L ( 3 )} ( χ ) \approx {\sum }_{{h}_{10} = 1}^{{T}_{d}} {f}_{L ( 3 )} ( {h}_{10} , {h}_{11} )$$

Or more generically as:

$${L}_{L ( j )} ( χ ) \approx {\sum }_{{h}_{allele 1} = 1}^{{T}_{d}} {f}_{L ( j )} ( {h}_{allele 1} , {h}_{allele 2} )$$

Possible Case Three—h₁₀ [symbol] T_{d},h₁₁ [symbol] T_{d}

In this case, the height of both the peaks is less than the limit of detection threshold.

L_{L(3)}(χ)=∫₀^{T}^{_{d}}∫ₕ_{₁₀}^{T}^{_{d}}ƒ_{L(3)}(h_{10,}h₁₁)dh₁₀dh₁₁.

It can be approximated by:

$${L}_{L ( 3 )} ( χ ) \approx {\sum }_{{h}_{10} = 1}^{{T}_{d}} {\sum }_{{h}_{11} = {h}_{10} + 1}^{{T}_{d}} {f}_{L ( 3 )} ( {h}_{10} , {h}_{11} )$$

Or more generically as:

$${L}_{L ( j )} ( χ ) \approx {\sum }_{{h}_{allele 1} = 1}^{{T}_{d}} {\sum }_{{h}_{allele 2} = {h}_{allele 1} + 1}^{{T}_{d}} {f}_{L ( j )} ( {h}_{allele 1} , {h}_{allele 2} )$$

### 3.3.2—Category 2: Heterozygous Donor with Non-Adjacent Alleles

### 3.3.2.1—Stutter

FIG. 3a illustrates an example of such a situation. The example has a profile, C_{L(2)}={h₁₈,h₁₉,h₂₀,h₂₁}, arising from a genotype, g_{L(2)}={19,21}. The consideration is of a donor which is heterozygous, but the peaks are spaced such that a stutter peak cannot contribute to an allele peak. The same approach applies where the allele peaks are separated by two or more allele positions.

This position can be stated as in the Bayesian Network of FIG. 3b. The stutter peak height for allele 18, H_{stutter,18}, is dependent upon the allele peak height for allele 19, H_{allele,19}, which is in turn dependent upon the DNA quantity, χ. The stutter peak height for allele 20, H_{stutter,20}, is dependent upon the allele peak height for allele 21, H_{allele,21}, which is in turn dependent upon the DNA quantity, χ.

In this context, χ, is assumed to be a known quantity. H_{stutter,18} is a probability distribution function, PDF, which represents the variation in height of the stutter peak with variation in height of the allele peak, H_{allele,19}. H_{allele,19} is a probability distribution, PDF, which represent the variation in height of the allele peak with variation in DNA quantity. H_{stutter,20} is a probability distribution function, PDF, which represents the variation in height of the stutter peak with variation in height of the allele peak, H_{allele,21}. H_{allele,21} is a probability distribution, PDF, which represent the variation in height of the allele peak with variation in DNA quantity.

These PDF's can be the same PDF's as described above in category 1, particularly where the same locus is involved. As previously mentioned, the PDF's for these different alleles and/or PDF's for these different stutter locations may be different for each allele.

The consistent nature of the PDF's with those described above means that a similar position to that illustrated in FIG. 2c occurs. Equally, these PDF's too can be obtained from experimental data.

FIG. 8b provides a further illustration of the variation in mean height with DNA quantity (similar to FIG. 2d). Whilst FIG. 8a provides an illustration of such variance modelling, with the value of profile mean plotted against profile standard deviation.

In addition, the Bayesian Network of FIG. 3b indicates that both the allele peak height for allele 19, H_{allele,19}, and the allele peak height for allele 21, H_{allele,21}, are dependent upon the heterozygous imbalance, R and the mean peak height, M, with those terms also dependent upon each other and upon the DNA quantity, χ.

The heterozygous imbalance is defined as:

$$r = \frac{{h}_{19}}{{h}_{21}}$$

or generically as:

$$r = \frac{{h}_{allele 1}}{{h}_{allele 2}}$$

The mean height is defined as:

$$m = \frac{{h}_{19} + {h}_{21}}{2}$$

or generically as:

$$m = \frac{{h}_{allele 1} + {h}_{allele 2}}{2}$$

The PDF for ƒ(h₁₉,h₂₁) is defined as:

ƒ(h₁₉,h₂₁)=|J|·ƒ(r|m)·ƒ(m)

with the heterozygous imbalance, r, having a PDF of the lognormal form, for each value of m, so as to give a family of lognormal PDF's overall; and with the mean, m, having a PDF of gamma form, for each value of χ, with a series of discrete values for χ being considered.

FIG. 9 illustrates a PDF for R|M=m using such an approach.

### 3.3.2.2—Joint PDF for Peak Pair Heights

### Details

Providing further detail on this, the specification of a joint distribution of pairs of peak heights h₁ and h₂ is described.

The specification is done by the specification of a joint distribution of mean height m and heterozygote imbalance, which is given by

$$( {h}_{1} , {h}_{2} ) ↦ ( m = \frac{{h}_{1} + {h}_{2}}{2} , r = \frac{{h}_{1}}{{h}_{2}} )$$

If we specify a joint PDF for mean height M and heterozygote imbalance R we can obtain a joint PDF for peak heights H₁ and H₂ using the formula:

$${f}_{H 1 , H 2} ( {h}_{1} , {h}_{2} \vert χ ) = \frac{1}{{h}_{2}^{2}} ( \frac{{h}_{1} + {h}_{2}}{2} ) \times {f}_{M , R} ( m , r \vert χ )$$

In fact we specify the joint distribution of M and R through the marginal distribution of M,ƒ_{M}(m|χ), and the conditional distribution of R given M,ƒ_{R|}_{_{M}}(r|m). With these considerations the joint PDF for heights is given by the formula:

$${f}_{H 1 , H 2} ( {h}_{1} , {h}_{2} \vert χ ) = \frac{1}{{h}_{2}^{2}} ( \frac{{h}_{1} + {h}_{2}}{2} ) \times {f}_{R , M} ( r \vert m ) {f}_{M} ( m \vert χ )$$

Notice that the PDF for M is conditional on DNA quantity X. This is a feature in the model that allow for dependence among peak heights in a profile.

In the following description we specify the PDF's for M and R|M=m

### 3.3.2.3—PDFs for Mean Height Given DNA Quantity

### Details

The PDF ƒ_{M}(m|χ) represents a family of PDF's for mean height, one for each value of DNA quantity.

This model the behaviour of peak heights in a profile: the more DNA, the higher the peaks, of course, up to some variability.

The Gamma PDF is given by the formula:

$$f ( x α , β ) = \frac{1}{{s}^{α} Γ ( α )} {x}^{α - 1} {e}^{- x / s}$$

where s−i/P. Parameter α is the shape parameter, β is the rate parameter and so, s is the scale parameter.

Therefore, the specification of the Gamma PDF's is achieved through the specification of the parameter α and β parameters as a function of DNA quantity χ. We achieve this through two intermediary parameters m̅ and k that model the mean value and the variance of M, respectively. The mean of the Gamma distributions is given by a linear function displayed in FIG. 3d. The equation of the line is:

m̅=−8.69+0.66×χ

The variance is controlled by a factor k, which is set to 10 although it will change in the future. Now that we have the parameters m̅ and k, we can compute the parameters of α and β of a Gamma distribution using the formula:

α= m̅/k,β=α/ m̅

For illustrative purposes, a selection of the Gamma distributions is shown in FIG. 3e.

### 3.3.2.4—PDFs for Heterozygote Imbalance Given Mean Height

### Details

The conditional PDFs of heterozygote imbalance are modelled with lognormal PDFs whose PDF is given by

$${f}_{R} ( r \vert μ , σ ) = \frac{1}{r \times σ ( m ) \sqrt{2 π}} {exp}^{\frac{- {( ln ( r ) - μ )}^{2}}{2 σ ( m )}}$$

A Lognormal PDF is fully specified through parameters μ and σ(m). The latter parameter is dependent on the mean height m by the plot in FIG. 3f. The transfer of the actual values can be done digitally. Currently the parameters are stored in log NPars·rData.

### 3.3.2.5—Further Details

As a result, PDF's have been determined for the six dependents in FIG. 3b.

Given the above, the Bayesian Network of FIG. 3b can be simplified to the form of FIG. 3c.

In an example where locus 2 is under consideration and the allele peaks are at 19 and 21 and the stutter peaks are at 18 and 20, the generic PDF for this calculation is given by the formula:

ƒ_{L(2)}(h₁₈,h₁₉,h₂₀,h₂₁)=ƒₛ(h₁₈|h₁₉)ƒₛ(h₁₈|h₁₉)ƒₛ(h₂₀|h₂₁)ƒₕₑₜ(h₁₉|h₂₁)

This formula can be abstracted to give the generic form:

ƒ_{L(j)}(hₛₜᵤₜₜₑᵣ₁,hₐₗₗₑₗₑ₁,hₛₜᵤₜₜₑᵣ₂,hₐₗₗₑₗₑ₂)=ƒₛₜᵤₜₜₑᵣ(hₛₜᵤₜₜₑᵣ₁|hₐₗₗₑₗₑ₁)ƒₛₜᵤₜₜₑᵣ(hₛₜᵤₜₜₑᵣ₂|hₐₗₗₑₗₑ₂)ƒₕₑₜ(hₐₗₗₑₗₑ₁|hₐₗₗₑₗₑ₂)

The manner for obtaining the PDF's is as described above with respect to the simplified form too.

### 3.3.2.6—Extension to Possible Dropout

The formula ƒ_{L(2)}(h₁₈,h₁₉,h₂₀,h₂₁), more generically ƒ_{L(j)}(hₛₜᵤₜₜₑᵣ₁,hₐₗₗₑₗₑ₁,hₛₜᵤₜₜₑᵣ₂,hₐₗₗₑₗₑ₂), gives density values for any positive value of the arguments. In many occasions either technical dropout, where a peak is smaller than the limit-of-detection threshold T_{d}, or dropout, where a peak is in the baseline, have occurred and therefore we need to perform some integrations. Eight possible cases are considered.

Possible Case One—h₁₈≧T_{d},h₁₉≧T_{d},h₂₀≧T_{d},h₂₁≧T_{d}

In this case we do not need to compute any integration and

L_{L(2)}(χ)=ƒ_{L(2)}(h₁₈,h₁₉,h₂₀,h₂₁)

Or more generically:

L_{L(j)}(χ)=ƒ_{L(j)}(hₛₜᵤₜₜₑᵣ₁,hₐₗₗₑₗₑ₁,hₛₜᵤₜₜₑᵣ₂,hₐₗₗₑₗₑ₂)

Possible Case Two—h₁₈≧T_{d},h₁₉≧T_{d},h₂₀ [symbol] T_{d},h₂₁ [symbol] T_{d}

In this case we need to compute two integrations:

L_{L(2)}(χ)=·₀^{T}^{_{d}}·ₕ_{₂₀}^{T}^{_{d}}ƒ_{L(2)}(h₁₈,h₁₉,h₂₀h₂₁)dh₂₀dh₂₁.

It can be approximated with the following summations:

$${L}_{L ( 2 )} ( χ ) \approx {\sum }_{{h}_{20} = 1}^{{T}_{d}} {\sum }_{{h}_{21} = {h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stuttere 2} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 1} , {h}_{stutter 2} , {h}_{allele 2} )$$

Possible Case Three—h₁₈ [symbol] T_{d},h₁₉≧T_{d},h₂₀≧T_{d},h₂₁≧T_{d}

In this case we need only one integration:

L_{L(2)}(χ)=∫₀^{T}^{_{d}}ƒ_{L(2)}(h₁₈,h₁₉,h₂₀h₂₁)dh₁₈

It can be approximated as summation:

$${L}_{L ( 2 )} ( χ ) \approx {\sum }_{{h}_{18} = 1}^{{T}_{d}} {f}_{L ( 2 )} ( {h}_{18} , {h}_{19} , {h}_{20} , {h}_{21} )$$

Or more generically as:

$${L}_{L ( j )} ( χ ) \approx {\sum }_{{h}_{stutter 1} = 1}^{{T}_{d}} {f}_{L ( j )} ( {h}_{stutter 1} , {h}_{allele 1} , {h}_{stutter 2} , {h}_{allele 2} )$$

Possible Case Four—h₁₈ [symbol] T_{d},h₁₉≧T_{d},h₂₀ [symbol] T_{d},h₂₁≧T_{d}

Two integrations are required. The likelihood is given by:

L_{L(2)}(χ)=∫₀^{T}^{_{d}}·₀^{T}^{_{d}}ƒ_{L(2)}(h₁₈,h₁₉,h₂₀h₂₁)dh₁₈dh₂₀.

It can be approximated by:

$${L}_{L ( 2 )} ( χ ) \approx {\sum }_{{h}_{18} = 1}^{{T}_{d}} {\sum }_{{h}_{20} = 1}^{{T}_{d}} {f}_{L ( 2 )} ( {h}_{18} , {h}_{19} , {h}_{20} , {h}_{21} )$$

Or more generically as:

$${L}_{L ( j )} ( χ ) \approx {\sum }_{{h}_{stutter 1} = 1}^{{T}_{d}} {\sum }_{{h}_{stutter 2} + 1}^{{T}_{d}} {f}_{L ( j )} ( {h}_{stutter 1} , {h}_{allele 1} , {h}_{stutter 2} , {h}_{allele 2} )$$

Possible Case Five—h₁₈ [symbol] T_{d},h₁₉≧T_{d},h₂₀ [symbol] T_{d},h₂₁ [symbol] T_{d}

We need three integrations.

L_{L(2)}(χ)=∫₀^{T}^{_{d}}∫₀^{T}^{_{d}}∫ₕ_{₂₀}^{T}^{_{d}}ƒ_{L(2)}(h₁₈,h₁₉,h₂₀,h₂₁)dh₁₈dh₁₉dh₂₀dh₂₁.

The likelihood is approximated with the summations:

$${L}_{L ( 2 )} ( χ ) \approx {\sum }_{{h}_{18} = 1}^{{T}_{d}} {\sum }_{{h}_{20} = 1}^{{T}_{d}} {\sum }_{{h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{stutter 2} = 1}^{{T}_{d}} {\sum }_{{h}_{stutter 2} + 1}^{{T}_{d}} {f}_{L ( j )} ( {h}_{stutter 1} , {h}_{allele 1} , {h}_{stutter 2} , {h}_{allele 2} )$$

Possible Case Six—h₁₈ [symbol] T_{d},h₁₉ [symbol] T_{d},h₂₀≧T_{d},h₂₁≧T_{d}

Two integrations are required.

L_{L(2)}(χ)=∫₀^{T}^{_{d}}∫ₕ_{₁₈}^{T}^{_{d}}ƒ_{L(2)}(h₁₈,h₁₉,h₂₀h₂₁)dh₁₈dh₁₉.

The likelihood is approximated with the summations:

$${L}_{L ( 2 )} ( χ ) \approx {\sum }_{{h}_{18} = 1}^{{T}_{d}} {\sum }_{{h}_{19} = {h}_{18} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {f}_{L ( j )} ( {h}_{stutter 1} , {h}_{allele 1} , {h}_{stutter 2} , {h}_{allele 2} )$$

Possible Case Seven—h₁₈ [symbol] T_{d},h₁₉ [symbol] h₂₀ [symbol] T_{d},h₂₁≧T_{d}

We need three integrations.

L_{L(2)}(χ)=∫₀^{T}^{_{d}}∫ₕ_{₁₈}^{T}^{_{d}}∫₀^{T}^{_{d}}ƒ_{L(2)}(h₁₈,h₁₉,h₂₀,h₂₁)dh₁₈dh₁₉dh₂₀.

The likelihood is approximated with the summations:

$${L}_{L ( 2 )} ( χ ) \approx {\sum }_{{h}_{18} = 0}^{{T}_{d}} {\sum }_{{h}_{19} = {h}_{18} + 1}^{{T}_{d}} {\sum }_{{h}_{20} = 0}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 0}^{{T}_{d}} {\sum }_{{h}_{allele 1} = {h}_{stutter 1} + 1}^{{T}_{d}} {\sum }_{{h}_{stutter 2} = 0}^{{T}_{d}} {f}_{L ( j )} ( {h}_{stutter 1} , {h}_{allele 1} , {h}_{stutter 2} , {h}_{allele 2} )$$

Possible Case Eight—h₁₈ [symbol] T_{d},h₁₉ [symbol] T_{d},h₂₀ [symbol] T_{d},h₂₁ [symbol] T_{d}

We need four integrations.

L_{L(2)}(χ)=∫₀^{T}^{_{d}}∫ₕ_{₁₈}^{T}^{_{d}}∫₀^{T}^{_{d}}∫ₕ_{₂₀}^{T}^{_{d}}ƒ_{L(2)}(h₁₈,h₁₉,h₂₀,h₂₁)dh₁₈dh₁₉dh₂₀dh₂₁

The likelihood can be approximated with the summations:

$${L}_{L ( 2 )} ( χ ) \approx {\sum }_{{h}_{18} = 1}^{{T}_{d}} {\sum }_{{h}_{19} = {h}_{18} + 1}^{{T}_{d}} {\sum }_{{h}_{20} = 1}^{{T}_{d}} {\sum }_{{h}_{21} = {h}_{20} + 1}^{{T}_{d}} {f}_{L ( 2 )} ( {h}_{18} , {h}_{19} , {h}_{20} , {h}_{21} )$$

Or more generically:

$${L}_{L ( j )} ( χ ) \approx {\sum }_{{h}_{stutter 1} = 1}^{{T}_{d}} {\sum }_{{h}_{allele 1} = {h}_{stutter 1} + 1}^{{T}_{d}} {\sum }_{{h}_{stutter 2} = 1}^{{T}_{d}} {\sum }_{{h}_{allele 2} = {h}_{stutter 2} + 1}^{{T}_{d}} {f}_{L ( j )} ( {h}_{stutter 1} , {h}_{allele 1} , {h}_{stutter 2} , {h}_{allele 2} ) .$$

### 3.3.3—Category 3: Heterozygous Donor with Adjacent Alleles

### 3.3.3.1—Stutter

FIG. 4a illustrates an example of such a situation. The example has a profile, c_{L(1)}={h₁₅,h₁₆,h₁₇} arising from a genotype g_{L(1)}={16,17} where each height hᵢ can be smaller than the limit-of-detection threshold T_{d}, situation hᵢ [symbol] T_{d}, or can be greater than this threshold, hᵢ≧T_{d} for iε{11,15,16,17}. The consideration is of a donor which is heterozygous, but with overlap in position between allele peak and stutter peak.

The position can be stated in the Bayesian Network of FIG. 4b. The stutter peak height for allele 15, H_{stutter,15}, is dependent upon the allele peak height for allele 16, H_{allele,16}, which is in turn dependent upon the DNA quantity, χ. The stutter peak height for allele 16, H_{stutter,16}, is dependent upon the allele peak height for allele 17, H_{allele,17}, which is in turn dependent upon the DNA quantity, χ. Additionally, the Bayesian Network needs to include the combined allele and stutter peak at allele 16, H_{allele+stutter,16}, which is dependent upon the allele peak height for allele 16, H_{allele,16}, and is dependent upon the stutter peak height for allele 16, H_{stutter,16}.

In terms of the actual observed results, H_{stutter,15}, H_{allele,17}, and H_{allele+stutter,16}, are observed and can be seen in FIG. 4a, but H_{allele,16}, and H_{stutter,16} are components within H_{allele+stutter,16} and so are not observed.

In addition, the Bayesian Network of FIG. 4b indicates that both the allele peak height for allele 16, H_{allele,16}, and the allele peak height for allele 17, H_{allele,17}, are dependent upon the heterozygous imbalance, R and the mean peak height, M, with those terms also dependent upon each other and upon the DNA quantity, χ.

In this context, χ, is assumed to be a known quantity.

The overlap between stutter and allele contribution within a peak means that a different approach to obtaining the PDF's needs to be taken.

### 3.3.3.2—PDF for Allele+Stutter Peak Height with Allele Peak Height and Stutter Peak Height

### Details

The PDF for ƒ(hₐₗₗₑₗₑ₁₊ₛₜᵤₜₜₑᵣ₁|hₐₗₗₑₗₑ₁,hₛₜᵤₜₜₑᵣ₁)=1 if hₐₗₗₑₗₑ₁₌ₛₜᵤₜₜₑᵣ₁=hₐₗₗₑₗₑ₁+hₛₜᵤₜₜₑᵣ₁ and has value=0 otherwise. This is more clearly seen in the two specific examples:

ƒ(h_{=200 for allele1+stutter1}|h_{=150 for allele1},h_{=50 for stutter1})=1

ƒ(h_{=210 for allele1+stutter1}|h_{=150 for allele1},h_{=50 for stutter1})=0

This form is used to provide a PDF for H_{allele+stutter,16} in the above example.

### 3.3.3.3—PDF's for Other Observed Peaks

The PDF's for the other two observed dependents are obtained by integrating out H_{allele,16} and H_{stutter,16} in the above example; more generically, Hₐₗₗₑₗₑ₁ and Hₛₜᵤₜₜₑᵣ₁. Integrating out avoids the need to consider a three dimensional estimation of the PDF's from experimental data.

The integrating out allows PDF's for the resulting components to be sought, for instance by looking at all the possibilities. This provides:

ƒ(hₐₗₗₑₗₑ₁₆,hₐₗₗₑₗₑ₁₇|χ)xƒ(hₛₜᵤₜₜₑᵣ₁₅|hₐₗₗₑₗₑ₁₆)xƒ(hₛₜᵤₜₜₑᵣ₁₆|hₐₗₗₑₗₑ₁₇)xƒ(hₐₗₗₑₗₑ₊ₛₜᵤₜₜₑᵣ₁₆|hₐₗₗₑₗₑ₁₆,hₛₜᵤₜₜₑᵣ₁₆)

Which equates to:

ƒ(hₐₗₗₑₗₑ₁₆,hₐₗₗₑₗₑ₁₇|χ)xƒ(hₛₜᵤₜₜₑᵣ₁₅,hₐₗₗₑₗₑ₁₆,hₛₜᵤₜₜₑᵣ₁₆,h_{allele+stutter16,}hₐₗₗₑₗₑ₁₇)

This comes together as the simplified Bayesian Network of FIG. 4c. In an example where locus 1 is under consideration and the allele peaks are at 16 and 17 and the stutter peaks are at 15 and 16, we wish to calculate:

L_{L(1)}(χ)=ƒ(c_{L(1)}|g_{L(1)},V,χ)

So, without considering T_{d}, the generic PDF is defined as:

ƒ_{L(1)}(h₁₅,h₁₆,h₁₇)=∫_{R}ƒₛ(h₁₅|h_{a,16})ƒₛ(h_{s,16}|h₁₇)ƒₕₑₜ(h_{a,16},h₁₇)dh_{a,16}dh_{s,16}

where R={hₐ₁₆,h_{s,16}:h_{a,16}+h_{s,16}=h₁₆}; ƒₛ is a PDF for stutter heights conditional on parent height; and ƒₕₑₜ is a PDF of pairs of heights of heterozygous genotypes. The PDFs in these sections are given for any value hᵢ, including hᵢ less than the threshold T_{d}.

The integral in the equation above can be computed by numerical integration or Monte Carlo integration. The preferred method for numerical integration is adaptive quadratures. The simplest method is integration by histogram approximation, which, for completeness, is given below.

The integral in the previous equation can be approximated with the summation:

$${f}_{L ( 1 )} ( {h}_{15} , {h}_{16} , {h}_{17} ) \approx {\sum }_{{h}_{a , 16} = {h}_{15} + 1}^{{h}_{16}} {f}_{s} ( {h}_{15} \vert {h}_{a , 16} ) {f}_{s} ( {h}_{s , 16} \vert {h}_{17} ) {f}_{het} ( {h}_{a , 16} , {h}_{17} )$$

where h_{s,16}=h₁₆−h_{a,16}. The step in the summation is one. It c be modified to have a larger increment, say x_{inc}, but then the term in the summation needs to be multiplied by x_{inc}. This is one possible numerical approximation. Faster numerical integrations can be achieved using adaptive methods in which the size of the bin is dynamically selected.

### 3.3.3.4—Extending to Dropout

The term ƒ_{L(1)}(h₁₅,h₁₆,h₁₇) provides density values for each value of the arguments. However, in many occasions technical dropout has occurred, that is, a peak is smaller than the limit-of-detection threshold T_{d}. In this case we need to calculate further integral to obtain the required likelihoods. In the following sections we describe the extra calculations that need to be done for each of the six possible cases.

All integrals described in the sections below can be computed by numerical integration of Monte Carlo integration. The method described in these sections in the simplest way to compute a numerical integration through a hitogram approximation. They are included for the sale of completeness. An integration method based on adaptive quadratures is more efficient in terms of computational cost.

Possible Case One—h₁₅≧T_{d},h₁₆≧T_{d},h₁₇≧T_{d}

If all the heights in c_{L(1)} are taller than T_{d} then the numerator of the LR for this locus is given by:

L_{L(1)}(χ)=ƒ_{L(1)}(h₁₅,h₁₆,h₁₇).

Or more generically:

L_{L(j)}(χ)=ƒ_{L(j)}(hₛₜᵤₜₜₑᵣ₁,hₐₗₗₑₗₑ₁₊ₛₜᵤₜₜₑᵣ₂,hₐₗₗₑₗₑ₂)

Possible Case Two—h₁₅ [symbol] T_{d},h₁₆≧T_{d},h₁₇≧T_{d}

If one of the heights are below T_{d} we need to perform further integrations. For example if h₁₅ [symbol] T_{d} the numerator of the LR is given by the equation:

L_{L(1)}(χ)=∫ₕ_{₁₅} [symbol] ₕ_{₁₆}ƒ_{L(1)}(h_{15,}h₁₆,h₁₇)dh₁₅.

A numerical approximation can be use to obtain the integral:

$${L}_{L ( 1 )} ( χ ) \approx {\sum }_{{h}_{15} = 1}^{{T}_{d}} {f}_{L ( 1 )} ( {h}_{15} , {h}_{16} , {h}_{17} ) .$$

Or more generically:

$${L}_{L ( j )} ( χ ) = {\sum }_{{h}_{stutter 1} = 1}^{{T}_{d}} {f}_{L ( j )} ( {h}_{stutter 1} , {h}_{allele 1 + stutter 2} , {h}_{allele 2} )$$

Possible Case Three—h₁₅ [symbol] T_{d},h₁₆ [symbol] T_{d},h₁₇≧T_{d}

In this case we need to compute two integrals:

L_{L(1)}(χ)=∫ₕ_{₁₅} [symbol] _{T}_{_{d}}∫ₕ_{₁₆} [symbol] ^{T}_{d}ƒ_{L(1)}(h₁₅,h₁₆,h₁₇)dh₁₅.

It can be approximated with:

$${L}_{L ( 1 )} ( χ ) \approx {\sum }_{{h}_{15} = 1}^{{T}_{d}} {\sum }_{{h}_{16} = {h}_{15} + 1}^{{T}_{d}} {f}_{L ( 1 )} ( {h}_{15} , {h}_{16} , {h}_{17} ) {dh}_{15} {dh}_{16} .$$

Or more generically by:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {f}_{L ( j )} ( {h}_{stutter 1} , {h}_{allele 1 + stutter 2} , {h}_{stutter 2} ) {dh}_{stutter 1} {dh}_{allele 1 + stutter 2}$$

Possible Case Four—h₁₅ [symbol] T_{d},h₁₆≧T_{d},h₁₇ [symbol] T_{d}

In this case we need to calculate two integrals:

L_{L(1)}(χ)=∫ₕ_{₁₅} [symbol] _{T}_{_{d}}∫ₕ_{₁₇} [symbol] _{T}_{_{d}}ƒ_{L(1)}(h₁₅,h₁₆,h₁₇)dh₁₅dh₁₇.

It can be approximated by

$${L}_{L ( 1 )} ( χ ) \approx {\sum }_{{h}_{15} = 1}^{{T}_{d}} {\sum }_{{h}_{17} = 1}^{{T}_{d}} {f}_{L ( 1 )} ( {h}_{15} , {h}_{16} , {h}_{17} )$$

Or more generically by:

$${L}_{L ( i )} ( χ ) \approx {\sum }_{{h}_{stutter 1} = 1}^{{T}_{d}} {\sum }_{{h}_{allele 2} = 1}^{{T}_{d}} {f}_{L ( j )} ( {h}_{stutter 1} , {h}_{allele 1 + stutter 2} , {h}_{allele 2} )$$

Possible Case Five—h₁₅≧T_{d},h₁₆≧T_{d},h₁₇ [symbol] T_{d}

In this case we need to calculate only one integral:

L_{L(1)}(χ)=∫ₕ_{₁₇} [symbol] _{T}_{_{d}}ƒ_{L(1)}(h₁₅,h₁₆,h₁₇)dh₁₇.

The integral can be approximated using the summation:

$${L}_{L ( 1 )} ( χ ) \approx {\sum }_{{h}_{17} = 1}^{{T}_{d}} {f}_{L ( 1 )} ( {h}_{15} , {h}_{16} , {h}_{17} )$$

Or more generically by:

$${L}_{L ( j )} ( χ ) \approx {\sum }_{{h}_{allele 2} = 1}^{{T}_{d}} {f}_{L ( j )} ( {h}_{stutter 1} , {h}_{allele 1 + stutter 2} , {h}_{stutter 2} )$$

Possible Case Six—h₁₅ [symbol] T_{d},h₁₆ [symbol] T_{d},h₁₇ [symbol] T_{d}

In this case we need to compute three integrals:

L_{L(1)}(χ)=∫ₕ_{_{—}}₁₅ [symbol] _{T}_{_{d}}∫ₕ_{_{—}}₁₆ [symbol] _{T}_{_{d}}∫ₕ_{_{—}}₁₇ [symbol] _{T}_{_{d}}ƒ_{L(1)}(h₁₅,h₁₆,h₁₇)dh₁₅dh₁₆dh₁₇.

The integrals can be approximate with the summations,

$${L}_{L ( 1 )} ( χ ) \approx {\sum }_{{h}_{15} = 1}^{{T}_{d}} {\sum }_{{h}_{16} = {h}_{15} + 1}^{{T}_{d}} {\sum }_{{h}_{17}}^{{T}_{d}} {f}_{L ( 1 )} ( {h}_{15} , {h}_{16} , {h}_{17} )$$

Or more generically:

$${L}_{L ( j )} ( χ ) \approx {\sum }_{{h}_{stutter 1} = 1}^{{T}_{d}} {\sum }_{{h}_{allele 1 + stutter 2} = {h}_{stutter 1} + 1}^{{T}_{d}} {\sum }_{{h}_{allele 2}}^{{T}_{d}} {f}_{L ( j )} ( {h}_{stutter 1} , {h}_{allele + stutter 2} , {h}_{allele 2} )$$

### 3.3.4—LR Nominator Summary

The approach for the three different categories is summarised in the Bayesian Network of FIG. 5. This presents the acyclic directed graph of a Bayesian Network in the case of three loci with the form:
Locus L(1):
   c_{L(1)}={h₁₅,h₁₆,h₁₇} and
   g_{s,L(1)}={16,17}
Locus L(2):
   c_{L(2)}={h₁₈,h₁₉,h₂₀,h₂₁} and
   g_{s,L(2)}{19,20}
Locus L(3):
   C_{L(3)}={h₁₀,h₁₁} and
   g_{s,L(3)}={11,11}

The specification of the calculation of likelihood for this Bayesian Network is sufficient for calculating likelihoods for all loci of any number of loci.

### 3.4 The LR Denominator Form

The calculation of the denominator follows the same derivation approach. Hence, the calculation of the denominator is given by:

L_{d}=ƒ(c|gₛ,V_{d})

As above, because the crime profile c extends across loci, for the three locus example, the initial equation of this section can be rewritten as:

L_{d}=ƒ(c_{L(1)},c_{L(2)},c_{L(3)}|g_{s,L(1)},g_{s,L(2)},g_{s,L(3)},V_{d})

Likelihood L_{d} can be factorised according to DNA quantity and combined with the previous equation's expansion, to give:

$${L}_{d} = {\sum }_{ {χ}_{i}} f ( {c}_{L ( 1 )} \vert {g}_{L ( 1 )} , {V}_{d} , {χ}_{i} ) f ( {c}_{L ( 2 )} \vert {g}_{L ( 2 )} , {V}_{d} {χ}_{i} ) f ( {c}_{L ( 3 )} \vert {g}_{L ( 3 )} , {V}_{d} {χ}_{i} )$$

This can be abstracted to give:

ƒ(c_{L(j)}|g_{L(j)},V_{d},χᵢ)

As the expression ƒ(c_{L(j)}|g_{L(j)},V_{d},χᵢ) does not specify the donor of the crime stain, it needs to be expanded as:

$$f ( {c}_{L ( j )} \vert {g}_{L ( j )} , {V}_{d} , {χ}_{i} ) = {\sum }_{{g}_{U , L ( j )}} f ( {c}_{L ( j )} {g}_{U , L ( j )} , {V}_{d} , χ \vert ) \times p ( {g}_{U , L ( j )} \vert {g}_{S , L ( j )} , {V}_{d} )$$

The first term on the right hand side of this definition corresponds to a term of matching form found in the numerator, as discussed above and expressed as:

L_{L(j)}(χ)=ƒ(C_{L(j)|}g_{L(j)},V,χ)

The second term in the right-hand side is a conditional genotype probability. This can be computed using existing formula for conditional genotype probabilities given putative related and unrelated contributors with population structure or not, for instance see J. D. Balding and R. Nichols. DNA profile match probability calculation: How to allow for population stratification, relatedness, database selection and single bands. Forensic Science International, 64:125-140, 1994.

We denote the first term with the expression:

L_{d,L(j)}(χ)=ƒ(c_{L(j)}|g_{U,L(j),}V_{d},χ)

with the likelihood in this specified as a likelihood of the heights in the crime profile given the genotype of a putative donor, and so, they can be written as:

L_{L(j)}(χ)=ƒ(c_{L(j)}|g_{L(j)},V,χ)

where V states that the genotype of the donor of crime profile c_{L(j)} is g_{L(j)}.

The Bayesian Network for calculating the denominator of the likelihood ratio is shown in FIG. 5. The network is conditional on the defense hypothesis V_{d}. The ovals represent probabilistic quantities whilst the rectangles represent known quantities. The arrows represent probabilistic dependencies.

In general terms, the denominator can be stated as:

$${\sum }_{{χ}_{i}} [ {Π}_{j}^{n loci} Σ f ( {c}_{L ( j )} \vert {g}_{u , L ( j )} , {V}_{d} , {χ}_{i} ) \times p ( {g}_{u , L ( j )} \vert {g}_{u , L ( j )} ) ] p ( {χ}_{i} )$$

where the consideration is in effect, the genotype (gₛ) is the donor of (cₕ₍ⱼ₎) given the DNA quantity (χᵢ).

The general statements provided above for the denominator enable a suitable denominator to be established for the number of loci under consideration.

### 3.5—The LR Denominator Quantification

In the denominator of the LR we need to calculate the likelihood of observing a set of heights giving any potential contributors. Most of the likelihoods would return a zero, if there is a height that is not explained by the putative unknown contributor. The presence of a likelihood of zero as the denominator in the LR would be detrimental to the usefulness of the LR.

In this section we provide with a method for generating genotype of unknown contributors that will lead to a non-zero likelihood.

For c_{L(i)} there may be a requirement to augment with zeros to account for peaks that are smaller than the limit-of-detection threshold T_{d}. It is assumed that the height of a stutter is at most the height of the parent allele.

The various possible cases observed from a single unknown contributor are now considered. In the generic definitions, the allele number, stated as allele1, allele 2 etc refers to the sequence in the size ordered set of alleles, in ascending size.

### Possible Case 1—Four Peaks

For this to be a single profile we need the two pair of heights where each pair are adjacent. If the heights are c_{L(i)}={h₁,h₂,h₃,h₄}, then the only possible genotype of the contributor is g_{U}={2,4}. Crime profile c_{L(i)} remains unchanged.
Possible Case 2—Three Peaks with One Allele not Adjacent

In this cases, there are two sub-cases to consider:
The larger two peaks are adjacent. If the peak heights are c_{L(i)}={h₂,h₅,h₆}, then the only possible genotype is g_{U,L(i)}={2,6} and c_{L(i)}={h₁,h₂,h₅,h₆} where h₁=0.
The smaller two peaks are adjacent. If the peak heights are {h₂,h₃,h₅}, the only possible genotype is g_{U}={3,5} and c_{L(i)}={h₂,h₃,h₄,h₅} where h₄=0.

### Possible Case 3—Three Adjacent Peaks

The alleles heights can be written as c_{L(i)}={h₂,h₃,h₄}. There are only two sub-cases to consider:

g_{U,L(i)}={2,4} or

g_{U,L(i)}={3,4}
If g_{U,L(i)}={2,4}, then c_{L(i)}={h₁,h₂,h₃,h₄} where h₁=0.
If g_{U,L(i)}={3,4}, then c_{L(i)} remains unchanged.

### Possible Case 4—Two Non-Adjacent Peaks

If allele heights are c_{L(i)}={h₂,h₄}, then the only possible genotype is g_{U,L(i)}={2,4} and c_{L(i)}={h₁,h₂,h₃,h₄} where h₁=0 and h3=0.

### Possible Case 5—Two Adjacent Peaks

If allele heights are c_{L(i)}={h₂,h₃} then four possible genotypes need to be considered:

g_{U,L(i)}={2,3}

g_{U,L(i)}={3,3}

g_{U,L(i)}={3,4} or

g_{U,L(i)}={3,Q}
where Q is any other allele different than alleles 2, 3 and 4.
if g_{U,L(i)}={2,3}, then c_{L(i)}={h₁,h₂,h₃} where h₁=0
if g_{U,L(i)}={3,3}, then c_{L(i)}={h₂,h₃} remains unchanged
if g_{U,L(i)}={3,4}, then c_{L(i)}={h₂,h₃,h₄} where h₄=0
if g_{U,L(i)}={3,Q}, then c_{L(i)}={h₂,h₃,h_{s,Q},h_{Q}} where h_{s,Q}=h_{Q}=0.

### Possible Case 6—One Peak

If the peak is denoted by c_{L(i)}={h₂}, then three possible genotypes need to be considered:

g_{U,L(i)}={2,2}

g_{U,L(i)}={2,3} or

g_{U,L(i)}={2,Q}
where Q is any allele other than 2 and 3.
if g_{U,L(i)}={2,2}, then c_{L(i)}={h₁,h₂} where h₁=0
if g_{U,L(i)}={2,3}, then c_{L(i)}={h₁,h₂,h₃} where h₁=h₃=0
if g_{U,L(i)}={2,Q}, then c_{L(i)}={h₁,h₂,h_{s,Q},h_{Q}} where =h₁=h_{s,2}=h_{Q}=0.

### Possible Case 7—No Peak

If this case the LR is one and therefore, there is no need to compute anything.

### 4. DETAILED DESCRIPTION

### Mixed Profile

### 4.1—The Calculation of the LR

The aim of this section is to describe in detail the statistical model for computing likelihood ratios for mixed profiles while considering peak heights, allelic dropout and stutters.

In considering mixtures, there are various hypotheses which are considered. These can be broadly grouped as follows:

Prosecution hypotheses:
Vₚ(S+V): The DNA came from the suspect and the victim;
Vₚ(S₁+S₂): The DNA came from suspect 1 and suspect 2;
Vₚ(S+U): The DNA came from the suspect and an unknown contributor;
Vₚ(V+U): The DNA came from the victim and an unknown contributor.
   Defense hypotheses:
V_{d}(S+U): The DNA came from the suspect and an unknown contributor;
V_{d}(V+U): The DNA came from the victim and an unknown contributor;
V_{d}(U+U): The DNA came from two unknown contributors.

The combinations that are used in casework are:
Vₚ(S+V) and V_{d}(S+U);
Vₚ(S+V) and V_{d}(V+U);
Vₚ(S+U) and V_{d}(U+U);
Vₚ(V+U) and V_{d}(U+U);
Vₚ(S₁+S₂) and V_{d}(U+U).

If we denote by K₁ and K₂ the person whose genotypes are known, there are only three generic pairs of propositions:
Vₚ(K₁+K₂) and V_{d}(K₁+U);
Vₚ(K₁+U) and V_{d}(U+U);
Vₚ(K₁+K₂) and V_{d}(U+U).

The likelihood ratio (LR) is the ratio of the likelihood for the prosecution hypotheses to the likelihood for the defense hypotheses. In this section, that means the LR's for the three generic combinations of prosecution and defense hypotheses listed above.

Throughout this section p(w) denotes a discrete probability distribution for mixing proportion w and p(x) denotes a discrete probability distribution for x.

### 4.4.1—Proposition One

### Vₚ(K₁+K₂) and V_{d}(K₁+U)

The numerator of the LR is:

$$num = {\sum }_{x} {\sum }_{w} {\prod }_{i}^{n loci} f ( {C}_{L ( i )} \vert g 1 , L ( i ) , g 2 , {L}_{( i )} , w , x ) p ( w ) p ( x )$$

where:
g₁ and g₂ are the genotypes of the known contributors K₁ and K₂ across loci;
c. is the crime profile across loci;

The subscript L(i) means that the either the genotype of crime profile is for locus i or is the number of loci.

The denominator of the LR is:

$$den = {\sum }_{x} {\sum }_{w} {\prod }_{i}^{n loci} {\sum }_{gU , L ( i )} f ( {C}_{L ( i )} \vert {g}_{1} , L ( i ) , gU , L ( i ) , w , x ) p ( gU , L ( i ) \vert {g}_{1} , L ( i ) , {g}_{2} , L ( i ) ) p ( w ) p ( x )$$

where:
g1,L(i) is the genotype of the known contributor in locus I;
g2,L(i) is a known genotype for locus i but it is not proposed as a genotype of the donor of the mixture;
gU,L(i) is the genotype of the unknown donor.

The conditional genotype probability in the right-hand-side of the equation is calculated using the Balding and Nichols model cited above.

The function in the left-hand side equation is calculated from probability distribution functions of the type described above and below.

### 4.4.2—Proposition Two

### Vₚ(K₁+U) and V_{d}(U+U)

The numerator is:

$$num = {\sum }_{x} {\sum }_{w} {\prod }_{i}^{n loci} {\sum }_{gU , L ( i )} f ( {C}_{L ( i )} \vert {g}_{1} , {L}_{i} , gu , {L}_{( i )} , w , x ) p ( gu , L ( i ) \vert g 1 , L ( i ) ) p ( w ) p ( x )$$

where:
g1,L(i) is the genotype of the known contributor K₁ in locus i.

The denominator is

$$den = {\sum }_{x} {\sum }_{w} {\prod }_{i}^{{n}_{Loci}} {\sum }_{{g}_{{U}_{1} , ℒ ( i )} , {g}_{{U}_{2} , ℒ ( i )}} f ( {c}_{ℒ ( i )} \vert {g}_{{U}_{1} , ℒ ( i )} , {g}_{{U}_{2} ℒ ( i )} , w , x ) p ( {g}_{{U}_{1} , ℒ ( i )} , {g}_{{U}_{2} , ℒ ( i )} \vert {g}_{1 , ℒ ( i )} , {g}_{2} , L ( i ) ) p ( w ) p ( x )$$

where:
g1,L(i) is the genotype of the known contributor K₁ in locus i; and
g_{U1},L(i) and g_{U2},L(i) are the genotypes for locus i of the unknown contributors.

The second factor is computed as:

p(g_{U}_{₁}_{,} [symbol] ₍ᵢ₎,g_{U}_{₂}_{,} [symbol] ₍ᵢ₎)=p(g_{U}_{₁}_{,} [symbol] ₍ᵢ₎|g_{1,} [symbol] ₍ᵢ₎|g_{U}_{₂}_{,} [symbol] ₍ᵢ₎)p(g_{U}_{₂}_{,} [symbol] ₍ᵢ₎|g_{1,} [symbol] ₍ᵢ₎)

The factors in the right-hand-side of the equation are computed using the model of Balding and Nichols cited above.

### 4.3.3—Proposition Three

### Vₚ(K₁+K₂) and V_{d}(U+U)

The numerator is the same as the numerator for the first generic pair of hypotheses. The denominator is almost the same as the denominator for the second generic pair of propositions except for the genotypes to the right of the conditioning bar in the conditional genotype probabilities. The denominator of the LR for the generic pair of propositions in this section is:

$$den = {\sum }_{x} {\sum }_{w} {\prod }_{i}^{{n}_{Loci}} {\sum }_{{g}_{{U}_{1} , ℒ ( i )} , {g}_{{U}_{2} , ℒ ( i )}} f ( {c}_{ℒ ( i )} \vert {g}_{{U}_{1} , ℒ ( i )} , {g}_{{U}_{2} ℒ ( i )} , w , x ) p ( {g}_{{U}_{1} , ℒ ( i )} , {g}_{{U}_{2} , ℒ ( i )} \vert {g}_{1 , ℒ ( i )} , {g}_{2 , ℒ ( i )} ) p ( w ) p ( x )$$

where:
g1,L(i) and g2,L(i) are the genotypes of the known contributors K₁ and K₂ in locus i;
gU₁,L(i) and gU₂,L(i) are the genotypes for locus i of the unknown contributors.

The second factor is computed as:

p(g_{U}_{₁}_{,} [symbol] ₍ᵢ₎,g_{U}_{₂}_{,} [symbol] ₍ᵢ₎|g_{1,} [symbol] ₍ᵢ₎,g_{2,} [symbol] ₍ᵢ₎)=p(g_{U}_{₁}_{,} [symbol] ₍ᵢ₎|g_{1,} [symbol] ₍ᵢ₎,g_{2,} [symbol] ₍ᵢ₎,g_{U}_{₂}_{,} [symbol] ₍ᵢ₎)p(g_{U}_{₂}_{,} [symbol] ₍ᵢ₎|g_{1,} [symbol] ₍ᵢ₎g_{2,} [symbol] [symbol] ₍ᵢ₎)

The factors in the right-hand-side of the equation are computed using the model of Balding and Nichols cited above.

### 4.2—Density Value for Crime Profile Given Two Putative Donors

The terms in the calculations above are put together using per locus conditional genotype probabilities and density values of per locus crime profiles given putative per locus genotypes of two contributors. The conditional genotype probabilities are calculated using the model of Balding and Nichols cited above. In this section we focus on the density values of per locus crime profiles.

For the sake of clarity and brevity of explanation, the method for calculating the density value ƒ(cL(i)|g1,L(i),g2,L(i),w,x) is explained through an example.

### Example

The genotypes and crime profiles are:

g_{1,} [symbol] ₍ᵢ₎={16,17}

g_{2,} [symbol] ₍ᵢ₎={18,20}

c [symbol] ₍ᵢ₎={h_{*,15},h_{*,16},h_{*,17},h_{*,18},h_{*,19},h_{*,20}}.

We first obtain an intermediate probability density function (PDF) defined as the product of the factors:
1. ƒ(h_{1,15},h_{1,16},h_{1,17}|g_{1,} [symbol] ₍ᵢ₎={16,17},w×x)
2. ƒ(h_{2,17},h_{2,18},h_{2,19}|g_{2,} [symbol] ₍ᵢ₎={18,28},(1−w)×x)
3. δₛ(h₁₇|h_{1,17},h_{2,17})

The first factor has been already defined as a PDF for a single contributor: in this case the donor is g1,L(i)={16,17} and DNA quantity w×x. The second factor has also being defined as a PDF for a single contributor: the donor in this case is g2,L(i)={18,28} and DNA quantity (1−w)×x. The third factor is a degenerated PDF defined by: δ_{S}(h₁₇|h_{1,17},h_{2,17})=1 if h_{1,17}=h_{1,17}+h_{2,17} and zero otherwise. The intermediate PDF is denoted by ƒ(h_{1,15},h_{1,16},h_{1,17},h₁₇,h_{2,17},h_{2,18},h_{2,19}). The required density value is obtained by integration:

ƒ(h_{*,15},h_{*,16},h_{*,17},h_{*,18},h_{*,19})=∫ƒ(h_{*,15},h_{*,16},h_{1,17},h_{*,17},h_{2,17},h_{*,18},h_{*,19})dh_{1,17}dh_{2,17}

where ƒ(h_{*,15},h_{*,16},h_{*,17},h_{*,18},h_{*,19})=ƒ(c [symbol] ₍ᵢ₎|g_{1,} [symbol] ₍ᵢ₎,g_{2,} [symbol] ₍ᵢ₎,w,x) in this example.

Notice that h_{1,15} has been replaced by the observed height in the crime profile h_{*,15}. This is because h_{1,15} represents a generic variable and h_{*,15} represent an observed height. (For example, cosine(y) represents a generic function but cosine(n) represent the evaluation of the function cosine for the value π.). Notice as well that the height h*,15 is only explained by the stutter of allele 16.

In contrast, h_{1,17} and h_{2,17} are not replaced by h_{*,17} because h_{*,17} is form as the sum of h_{1,17} and h_{2,17}. We do not know the observed values but only the sum of them. (If we observe number 10 and we are told that it is the sum of two numbers, there are many possibilities for the two numbers: 1 and 9, 2 and 8, 1.1 and 8.9, etc.). The integration considers all of the possible h_{1,17} and h_{2,17}. The variable that take these values is known as a hidden, latent or unobserved variable.

The integration can be achieved using any type of integration, including, but not limited to, Monte Carlo integration, and numerical integration. The preferred method is adaptive numerical integration in one dimension in this example, and in several dimensions in general.

The general methods is to generate an intermediate PDF using the PDF of the contributor and by introducing δₛ PDFs for the height pairs that fall in the same position. There can be cases when more than one pair of heights fall in the same position. For example if g1,L(i)={16,17} and g2,L(i)={16,17}, then there are three pairs of heights falling in the same position: one in position 15, another in position 16 and the third in position 17.

If one of the observed heights is below the limit-of-detection threshold T_{d}, we need to perform further integration to consider all values. For example if h{*,15} is reported as below the limit-of-detection threshold T_{d} and all other heights are greater than the limit-of-detection threshold, the PDF value that we are interested become a likelihood given by:

ƒ(h_{*,15}<T_{d},h_{*,16},h_{*,17},h_{*,18},h_{*,19})=∫ₕ_{_{*,15}}_{<T}_{_{d}}ƒ(h₁₅,h_{*,16},h_{*,17},h_{*,18},h_{*,19})dh₁₅

The integral consider all the possibilities for h₁₅. In general we need to perform an integration for each height that is smaller than T_{d}. Any method for calculating the integral can be used. The preferred method is adaptive numerical integration.

### 5. DETAILED DESCRIPTION

### Intelligence Uses

### 5.1—Use in Intelligence Applications

In an intelligence context, a different issue is under consideration to that approached in an evidential context. The intelligence context seeks to find links between a DNA profile from a crime scene sample and profiles stored in a database, such as The National DNA Database® which is used in the UK. The process is interested in the genotype given the collected profile.

Thus in this context, the process starts with a crime profile c, with the crime profile consisting of a set of crime profiles, where each member of the set is the crime profile of a particular locus. The method is interested in proposing, as its output, a list of suspect's profiles from the database. Ideally, the method also provides a posterior probability (to observing the crime profile) for each suspect's profile. This allows the list of suspect's profiles to be ranked such that the first profile in the list is the genotype of the most likely donor.

Where the profile is from a single source, a single suspect's profile and posterior probability is generated.

Where the profile is from two sources, a pair of suspect profiles and a posterior probability are generated.

### 5.2—Intelligence Application Single Profile

As described above, the process starts with a crime profile c, with the crime profile consisting of a set of crime profiles, where each member of the set is the crime profile of a particular locus. The method is interested in proposing a list of single suspect profiles from the database, together with a posterior probability for that profile. This task is usually done by proposing a list of genotypes {g₁, g₂, . . . , gₘ} which are then ranked according the posterior probability of the genotype given the crime profile.

The list of genotypes is generated from the crime scene c. For example if c={h₁,h₂}, where both h₁ and h₂ are greater than the dropout threshold, t_{d}, then the potential donor genotype is generated according to the scenarios described previously. Thus, if the peaks are not adjoining, then the lower size peak is not a possible stutter and g={1,2}. If the peaks are adjoining, then g={1, 2} and g={stutter2, 2} are possible, and so on.

The quantity to be computed is the posterior probability, p(gᵢ|c), for all possible genotypes across the profile, gᵢ. This quantity can be defined as:

$$p ( {g}_{i} \vert c ) = \frac{f ( c \vert {g}_{i} ) p ( {g}_{i} )}{{\sum }_{{g}_{j}} f ( c \vert {g}_{j} ) p ( {g}_{j} )}$$

where p(gᵢ) is a prior distribution for genotype gᵢ, preferably computed from the population in question.

The likelihood ƒ(c|g) can be computed using the approach of section 3.2 above, but with the modification of replacing the suspect's genotype by one of the generated

Thus the computation uses:

$${L}_{p} = {\sum }_{{χ}_{i}} {L}_{p , L ( 1 )} ( {χ}_{i} ) \times {L}_{p , L ( 2 )} ( {χ}_{i} ) \times {L}_{p , L ( 3 )} ( {χ}_{i} ) \times p ( {χ}_{i} )$$

Where L_{p,L(j)}(χᵢ) is the likelihood for locus j conditional on DNA quantity, this assumes the abstracted form:

$${L}_{p , L ( j )} ( χ ) = f ( {c}_{L ( j )} \vert {g}_{s , L ( j )} , {V}_{p} , {χ}_{j} )$$

$$or \text{:}$$

$${L}_{p , L ( j )} ( χ ) = f ( {c}_{L ( j )} \vert {g}_{h ( j )} , V , {χ}_{j} ) . \\ or \text{:}$$

$${\sum }_{{χ}_{i}} [ {Π}_{j}^{n loci} f ( {c}_{h ( j )} \vert {g}_{s , L ( j )} , {V}_{p} , {χ}_{i} ) ] p ( {χ}_{i} )$$

The prior probability p(gᵢ|c) is computed as:

p(gᵢ)=Πₖ₌₁ⁿ^{_{loci}}p(g_{i,L(k)})

Each factor in this product can be computed using the following approach.

The approach inputs are:
g—a genotype;
AlleleList—a list of observed alleles—this may include allele repetitions, such as {15,16; 15,16};
locus—an identifier for the locus;
theta—a co-ancestry or inbreeding coefficient—a real number in the interval [0,1];
eaGroup—ethnic appearance group—an identifier for the ethnic group appearance, which can change from country to country;
alleleCountArray—an array of integers containing counts corresponding to a list of alleles and loci.
   The approach outputs are:
Prob—a probability—a real number with interval [0,1].
   The algorithmically description becomes:
a) if g is a heterozygote, then multiply by 2;
b) N=length(g)+length(allelelist);
c) den=[1+(N−2)θ][1+(N−3)θ];
d) n₁ is the number of times that the first allele g(1) is present in allelelist ∪g(2);
e) n₂ is the number of times that the second allele g(2) is present in the list alleleList.
f) num=[(n₁−1)θ+(1−θ)*p₁][(n₂−1)θ+(1−θ)*p₂] where p₁ is the probability of allele g(1) and p₂ is the probability of allele g(2).

### 5.3—Intelligence Application Mixed Profile

In the mixed profile case, the task is to propose an ordered list of pairs of genotypes g₁ and g₂ per locus (so that the first pair in the list are the most likely donors of the crime stain) for a two source mixture; an ordered list of triplets of genotypes per locus for three source sample and so on.

The starting point is the crime stain profile c. From this, an exhaustive list {g_{1,i},g_{2,i}} of pairs of potential donors are generated. The potential donor pair genotypes are generated according to the scenarios described previously taking into account possible stutter etc.

For each of theses pairs, a probability distribution for the genotypes is calculated using the formula:

$$p ( {g}_{1} , {g}_{2} \vert c ) = \frac{f ( c \vert {g}_{1} , {g}_{2} ) p ( {g}_{1} , {g}_{2} )}{{\sum }_{gi , gj} f ( c \vert {g}_{i} , {g}_{j} ) p ( {g}_{i} , {g}_{j} )}$$

where p(g₁,g₂) and/or p(gᵢ,gⱼ) are a prior distribution for the pair of genotypes inside the brackets that can be set to a uniform distribution or computed using the formulae introduced by Balding et al. In practice, there is no need to compute the denominator as the computation extends to all possible genotypes. The term can be normalised later. As described above for evidential uses, for instance, the core term is the calculation of the likelihood ƒ(c|g₁,g₂). This can be computed according to the formula:

$$f ( c \vert {g}_{1} , {g}_{2} ) = {\sum }_{x} {\sum }_{w} {{\prod }_{i}}^{{n}_{loci}} f ( {c}_{L ( i )} \vert {g}_{1 , L ( i )} , {g}_{2 , L ( i )} ) p ( w ) p ( x )$$

where the term:

$$p ( {g}_{1} , {g}_{2} ) = {\prod }_{i}^{{n}_{loci}} p ( {g}_{1 , L ( i )} \vert {g}_{2 , L ( i )} ) p ( {g}_{1 , L ( i )} )$$

Each factor in this product can be computed using the approach described in section 5.2 above.

### 6. EXTENSION TO INCLUDE VARIABLE PEAK HEIGHT IMPACT EFFECTS IN THE MODEL

### 6.1—Background

In practice, there are a variety of effects which impact upon the way in which different allele sizes and/or different loci sizes are observed in the results.

For instance, degradation of DNA samples occurs with time due to various factors. When the effect occurs it impacts by resulting in a reduction in the observed peak height of an allele as the degraded DNA does not contribute to that peak (or any of the peaks) within the analysis. However, the impact of degradation is not consistent across all loci. Higher molecular weight loci are subjected to greater levels of degradation than lower molecular weight loci within a sample.

Another instance of an effect having a variable impact is variations in amplification efficiency within and/or between loci. Lower amplification efficiency effects will impact in terms of lower peaks for the quantity of DNA present than is the case for higher amplification efficiency effects.

Another instance is sampling effects, where because the number of molecules of DNA forming the starting point for amplification is small, any variation in the number of molecules when the sub-samples of the DNA sample are generated will have a material effect on the peak heights.

In general, the effect can be considered as any effect which has the impact of causing peak imbalance in the results.

### 6.2—Experimental Determination of the Information

In the technique which follows, there is a need to have available information on the mean height of an allele for a locus and the variance thereof.

This information could be generated by a model of the results observed for various alleles under various conditions. In this instance, however, experimentally derived information is used.

### 6.2.1—Profile Generation

A total of 865 profiles were produced from 15 volunteers who donated three buccal scrapes (using Whatman®OmniSwab™). Nineteen DNA templates were targeted through a dilution series from 50 to 500 picograms per microlitre (pg/μl) in increments of 25 pg/μl, covering a template range where allelic dropout is possible. To cover current protocols used in the FSS, three combination of amplification and detection were selected that represent current of casework samples: (a) Tetrad and 3100; (b) Tetrad and 3130x1 and (c) 9700 and 3130x1. The protocol used is now described.

### 6.2.2—Extraction

The serrated collection area of each swab was deposited into a micro test tube (Eppendorf Biopur Safe-Lock, 1.5 μl, individually sealed). DNA was purified from the buccal scrapes using a Qiagen EZ1 and the EZ1 DNA tissue kit. Each donor's three purified DNA samples were hen pooled into a single sample to ensure that a sufficient volume of high concentration DNA was available.

### 6.2.3—Dilution Series

The DNA in each pooled sample was measured in duplicate using the 7500 Real Time PCR System (Applied Biosystems) and the Quantifier Human DNA Quantification kit (Applied Biosystems). Each pooled extract was first used to create stock volumes of 100 pg/l, 250 pg/l and 500 pg/l. The stock volumes were then used to generate diluted volumes such that the addition of 101 to the amplification reaction will provide each of the 19 target template levels in the dilution series.

### 6.2.4—Amplification

Amplification was performed for each donor at each template level using the AmpFSTR SGM Plus PCR Amplification Kit (Applied Biosystems) on theremocycler MJ Research PTC-225 Tetrad. A reaction volume of 25 l was used for each amplification. Protocols that use a reaction volume of 25 l have been tested in the FSS and they produce comparable profiles to protocols that use 50 l.

### 6.2.5—Detection

Two genetic analyzers were used: (1) the 3100 Genetic Analyzer (Applied Biosystems) using POP4™ (Applied Biosystems) and injection parameters of 1 kV for 22 seconds. (2) the 3130x1 Genetic analyzer using injection parameters of 1.5 kv for 10 seconds and 3 kv for 10 seconds.

### 6.2.6—Interpretation

Analysis and genotyping of the run files was carried out using GeneMapper® ID v3.2 (Applied Biosystems). A series of peak positions and heights were thus obtained for the allele or alleles present at each locus for each sample.

### 6.2.7—Data Generation

### 6.2.7.1—Allele Mean v Quantity Distribution Fitting

All the heights within a profile were added together (except the Amelogenin height) to give the χ value; DNA quantity. The sum of the heights χₗ₍ᵢ₎ in locus l(i) was then computed from the same basic data and the mean height of allele obtained. This information formed the data points for a plot of mean peak height against DNA quantity×scaling factor. In the case of the FIG. 11a illustration, mean peak height is plotted against DNA quantity×10 (as a scaling factor).

A linear Gamma distribution (the line shown) is then fitted to these points. The allele mean for locus l(i), denoted by μ_{a,l(i)} is modelled with a regression line through the origin: μ_{a,l(i)}=η_{1,a,l(i)}xχ where κ_{1,al(i)} is the amplified DNA proxy χ, by summing all peak heights above the limit of detection threshold T_{d}=30 rfu in the profile, except for Amelogenin.

### 6.2.7.2—Stutter Mean v Quantity Distribution Fitting

In a similar manner, a plot of mean stutter peak height against DNA quantity×scaling factor can be obtained. The stutter mean model for locus l(i), denoted by μ_{s,l(i)} is also modelled with a regression line through the origin: μ_{s,l(i)}=κ_{1,s,l(i)}xχ.

### 6.2.7.3—Allele Variance Distribution Fitting

In the next step of the data generation, the approach goes on to consider the variances for the alleles based upon the expected mean and the observed means. By plotting variance against the mean height, a plot of the type shown in FIG. 11b can be obtained.

Again a Gamma distribution can be fitted to it; in this case two different distributions are fitted to the two different sections, with a knot joining them. The allele variance is modelled with two quadratic polynomials joined in a chosen knot. A knot is chosen through experimenting with several candidates and selecting candidates that give a good fit. The result is stated as, if μ≦knot:

σ²=κ_{2,1,l(i)}xμ+κ_{3,1,l(i)}xμ²

If μ>knot,

σ²=κ_{2,2,l(i)}xμ+κ_{3,2l(i)}xμ²

The allele variance model is used for stutter because stutter heights are smaller than allele heights and are more affected by the censoring of 30 rfu. Peak heights of alleles and stutters are assumed to follow a Gamma distribution where the parameters α and β are calculated from the mean and variance specified above.

### 6.2.7.4—Examples for Loci

The process is repeated for all the loci of interest.

In FIGS. 12a and 12b the allele and stutter results are shown for the D3 locus. FIGS. 13a and 13b show the allele and stutter results for the vWA locus. FIGS. 14a and 14b show the allele and stutter results for the D16 locus. FIGS. 15a and 15b show the allele and stutter results for the D2 locus. FIGS. 16a and 16b show the allele and stutter results for Amelogen. FIGS. 17a and 17b show the allele and stutter results for the D8 locus. FIGS. 18a and 18b show the allele and stutter results for the D21 locus. FIGS. 19a and 19b show the allele and stutter results for the D18 locus. FIGS. 20a and 20b show the allele and stutter results for the D19 locus. FIGS. 21a and 21b show the allele and stutter results for the THO locus. FIGS. 22a and 22b show the allele and stutter results for the FGA locus.

### 6.2.7.5—Equivalent β Values

In the next step, the approach provides for the system preference for the β values for the Gamma distributions to be the same, and hence the requirement for a linear relationship: σ²=k₂xμ. Hence:

$$β = \frac{μ}{{σ}^{2}} = \frac{μ}{{k}_{2} \cdot μ} = \frac{1}{{k}^{2}}$$

As a single estimate of k₂ is required for all μ's, if for example, there are three peaks with means μ₁=200, μ₂=400 and μ₃=600, the model of FIG. 11b can be used to give the variance values, σ₁², σ₂² and σ₃². A least-squares line is then estimated for these points, FIG. 11c and the k₂ slope is obtained as a result.

### 6.2.8—Estimate of the Allele Model

The EM algorithm is used to estimate the parameters of the mean and variance models. The values of the parameters in iteration m is denoted by:

κ_{1,a,l(i)}[m],κ_{2,1,l(i)}[m],κ_{3,1,l(i)}[m],κ_{2,2,l(i)}[m],κ_{3,2l(i)}[m]

In the first iteration we ignore zeros, i.e. heights smaller than T_{d}=30. From the second iteration onwards, the zeros are replaced by samples obtained from the tail of the Gamma pdfs estimated in the previous step. More specifically,
1. Parameter k_{1,a,l(i)}[1] is estimated using standard linear regression methods where the response variable are non-zero allele heights and the covariate is the corresponding χ.
2. Parameters k_{2,1,l(i)}[1], k_{3,1,l(i)}[1], k_{2,2,l(i)}[1], k_{3,2,l(i)}[1] are estimated by using the estimated mean μ_{a,l(i)} as the mean and computing the variance of the heights around these mean according to a window size.
3. In iteration m, zeros are replaced by samples taken from the family of Gamma distribution estimated in the previous iteration. In more detail, for a zero corresponding to χ, we first obtain a μ_{a,l(i)}[m−1] from χ and σ_{a,l(i)}²[m−1] from μ_{a,l(i)}[m−1]. Parameter α[m−1] and β[m−1] can be computed from μ_{a,l(i)}[m−1] and σ_{a,l(i)}²[m−1]. A sample is then taken in the interval (0, 30) from the tail of the distribution using the CDF inverse method using uniform samples in the interval (0, F(30, α[m−1], β[m−1])) where F is the CDF of a Gamma distribution.
4. Parameter k_{1,a,l(i)}[m] is also estimated using standard linear regression methods where the response variable are allele heights and the covariate are the corresponding χ's. Zeros are replaced using the method described above.
5. Parameters k_{2,1,l(i)}[m], k_{3,1,l(i)}[m], k_{2,2,l(i)}[m], k_{3,2,l(i)}[m] are estimated by using the estimated mean μ_{a,l(i)}[m] as the mean and computing the variance of the heights around these mean according to a window size.
6. The process is repeated until the parameters converge according to the rules:
   (a) |k_{1,a,l(i)}[m]−k_{1,a,l(i)}[m−1]|<0.0001;
   (b) |k_{2,a,l(i)}[m]−k_{2,a,l(i)}[m−1]|<0.01; and
   (c) |k_{3,a,l(i)}[m]−k_{3,a,l(i)}[m−1]Å<0.001.

### 6.2.9—Estimation of the Stutter Model

The same methodology is used for estimating the parameters of the stutter model except that we have more zeros: stutter peaks are much smaller than allele peaks. To alleviate the extra variability introduced by the zeros we use the variance model for the allele and iterate only for the stutter mean.

### 6.2.10—Variances for Means Exceeding the Maximum

If an χ is larger than the one support by the data, we use the regression line to extrapolate a value for the allele and stutter means. Extrapolation of the variance is a more involved process.

The profiles provide estimates for variances up to a maximum value for the mean value denoted by μₘₐₓ. To extrapolate the variances we use the coefficient of variation, denoted here by ν, i.e the standard deviation divided by the mean (ν=σ/μ). The coefficient of variation decreases as the mean increases, however, its rate of reduction also decreases. FIGS. 12d to 22d show the coefficient of variation for each locus. We therefore use the last value of the coefficient of variation, denoted by νₘₐₓ. For a given mean μ larger than μₘₐₓ, we can compute the variance as:

σ²=(νₘₐₓxμ)².

### 6.3—Single Source Profiles

Having established the background information needed, the manner in which the approach is implemented for a variety of sample situations can be discussed, starting with samples from a single source.

### 6.3.1 Evidential Uses

As mentioned above, in the context of evidential uses, there is consideration of the term:

$$LR = \frac{f ( c \vert {g}_{s} , {V}_{p} )}{f ( c \vert {g}_{s} , {V}_{d} )}$$

with the crime profile c in a case consists of a set of crime profiles, where each member of the set is the crime profile of a particular locus. Similarly, the suspect genotype gₛ is a set where each member is the genotype of the suspect for a particular locus. As a result, the notation used was:

c={c_{L(i)}:i=,2, . . . ,nᵢ} and gₛ={g_{s,L(i)}:=1,2, . . . ,nᵢ}

where nᵢ is the number of loci in the profile.

As a result, this provides for the height of the crime scene profile at the locus being considered, but then being summed together with the heights of all the loci. The sum was used in the subsequent considerations and the heights at the individual loci were not made any further use of.

However, as mentioned in section 6.1, peak imbalance effects (such as degradation effects) are locus and even allele dependent in the occurrence and extent. For example, locus vWA undergoes greater extents of degradation than locus D3 in the same sample.

In accounting for peak imbalance, therefore, the model moves to condition on the sum per locus; χₗ₍ᵢ₎, the sum of peak heights in a locus. In effect, this considers the Bayesian Network shown in FIG. 10 which represents the position for two of the loci L under consideration.

### 6.3.1.1—Numerator

On this basis, the denominator in the LR can be expressed as:

$$Num = f ( c \vert {g}_{s} , {H}_{p} ) = {\prod }_{i = T}^{{n}_{l}} f ( {C}_{l ( i )} \vert {g}_{s , l ( i )} , {H}_{P} ) {χ}_{l ( i )} , δ )$$

where the peak heights are summed for loci i and δ is a parameter, peak imbalance parameter or EAQ, that takes into account effects within a locus (and which is discussed further in section 6.5.

The right-hand side factor of the above equation,

ƒ(Cₗ₍ᵢ₎|g_{s,l(i)},H_{P},χₗ₍ᵢ₎,δ)

can be written as:

ƒ(Cₗ₍ᵢ₎|gₗ₍ᵢ₎,χₗ₍ᵢ₎,δ)

where it is assumed that gₗ₍ᵢ₎ is the genotype of the donor of Cₗ₍ᵢ₎ (the donor varying according to the prosecution hypothesis and the defense hypothesis). This is a core pdf in the considerations made by the invention and is discussed further below.

### 6.3.1.2—Denominator

The denominator can be expressed as:

$$Den = f ( c \vert {g}_{s} , {H}_{d} ) = {\prod }_{i = T}^{{n}_{l}} f ( {C}_{l ( i )} \vert {g}_{s , l ( i )} , {H}_{d} , {χ}_{l ( i )} , δ )$$

The right-hand side factor of the above equation, ƒ(Cₗ₍ᵢ₎|g_{s,l(i)},H_{d},χₗ₍ᵢ₎,δ) can be written as:

$$f ( {C}_{l ( i )} \vert {g}_{s , l ( i )} , {χ}_{l ( i )} , {H}_{d} , δ ) = {\sum }_{i} f ( {C}_{l ( i )} \vert {g}_{u ( i )} , {χ}_{l ( i )} , {H}_{d} , δ , {g}_{u , l ( i )} ) Pr ( {g}_{u , l ( i )} \vert {g}_{s , l ( i )} )$$

where the function ƒ(Cₗ₍ᵢ₎|gᵤ₍ᵢ₎,χₗ₍ᵢ₎,H_{d},δ,g_{u,l(i)}) can be written as:

ƒ(Cₗ₍ᵢ₎−gₗ₍ᵢ₎,χₗ₍ᵢ₎,δ)

where we assume that gₗ₍ᵢ₎ is the genotype of the donor of Cₗ₍ᵢ₎. This is a pdf of the same form as referenced above as core to the invention.

Once again, the right-hand term is a conditional genotype probability. This can be computed using existing formula for conditional genotype probabilities given putative related and unrelated contributors with population structure or not, for instance using the approach defined in J. D. Balding and R. Nichols. DNA profile match probability calculation: How to allow for population stratification, relatedness, database selection and single bands. Forensic Science International, 64:125-140, 1994.

### 6.3.2—Intelligence Uses

In this use, the task is to compute posterior probabilities of the genotype given the crime profile for locus i. Given the crime stain, quantity of DNA and peak imbalance/EQA parameter, the use assigns probabilities to the genotypes which could be behind it. The term χₗ₍ᵢ₎ denotes the sum of peak heights in locus i bigger than reporting threshold Tᵣ. The term δ denotes the EAQ factor, described in below.

The posterior genotype probability for g*_{U,1(i)} given cₗ₍ᵢ₎,χₗ₍ᵢ₎ and δ is calculated using Bayes theorem:

$$p ( {g}_{U , l ( i )}^{*} \vert {C}_{l ( i )} , {χ}_{l ( i )} , δ ) = \frac{f ( {c}_{l ( i )} \vert {g}_{U , l ( i )}^{*} , {χ}_{l ( i )} , δ ) p ( {g}_{U , l ( i )}^{*} )}{{\sum }_{{g}_{U , l ( i )}} f ( {c}_{i} \vert {g}_{U , l ( i )} , {χ}_{l ( i )} , δ ) p ( {g}_{U , l ( i )} )}$$

where p(g_{U,l(i)}) is the probability of genotype g_{U,l(i)} prior to observing the crime profile. In this version of the method we chose to set a uniform prior to all genotypes so that only the effect of the crime profile is considered. The formula above is simplified to:

$$p ( {g}_{U , l ( i )}^{*} \vert {C}_{l ( i )} , {χ}_{l ( i )} , δ ) = \frac{f ( {c}_{l ( i )} \vert {g}_{U , l ( i )}^{*} , {χ}_{l ( i )} , δ )}{{\sum }_{{g}_{U , l ( i )}} f ( {c}_{i} \vert {g}_{U , l ( i )} , {χ}_{l ( i )} , δ )}$$

As above in the evidential uses, both numerator and denominator can be presented in a form based around the core pdf:

ƒ(Cₗ₍ᵢ₎|gₗ₍ᵢ₎,χₗ₍ᵢ₎,δ)

where we assume that gₗ₍ᵢ₎ is the genotype of the donor of Cₗ₍ᵢ₎.

In this use, it is not necessary to compute all possible genotypes in a locus: most of the probabilities would be zero. Instead we generate genotypes that may lead to a non-zero posterior probability. Starting with the crime profile Cₗ₍ᵢ₎ in this locus, peaks are designated either as a stutter or alleles. The set of designated alleles is used for generating the possible genotypes. There are only three possibilities:
1. No peaks bigger than reporting threshold Tᵣ. No genotype is generated as there is no peak height information to inform them.
2. One peak bigger than Tᵣ as allele, denoted by a. The possible genotypes are {a,a} and {a, Q} where Q denotes any allele other than a.
3. Two peaks bigger than Tᵣ designated as alleles, denoted by a and b. In this case the only possible genotype is {a,b}.

### 6.3.3—The Function ƒ(C_{l(i)|g}ₗ₍ᵢ₎,χₗ₍ᵢ₎,δ)

In the above sections, the pdf: ƒ(Cₗ₍ᵢ₎|gₗ₍ᵢ₎,χₗ₍ᵢ₎,δ) is explained as important to the calculation of the likelihood ratio, LR in each case.

In this first consideration, we consider the position where allele dropout is not involved given the suspect's genotype.

In a second consideration, below, we consider the position where allele dropout is involved given the suspect's genotype.

### 6.3.3.1—First Consideration

The first consideration opens with those cases where all the expected peaks given the genotype, including any stutter peaks present, are above the detection threshold limit T. The genotype is denoted as:

gₗ₍ᵢ₎={a_{1,l(i)},a_{2,l(i)}}

where the alleles a may be the same (homozygous) or different (heterozygous) in that locus, i. The pdf is constructed in seven steps.
Step 1 The peak-height sum is denoted by χₗ₍ᵢ₎. Let's denote the corresponding means for the peak heights of the alleles and the stutters of the putative donor gₗ₍ᵢ₎ by μ_{a,1,l(i)} and μ_{s,1,l(i)} respectively. They are a function of χₗ₍ᵢ₎ and obtained as described elsewhere. For each allele a of the donor, we assign the allele mean μ_{a,1,l(i)} to the position of allele a, and the stutter means μ_{s,1,l(i)} to a position a−1. If the donor is homozygote, we do the assignment twice.
Step 2 If the donor is a heterozygote, the means are modified using the EAQ factor δ to take into account factors, such as PCR efficiency and degradation, that affect the resulting peak heights. For example, if the donor is a heterozygote in locus l(i) the mean for his/her alleles and stutters are: δ₁xμ_{a,1,l(i)} and δ₁xμ_{s,1,l(i)} for the low-molecular-weight allele and δ₂xμ_{a,1,l(i)} and δ₂xμ_{s,1,l(i)} for the high-molecular-weight allele. We give a detailed description of the method for calculating δ₁ and δ₂ elsewhere.
Step 4 The variances for each allele and stutter are obtained as a function of their corresponding means and obtained using the method described above. In alter step we need to add random Gamma variables. A condition for a close form calculation of this addition is that the β-parameters are the same. Also in a later step, we divide each Gamma by the overall sum of peak height to account for using the sum of peak heights in this locus. A closed form calculation can be done if all β parameters are the same. The conditioned on the β-parameters can be obtained by estimating a line between the points form by the means, in the x-axis, and the variances, in the y-axis. A regression line with zero intercept is fitted to obtain:

\hat{σ}²=κ₂xμ

So, if peak i has mean and variance (μᵢ,σᵢ²),

β=μᵢ/σᵢ²=μᵢ(κ₂xμᵢ)=1/κ₂
regardless of the value of μ_{I}.
Step 5 The shape (α) and rate (β) parameters are obtained from the mean and the variances.
Step 6 The alpha parameters for alleles and stutters in the same allele position are added to obtain an overall a for that allele position. Now we have the parameters of a Gamma distribution for each allele position.
Step 7 To account for using the sum of peak height in the locus, the collection of Gamma pdfs whose peak heights are above the peak-height reporting limit are converted to a Dirichlet pdf. This is achieved in closed form because all β's are the same. The resulting Dirichlet pdf inherit the α parameters of the Gammas.

### 6.3.3.2 Second Consideration

In the second consideration, allele dropout is invoked given the suspects genotype, the consideration has to reflect one or more of the heights in the profile being below the threshold T. In such a case, the peak which is below the threshold does not form part of the value of χₗ₍ᵢ₎ and the correction is only applied to those peaks above the threshold.

For example, in the case of a non-adjacent heterozygous alleles case, when h_{s,1,l(i)}<T then the PDF is given by:

ƒ(h_{s,1,l(i)}<T,h_{a,1,l(i)},h_{s,2,l(i)},h_{a,2,l(i)}|gₗ₍ᵢ₎={a_{1,l(i)},a_{2,l(i)}},χₗ₍ᵢ₎,δ)

which can be expressed as:

F(T|α_{s,1,l(i)},β)ƒ_{Dir}(π_{a,1,l(i)},π_{s,2,l(i)},π_{a,2,l(i)},|α_{a,1,l(i),α}_{s,2,l(i)}α_{a,2,l(i)},)

where F is the cdf of a gamma distribution with parameters α_{s,1,l(i)} and β.

If there is more than one peak below the threshold T, then there will be a corresponding number off.

The approach for the second consideration is closely based on the approach for the first consideration, together with these revisions.

### 6.3.3.3—Example

### One Allele

In this case, the donor is homozygous. Hence, the term α_{a,1,l(i)} is deployed twice for the allele and the term α_{s,1,l(i)} is deployed twice for the stutter (if present). The probability density for cₗ₍ᵢ₎ is given by multiplying two Gamma pdf's. The first has parameters 2α_{s,1,l(i)} and β, and the second has parameters 2α_{a,1,l(i)} and β. Thereby giving the expression:

ƒ(h_{s,1,l(i)},h_{a,1,l(i)}|gₗ₍ᵢ₎={a_{1,l(i)},a_{2,l(i)}},χₗ₍ᵢ₎,δ)

which can be expressed as:

ƒ(h_{s,1,l(i)}|2α_{s,1,l(i)},β)ƒ(h_{a,1,l(i)}|2α_{a,1,l(i)},β)

In the next step, the effect of conditioning on the sum of heights χₗ₍ᵢ₎ is removed. Because the sum of the height is known, the contribution of the heights is only made through their contribution to the sum. So the PDF is replaced with:

$$\begin{matrix}f ( {h}_{s , 1 , l ( i )} , {h}_{a , 1 , l ( i )} \vert {g}_{l ( i )} = \{ {a}_{1 , l ( i )} , {a}_{a , l ( i )} \} , {χ}_{l ( i )} , δ \\ = {f}_{Dir} ( {π}_{s , 1 , l ( i )} , {π}_{a , 1 , l ( i )} \vert 2 {α}_{s , 1 , l ( i )} , 2 {α}_{a , 1 , l ( i )} )\end{matrix}$$

where π_{s,1,l(i)}=h_{s,1,l(i)}|gₗ₍ᵢ₎ and π_{a,1,l(i)}=h_{a,1,l(i)}|gₗ₍ᵢ₎ and ƒ_{Dir} is a Dirichlet pdf.

### 6.3.3.4—Example

### Two Alleles—Non-Adjacent Positions

In this case, the donor is heterozygous and their alleles for this locus are not in adjacent positions. For instance, the alleles might be 16, 18.

In this case, four a's are deployed, with those being α_{s,1,l(i)},α_{a,1,l(i)},α_{s,2,l(i)} and α_{a,2,l(i)}. The probability density for cₗ₍ᵢ₎ is given by multiplying four Gamma pdf's. The α parameters are given by α_{s,1,l(i)},α_{a,1,l(i)},α_{s,2,l(i)} and α_{a,2,l(i)}, with a single β. Thereby giving the expression:

ƒ(h_{s,1,l(i)},h_{a,1,l(i)}h_{s,2,l(i)},h_{a,2,l(i)}|gₗ₍ᵢ₎={a_{1,l(i)},a_{2,l(i)}},χₗ₍ᵢ₎,δ)

which can be expressed as:

ƒ(h_{s,1,l(i)},|α_{s,1,l(i)},β)ƒ(h_{a,1,l(i)},|α_{a,1,l(i)},β)ƒ(h_{s,2,l(i)},|α_{s,2,l(i)},β)ƒ(h_{a,2,l(i)},|α_{a,2,l(i)},β)

Once again, the conditioning on χₗ₍ᵢ₎ is removed, to obtain:

=ƒ_{Dir}(π_{s,1,l(i)},π_{a,1,l(i)}π_{s,2,l(i)},π_{a,2,l(i)}|α_{s,1,l(i)},α_{a,1,l(i)}α_{s,2,l(i)},α_{a,2,l(i)})

where the π's are the ratios of their respective h's divided by χₗ₍ᵢ₎.

### 6.3.3.5—Example

### Two Alleles—Adjacent Positions

In this case, the donor is heterozygous and their alleles for this locus are in adjacent positions. For instance, the alleles might be 16, 17. Because of their positions, the stutter for allele 2 is in the same position as allele 1.

In this case four α's are deployed, with those being α_{s,1,l(i)},α_{a,1,l(i)},α_{s,2,l(i)}, and α_{a,2,l(i)}. The probability density for cₗ₍ᵢ₎={h_{s,1,l(i)},h_{a,1,l(i)},h_{a,2,l(i)}} is given by multiplying the Gamma pdf's having α parameters given by α_{s,1,l(i)},α_{a,1,l(i)}+α_{s,2,l(i)} and α_{a,2,l(i)}, with a single β.

Taking the approach outlined above, and after having accounted for the conditioning on χₗ₍ᵢ₎ the expression gives:

ƒ(h_{s,1,l(i)},h_{a,1,l(i)},h_{a,2,l(i)}|gₗ₍ᵢ₎={a_{1,l(i)},a_{2,l(i)}},χₗ₍ᵢ₎,δ)

and hence:

=ƒ_{Dir}(π_{s,1,l(i)},π_{a,1,l(i)},π_{a,2,l(i)}|α_{s,1,l(i)},α_{a,1,l(i)}+α_{s,2,l(i)},α_{a,2,l(i)}).

### 6.3.4—Use of the Approach

Given a putative genotype, the peaks in the crime profile are either bigger or smaller than the reporting threshold Tᵣ, or not present at all. We treat missing peaks and peaks smaller than Tᵣ as peak that has dropped out.

We partition the crime profile for a given pair of genotype as:

cₗ₍ᵢ₎={h:hεcₗ₍ᵢ₎,h<Tᵣ}∪{h:hεcₗ₍ᵢ₎,h≧Tᵣ}

The resulting pdf is given by:

$$f ( {c}_{l ( i )} \vert {g}_{1 , l ( i )} , {g}_{2 , l ( i )} , {χ}_{l ( i )} , δ , ω ) = f ( π \vert α ) \times {\prod }_{( h \text{:} h ∈ {c}_{l ( i )} , h < {T}_{r} \}}^{ } F ( T \vert {α}_{h} , {β}_{h} )$$

ƒ(π|α) is a Dirichlet pdf with parameters:

α=∪{αₕ:hεcₗ₍ᵢ₎,h≧T} and

π∪={h/χ′ₗ₍ᵢ₎:hεcₗ₍ᵢ₎,h≧Tᵣ}

where aₕ is the alpha parameter of the associated Gamma pdf in the corresponding position of height h.

*χ′ₗ₍ᵢ₎=Σ_{hεc}_{ₗ₍ᵢ₎}_{,h≧T}_{ᵣ}h is the sum of peak heights bigger than reporting threshold Tᵣ.
F(Tᵣ|αₕ,βₕ) is the CDF of a Gamma distribution with parameters αₕ and βₕ for the peak in the position of h calculated as described above.

### 6.4—Peak Balance Parameter Model

### 6.4.1—Overview

As mentioned above, the approach uses a peak imbalance parameter/effective amplified quanitity (EQE) parameter, δ, in the form of a set of δ's, such that there is one for each of the alleles. Each of the peak imbalance parameters in the set can be used to adjust the means for the alleles.

The approach models degradation and other peak imbalance effects prior to any knowledge of the suspect's genotype. For each locus, the molecular weight of the peaks in the profile is associated with the sum of the heights. So as the molecular weight of the locus increase, a reduction in the sum of the peak heights is estimated.

### 6.4.2—Details

Following this approach, for locus l(i), there are a set of peak heights: hₗ₍ᵢ₎={h_{j,l(i)}: j=1, . . . nₗ₍ᵢ₎}. Each height has an associated base pair count: bₗ₍ᵢ₎={b_{j,l(i)}: j=1, . . . nₗ₍ᵢ₎}. An average base pair count is used as a measure of molecular weight for the locus, weighted by peak heights. This is defined as:

$${\overline{b}}_{l ( i )} = \frac{{\sum }_{j = 1}^{n} {b}_{j , l ( i )} {h}_{j , l ( i )}}{{χ}_{l ( i )}}$$

where

$${χ}_{l ( i )} = {\sum }_{j = 1}^{{n}_{l ( i )}} {h}_{j , l ( i )}$$

and so the degradation model is defined as:

χₗ₍ᵢ₎=d₁+d₂ b̅ₗ₍ᵢ₎

where d₁ and d₂ are the same for all loci.

The parameters d₁ and d₂ can be calculated using the least squared estimation. As some loci may behave differently to degradation etc, the sum of the peak heights for these loci are treated as outliers.

To deal with these outliers, a Jacknife method is used. There are n_{L} loci with peak height and base pair information. Hence, the approach:
1. fits a regression model n_{L} times, removing the i^{th} value of the sets {χₗ₍ᵢ₎: i=1, . . . n_{L}} and { b̅ₗ₍ᵢ₎:i=1, . . . n_{L}}.
2. uses the regression model to produce a prediction interval, \hat{χ}ₗ₍ᵢ₎=/−2σ where σ is the standard deviation of the residuals in the fitted regression line.
3. when the sum of the peak height χᵢ, which is not used for the estimation of the regression line, does not lie within the prediction interval, then consider it as an outlier.
4. removes any outliers from the data set and refits the model, after the n_{L} models have been produced. The values of d₁ and d₂ are extracted from the model estimated without outliers.

If the degradation etc in the profile is negligible. Peak height variability may cause the estimated value of d₂ to be greater than zero. In such cases, d₂ is set as 0 and d₁ as 1.

In the deployment of the degradation model, at locus l(i) there is a crime profile with peaks having allele designations α_{j,l(i)} and base pair counts bₗ₍ᵢ₎={b_{j,l(i)}: j=1, . . . nₗ₍ᵢ₎}. If degradation were not being accounted for, then given the sum of the peak heights χₗ₍ᵢ₎ it is possible to obtain a mean and a variance from a Gamma distribution.

When considering degradation, the same Gamma distribution is used, but the degradation model is used to adapt the Gamma pdf to account for the molecular weight of the allele.

As previously mentioned, peak heights increase with the sum of peak heights χₗ₍ᵢ₎ and therefore the mean and variance also increase accordingly. If an allele is of high molecular weight, a reduction of χₗ₍ᵢ₎ results in a reduction in the mean and variance. The degradation model reduced or increases the χₗ₍ᵢ₎ associated with an allele according to degradation by using an appropriate δ for that allele.

The appropriate δ's are calculated as follows using the degradation model χₗ₍ᵢ₎=d₁+d₂ b̅ₗ₍ᵢ₎.

The degradation parameter associated with alleles α_{j,l(i)} is defined as δ_{j,l(i)} so that the sum of peak heights associated with this allele are δ_{j,l(i)}·χₗ₍ᵢ₎.

For each allele the model is used to estimate the associated peak height sum:

\hat{χ}_{j,l(i)}=d₁+d₂b_{j,l(i)}

The calculations of δ are made such that the ratio of the estimated peak height sums are preserved; that is:

$$\frac{{\hat{χ}}_{j , l ( i )}}{{\hat{χ}}_{j + 1 , l ( i )}} = \frac{{δ}_{j , l ( i )} \cdot {χ}_{l ( i )}}{{δ}_{j + 1 , l ( i )} \cdot {χ}_{l ( i )}}$$

To do this, a set of nₗ₍ᵢ₎−1 equations with nₗ₍ᵢ₎ unknowns, are provided:

$$\frac{{\hat{χ}}_{j , l ( i )}}{{\hat{χ}}_{j + 1 , l ( i )}} = \frac{{δ}_{j , l ( i )}}{{δ}_{j + 1 , l ( i )}}$$

The ratios on the left-hand side are obtained from the degradation model and the δ's are the unknown variables. A restriction is set, such that the average peak height sum in the locus remains the same after the application of the δ's, that is:

$$\frac{{\sum }_{j = 1}^{{n}_{l ( i )}} {δ}_{j , l ( i )} \cdot {χ}_{l ( i )}}{{n}_{l ( i )}} = {χ}_{l ( i )}$$

which gives a further equation with the δ's as unknown quantities. This allows a solution to be found as there are nₗ₍ᵢ₎ equations in the system and nₗ₍ᵢ₎ unknowns.

The ratio of the estimated peak height sum is denoted:

$${r}_{j , l ( i )} = \frac{{\hat{χ}}_{j , l ( i )}}{{\hat{χ}}_{j + 1 , l ( i )}} , \\ j = 1 , 2 … {n}_{l ( i )} - 1$$

$${r}_{j , l ( i )} = 1 , \\ j = {n}_{l ( i )}$$

The degradation parameters δ's, are then given by:

$${δ}_{j , l ( i )} = \frac{{n}_{l ( i )} {\prod }_{k = j}^{{n}_{l ( i )}} {r}_{k , l ( i )}}{{\sum }_{k = 1}^{{n}_{l ( i )}} {\prod }_{k}^{{n}_{l ( i )}} {r}_{k , l ( i )}}$$

The stutter associated with an allele, will have the same degradation parameter δ as the allele because the starting DNA molecule is the same in each case.

### 6.4.3—Example

In FIG. 23, a table is shown which details profile information, DNA quantity for the loci and the weighted base pair count for the degraded profile observed.

From the linear model of degradation provided above, χₗ₍ᵢ₎=d₁+d₂ b̅ₗ₍ᵢ₎, this gives:

χ=3629.882−12.225b.

In FIG. 24, a plot of weighted base pair against DNA quantity per locus is provided, with the linear model overlaid. FIG. 25 shows in the table two examples of the degradation model as deployed.

### 6.5—Multiple Source Samples

Using the same background information provided above, and a similar approach to that taken on samples from a single source, it is possible to extend the approach to multiple source samples.

### 6.5.1 Evidential Uses

Applying the approach provided above for the single source samples, the numerator can be stated as:

$$Num = f ( c \vert {g}_{U 1} , {G}_{U 2 s} , {H}_{p} ) = {\prod }_{i = T}^{{n}_{l}} f ( {c}_{l ( i )} \vert {g}_{U 1 , l ( i )} , {g}_{U 2 , l ( i )} , {H}_{p} , {χ}_{l ( i )} , δ )$$

and the denominator as:

$$Den = f ( c \vert {g}_{U 1} , {G}_{U 2} , {H}_{d} ) = {\prod }_{i = T}^{{n}_{l}} f ( {C}_{l ( i )} \vert {g}_{U 1 , l ( i )} , {g}_{U 2 , l ( i )} , {H}_{d} , {χ}_{l ( i )} , δ )$$

In both instances, the core pdf is of the type previously identified, namely:

ƒ(cₗ₍ᵢ₎|g_{U,1,l(i)},g_{U,2,l(i)},χₗ₍ᵢ₎,δ)

### 6.5.2 Intelligence Uses

The task is to compute the posterior probability p(g_{U,1,l(i)},g_{U,2,l(i)}|Cₗ₍ᵢ₎,χₗ₍ᵢ₎,δ) of pair of genotypes given the peak heights in the profile. This probability is computed using Bayes theorem.

$$p ( {g}_{U , 1 , l ( i )}^{*} , {g}_{U , 2 , l ( i )}^{*} \vert {C}_{l ( i )} , {χ}_{l ( i )} , δ ) = \frac{f ( {c}_{l ( i )} \vert {g}_{U , 1 , l ( i )}^{*} , {g}_{U , 2 , l ( i )}^{*} , {χ}_{l ( i )} , δ ) p ( {g}_{U , 1 , l ( i )}^{*} , {g}_{U , 2 , l ( i )}^{*} )}{{\sum }_{{g}_{U , 1 , l ( i ) , {g}_{U , 2 , l ( i )}}}^{ } f ( {c}_{l ( i )} \vert {g}_{U , 1 , l ( i )} , {g}_{U , 2 , l ( i )} , {χ}_{l ( i )} , δ ) p ( {g}_{U , 1 , l ( i )} , {g}_{U , 2 , l ( i )} )}$$

We assume that the prior probability for the pair of genotypes is the same for any genotype combination in the locus, therefore the formula above simplifies to:

$$p ( {g}_{U , 1 , l ( i )}^{*} , {g}_{U , 2 , l ( i )}^{*} \vert {C}_{l ( i )} , {χ}_{l ( i )} , δ ) = \frac{f ( {c}_{l ( i )} \vert {g}_{U , 1 , l ( i )}^{*} , {g}_{U , 2 , l ( i )}^{*} , {χ}_{l ( i )} , δ )}{{\sum }_{{g}_{U , 1 , l ( i ) , {g}_{U , 2 , l ( i )}}}^{ } f ( {c}_{l ( i )} \vert {g}_{U , 1 , l ( i )} , {g}_{U , 2 , l ( i )} , {χ}_{l ( i )} , δ )}$$

The pdf for the peak heights given a pair of putative genotypes is calculated using the formula below:

$$f ( {c}_{l ( i )} \vert {g}_{U , 1 , l ( i )} , {g}_{U , 2 , l ( i )} , {χ}_{l ( i )} , δ ) = {\sum }_{ω}^{ } f ( {c}_{l ( i )} \vert {g}_{U , 1 , l ( i )} , {g}_{U , 2 , l ( i )} , {χ}_{l ( i )} , δ , ω ) p ( ω )$$

where ω is the mixing proportion.

Again the core pdf function ƒ(cₗ₍ᵢ₎|g_{U,1,l(i)},g_{U,2,l(i)},χₗ₍ᵢ₎,δ) features.

As with the single source sample, not all pair of genotypes will have a non-zero probability. We therefore use the crime profile to guess pair of genotypes that may have zero probability. Peaks in the crime profile are designated as alleles or stutters. The genotypes are produced based on the peaks designated as alleles. We describe all cases below:
1. No peaks are bigger than the reporting threshold Tᵣ. No genotypes are generated.
2. One peak bigger than Tᵣ is designated as allele, denoted by a. There are two possible genotypes {a, a} and a, Q} where Q denoted any allele other than a. Any pairing of these genotypes is possible: ({a, a}, {a, a}), ({a, a}, {a, Q}) and ({a, Q}, {a, Q}).
3. Two peaks bigger than Tᵣ designated as alleles, denoted by a and b. The possible genotypes are {a, a}, {a, b}, {a, Q}, {b, b}, {b, Q} and {Q, Q} where Q is any allele other than a and b. Any combination of pair of genotypes whose union contains a, b is a possible pair of genotypes: {a, a} with any genotype that contains b; {a, b} with any genotype in the list; {a, Q} with any genotype that contains b; {b, b} with any genotype that contains a; {b, Q} with any genotype that contains a; and {Q, Q} with {a, b}.
4. Three peaks bigger than Tᵣ, denoted by a, b and c. This case follows exactly the same logic as in the case above. There are 10 genotypes that are possible from allele set: a, b, c and Q, where Q denotes any allele other than a, b and c. All genotype pairs whose union contains a, b, c.
5. Four peaks bigger than Tᵣ are designated as alleles, denoted by a, b, c and d. In this case there are 10 possible pair of genotypes. Any genotype pair whose union is a, b, c, d is considered as a possible genotype pair.

In practice the interest lies on genotype pairs such that the first and second genotype corresponds to the major and minor contributor respectively. The calculation of the posterior probabilities in this section is done for all possible combinations of genotypes and mixing proportions. Moving from all combinations of genotypes to major minor requires folding the space of all combinations of genotypes and mixing proportions in two. To explain this point we need to introduce further notation:

Gⱼ: a random variable for the genotype of contributor j, j=1,2;

gⱼ: specific instances of a genotype, j=1,2; g₁ and g₂ can be the same or different genotype.

G_{M}: a random variable for the genotype of the major contributor;

Gₘ: a random variable for the genotype of the minor contributor.

We are interested in the probabilities:

$$Pr ( {G}_{M} = {g}_{1} , {G}_{m} = {g}_{2} \vert {c}_{l ( i )} ) = {\sum }_{ω ∈ Ω \geq 0.5}^{ } Pr ( {G}_{M} = {g}_{1} , {G}_{m} = {g}_{2} \vert {c}_{l ( i )} , ω ) p ( ω )$$

where Ω≧0.5 is a discreet set of mixing proportions greater or equal to 0.5. When ω>0.5 the first factor in the summation in the above equation is:

$$\begin{matrix}Pr ( {G}_{M} = {g}_{1} , {G}_{m} = {g}_{2} \vert {c}_{l ( i )} ω ) = Pr ( {G}_{1} = {g}_{1} , {G}_{2} = {g}_{2} \vert {c}_{l ( i )} , ω ) + \\ Pr ( {G}_{1} = {g}_{2} , {G}_{2} = {g}_{1} \vert {c}_{l ( i )} , 1 - ω ) \\ = 2 \times Pr ( {G}_{1} = {g}_{1} , {G}_{2 m} = {g}_{2} \vert {c}_{l ( i )} , ω )\end{matrix}$$

$$If ω = 0.5 \text{:}$$

$$Pr ( {G}_{M} = {g}_{1} , {G}_{m} = {g}_{2} \vert {c}_{l ( i )} ω ) = Pr ( {G}_{1} = {g}_{1} , {G}_{2} = {g}_{2} \vert {c}_{l ( i )} , ω ) .$$

### 6.5.3—Consideration of Mixing Proportion

In mixed source samples, the mixing proportion comes into play. On the basis that major and minor contributors are considered, then the values are:

ωε=(0.5,0.6, . . . 0.9).

In fact, the posterior probability of the mixing proportion given the peaks heights across all loci is used, expressed as:

$$f ( {c}_{l ( i )} \vert {g}_{U , 1 , l ( i )} , {g}_{U , 2 , l ( i )} ) = {\sum }_{ω}^{ } f ( {c}_{l ( i )} \vert {g}_{U , 1 , l ( i )} , {g}_{U , 2 , l ( i )} , ω ) p ( ω \vert {c}_{l ( 1 )} , {c}_{l ( 2 )} , … {c}_{1 ( nLoci )} )$$

The method for obtaining the posterior probability of the mixing proportion given peak heights, the second factor in the summation, is described in section 6.5.4. The method for computing pdf in the first factor of the summation is given in section 6.5.5.

### 6.5.4—Mixing Proportion Posterior Distribution

For each locus l(i) we generate a set of possible genotype pairs of potential contributors of the crime profile cₗ₍ᵢ₎. The j-th instance of the genotype of the contributor 1 and 2 are denoted by g_{U1,j,l(i)} and g_{U2,j,l(i)}, respectively, where n_{g} is the number of genotype pairs. We are interested in calculating the posterior probability of pair of genotypes given the peak heights in the crime profile cₗ₍ᵢ₎. For this calculation we need a probability distribution for mixing proportion. In this section we describe a sequential method for calculating the posterior distribution of mixing proportion given peak heights across loci.

The mixing proportion is a continuous quantity in the interval (0, 1). However, for practical purposed, we use a discrete probability distribution. Assume that we have mixing proportions ω={ωₖ: k=1, . . . , n_{ω}}, where n_{ω} is the number of mixing proportions considered. We set a prior distribution for mixing proportion as uniform over the discrete values. Using Bayes theorem, the posterior distribution for mixing proportion given the peak heights in locus i is:

$$p ( {ω}_{k} \vert {c}_{l ( i )} , {χ}_{l ( i )} , δ ) = \frac{f ( {c}_{l ( 1 )} \vert {χ}_{l ( 1 )} , {ω}_{k} , δ ) p ( {ω}_{k} )}{{\sum }_{m = 1}^{{n}_{ω}} f ( {c}_{l ( 1 )} \vert {χ}_{l ( 1 )} , δ , {ω}_{m} ) p ( {ω}_{m} )}$$

The posterior distribution of mixing proportion for locus i, i=2, 3, . . . , n_{L} is given by:

$$p ( {ω}_{k} \vert {c}_{l ( 1 )} , … , {c}_{l ( i )} , {χ}_{l ( 1 )} , … {χ}_{l ( i )} , δ ) = \frac{f ( {c}_{l ( i )} \vert {χ}_{l ( i )} , {ω}_{k} , δ ) p ( {ω}_{k} ) \vert \vert {c}_{l ( 1 )} , … , {c}_{l ( i - 1 )} , {χ}_{l ( 1 )} , … {χ}_{l ( i - 1 )} , δ}{\begin{matrix}{\sum }_{m = 1}^{{n}_{ω}} f ( {c}_{l ( i )} \vert {χ}_{l ( i )} , δ , {ω}_{m} ) \\ p ( {ω}_{m} \vert {c}_{l ( 1 )} , … , {c}_{l ( i - 1 )} , {χ}_{l ( 1 )} , … {χ}_{l ( i - 1 )} , δ\end{matrix}}$$

where ƒ(ωₖ|cₗ₍ᵢ₎,χₗ₍ᵢ₎), i=1, 2, . . . n_{L} is defined in the following paragraph. If there are any loci with no information they are ignored in the calculation as having no information.

The probability density of the peak height in the crime profile cₗ₍ᵢ₎ at locus l(i) for a given mixing proportion ωₖ is given by:

$$f ( {c}_{l ( i )} \vert {χ}_{l ( i )} , {ω}_{k} ) = {\sum }_{j = 1}^{{n}_{g}} f ( {c}_{l ( i )} \vert {g}_{U 1 , j , l ( i )} , {g}_{U 2 , j , l ( i )} , {χ}_{l ( i )} , {ω}_{k} ) p ( {g}_{U 1 , j , l ( i )} , {g}_{U 2 , j , l ( i )} )$$

where p(g_{U1,j,l(i)},g_{U2,j,l(i)}) is the probability of the two genotypes prior to observing the crime profile. This is based on the assumption of an equal probability of all genotype pairs:

$$p ( {g}_{U 1 , j , l ( i )} , {g}_{U 2 , j , l ( i )} ) = \frac{1}{{n}_{g}}$$

This

$$\frac{1}{{n}_{g}}$$

will cancel out in the following equations and it is thus ignored. Then the probability density in the above equation then simplifies to:

$$f ( {c}_{l ( i )} \vert {χ}_{l ( i )} , {ω}_{k} ) = {\sum }_{k = 1}^{{n}_{g}} f ( {c}_{l ( i )} \vert {g}_{U 1 , j , l ( i )} , {g}_{U 2 , j , l ( i )} , {χ}_{l ( i )} , {ω}_{k} )$$

The pdf in the summation of the above is described in section 6.5.5.

The calculations in this method can be readily represented using Bayesian Networks. The starting point is the Bayesian Network in FIG. 25a (with Ω as the mixing proportion). The effect of the above equation is represented in FIG. 25b by erasing the nodes corresponding to the putative genotypes. The effect of using equation

$$p ( {ω}_{k} \vert {c}_{l ( 1 )} , … , {c}_{l ( i )} , {χ}_{l ( 1 )} , … {χ}_{l ( i )} , δ ) = \frac{f ( {c}_{l ( i )} \vert {χ}_{l ( i )} , {ω}_{k} , δ ) p ( {ω}_{k} ) \vert \vert {c}_{l ( 1 )} , … , {c}_{l ( i - 1 )} , {χ}_{l ( 1 )} , … {χ}_{l ( i - 1 )} , δ}{\begin{matrix}{\sum }_{m = 1}^{{n}_{ω}} f ( {c}_{l ( i )} \vert {χ}_{l ( i )} , δ , {ω}_{m} ) \\ p ( {ω}_{m} \vert {c}_{l ( 1 )} , … , {c}_{l ( i - 1 )} , {χ}_{l ( 1 )} , … {χ}_{l ( i - 1 )} , δ\end{matrix}}$$

for locus l(i) takes us from FIG. 25b to FIG. 25c. The effect of using the same equation for locus l(j) takes the position from FIG. 25c to FIG. 25d.

### 6.5.5—Probability Density Function ƒ(cₗ₍ᵢ₎|g_{1,l(i)},g_{2,l(i)},ω,χₗ₍ᵢ₎,δ)

### 6.5.5.1—Overview

As identified above, in evidential and intelligence uses involving mixed source samples, the pdf ƒ(cₗ₍ᵢ₎|g_{1,l(i)},g_{2,l(i)},ω,χₗ₍ᵢ₎,δ) is of great importance.

In this section we describe the construction and use of the pdf for a crime profile given two putative donors. We use a running example to illustrate the method. The example is for locus D2. The crime profile and putative donors used in the example are given in Table 1.

TABLE 1

| allele | height | donor 1 | donor 2 | base pair count |
|---|---|---|---|---|
| 16 | 124 | | | 293 |
| 17 | 2243 | · | | 297 |
| 21 | 0 | | | 313 |
| 22 | 271 | | · | 317 |
| 23 | 169 | | | 321 |
| 24 | 2044 | · | · | 325 |

### 6.5.5.2—Construction

This pdf is closely related in principles and approach to that detailed for single source samples and again is constructed in seven steps:
Step 1 The associated peak-height sum for donor 1 is ωxχₗ₍ᵢ₎. Let's denote the corresponding means for the peak height of the alleles and the stutters of this donor by μ_{a,1,l(i)} and μ_{s,1,l(i)}, respectively. They are obtained as a function of χ_{D2} using the method described in section 6.2.7.3. For each allele a of donor 1, we assign the allele mean μ_{a,1,l(i)} to the position of allele a, and the stutter mean μ_{s,1,l(i)} to position a−1. If the donor is homozygote, we do the assignment twice.
   In the example, the sum of peak height above the limit of detection of 30 rfu is χ_{D2}=4851 and the mixing proportion is ω=0.9. The associated sum of peak heights for donor 1 is ωxχ_{D2=}4365.9. The sum of peak heights are in fact across all loci and therefore to obtain the means for alleles and stutters we multiply by 10. The expected mean height for stutters and alleles are given in table 2.

TABLE 2

| Mean | Value |
|---|---|
| μ_{a,1,D2} | 1501.87 |
| μ_{s,1,D2} | 100.42 |

Step 2 The associated peak-height sum for donor 2 is (1−ω)xχₗ₍ᵢ₎ with associated mean for allele and stutters: μ_{a,2,l(I)} and μ_{s,2,l(I)}. The assignment of means is done as in step 1.
   The associated peak height sum for donor 2 is (1−ω)xχ_{D2}=485.1. The means for alleles and stutter are given in Table 3.

TABLE 3

| Mean | Value |
|---|---|
| μ_{a,2,D2} | 166.87 |
| μ_{s,2,D2} | 11.16 |

Step 3 If a donor is a heterozygote, the means are modified to take into account factors, such as PCR efficiency and degradation, that affect the resulting peak heights. For example, if donor 1 is a heterozygote in locus l(i), the mean for his/her alleles and stutters are: δ₁xμ_{a,1,l(I)} and δ₁xμ_{s,1,l(I)} for the low-molecular-weight allele and δ₂xμ_{a,1,l(I)} and δ₂μ_{s,1,l(I)} for the high-molecular-weight allele. We give a detailed description of the method for calculating δ₁ and δ₂ elsewhere.
   In the example, both donors are heterozygotes. The EAQ factors for both donors are given in the Table 4. Notice that the EAQ factors for donor 1 are more separated than the EAQ factors of donor 2. This is due to the greater separation in base pairs between the alleles of donor 1 and the alleles of donor 2. The adjusted means for alleles and stutters are also given in Table 4.

| | Donor 1 | | | Donor 2 | | | Base |
|---|---|---|---|---|---|---|---|
| | De- | EAQ | | De- | EAQ | | pair |
| Allele | tected? | factor | means | tected? | factor | means | count |
| 16 | | δ1 = | 103.13 | | | | 293 |
| | | 1.027 | | | | | |
| 17 | X | δ1 = | 1542.42 | | | | 297 |
| | | 1.027 | | | | | |
| 21 | | | | | δ1 = | 12.07 | 313 |
| | | | | | 1.082 | | |
| 22 | | | | X | δ1 = | 180.56 | 317 |
| | | | | | 1.082 | | |
| 23 | | δ2 = | 97.60 | | δ2 = | 10.24 | 321 |
| | | 0.972 | | | 0.918 | | |
| 24 | X | δ2 = | 1459.2 | X | δ2 = | 153.19 | 325 |
| | | 0.972 | | | 0.918 | | |

Step 4 The variances for each allele and stutter are obtained as a function of means using the method described above. In later step we need to add random Gamma variables. A condition for a close form calculation is that the β-parameters are the same. Also in a later step, we divide each Gamma by the overall sum of peak height to account for using the sum of peak heights in this locus. A closed form calculation can be done if all β parameters are the same. The conditioned on the β-parameters can be obtained by estimating a line between the points formed by the means, in the x-axis, and the variances, in the y-axis. A regression line with zero intercept is fitted to obtain:

\hat{σ}²=κ₂xμ

So, if peak i has mean and variance (μᵢ,σᵢ²),

β=μᵢ/σᵢ²=μᵢ/(κ₂xμᵢ)=1/κ₂

regardless of the value of μᵢ. In this example k₂=118.2. Table 5 shows the standard deviations computed from the data and with the linear relationship between the means and variances.
Step 5 The shape (α) and rate (β) parameters are obtained from the mean (μ) and the variances (\hat{σ}²) using the known formulae α=(μ/\hat{σ}²)² and β=μ/\hat{σ}².
Step 6 The alpha parameters for alleles and stutters in the same allele position are added to obtain an overall α for that position. Now we have the parameters of a Gamma distribution for each position.

TABLE 5
Estimated means (μ) and standard deviations (σ) and
the standard deviations \hat{μ} obtained from the
linear relationship between the means (μ) and the variances (σ²)

| | | Donor 1 | | | | Donor 2 | | |
|---|---|---|---|---|---|---|---|---|
| Allele | | (μ) | (σ) | (σ²) | | (μ) | (σ) | (σ²) |
| 16 | | 103.13 | 45.17 | 110.41 | | | | |
| 17 | X | 1542.42 | 435.38 | 426.98 | | | | |
| 21 | | | | | | 12.07 | 3.56 | 37.77 |
| 22 | | | | | X | 180.56 | 66.44 | 146.10 |
| 23 | | 97.60 | 43.57 | 107.41 | | 10.24 | 12.06 | 35.29 |
| 24 | X | 1459.2 | 412.06 | 415.39 | X | 153.19 | 59.10 | 134.56 |

Step 7 To account for using the sum of peak height in the locus, the collection of Gamma pdfs whose peak heights are above the peak-height reporting limit are converted to a Dirichlet pdf. This is achieved in closed form because all β's are the same. The resulting Dirichlet pdf inherit the α parameters of the Gammas.

### 6.5.6—Use of the Approach

Given a pair of putative genotypes, the peaks in the crime profile are either bigger or smaller than the reporting threshold Tᵣ, or not present at all. We treat missing peaks and peaks smaller than Tᵣ as peak that has dropped out. We write the crime profile for a given pair of genotype as:

cₗ₍ᵢ₎={h:hεcₗ₍ᵢ₎,h<Tᵣ}∪{h:hεcₗ₍ᵢ₎,h≧Tᵣ}

The resulting pdf is given by:

$$f ( {c}_{l ( i )} \vert {g}_{1 , l ( i )} , {g}_{2 , l ( i )} , {χ}_{l ( i )} , δ , ω ) = f ( π \vert α ) \times {\prod }_{\{ h \text{:} h ∈ {c}_{l ( i )} , h < {T}_{r} \}}^{ } F ( T \vert {α}_{h} , {β}_{h} )$$

The terms are explained below:
ƒ(π|α) is a Dirichlet pdf with parameters

α=∪{αₕ:hεcₗ₍ᵢ₎,h≧Tᵣ}

and

π=∪{h/χ′ₗ₍ᵢ₎:hεcₗ₍ᵢ₎,h≧Tᵣ}

where αₕ is the alpha parameter of the associated Gamma pdf in the corresponding position of height h.

χ′ₗ₍ᵢ₎=Σ_{hεc}_{ₗ₍ᵢ₎}_{,h≧T}_{ᵣ}h is the sum of peak heights bigger than reporting threshold Tᵣ.
F(Tᵣ|αₕ,βₕ) is the CDF of a Gamma distribution with parameters αₕ and βₕ for the peak in the position of h calculated as described above.

### 6.7—Peak Imbalance Parameter Model Mixed Source Samples

### 6.7.1—Overview

The peak imbalance parameter or effective amplified quantity (EAQ) is manifested in a crime profile through a reduction of peak heights for high molecular weight alleles. In this section a model for quantifying EAQ is described. Methods for estimating EAQ parameters and deploying them for a profile in a locus are also given.

We model EAQ prior to any knowledge of the suspect's genotype. For each locus we associate molecular weight of the peaks in the profiles with the sum of heights. As the molecular weight of the locus increases we estimate the reduction in the sum of peak heights.

### 6.7.2—Details

Assume that in locus l(i) we have the set of peak heights hₗ₍ᵢ₎={h_{j,l(i)}: j=1, . . . , nₗ₍ᵢ₎}. Each height has an associated base pair count bₗ₍ᵢ₎={b_{j,l(i)}: j=1, . . . , nₗ₍ᵢ₎}. An average base pair count, weighted by peak heights, is used as a measure of molecular weight for the locus. More specifically, this is defined as:

$${χ}_{l ( i )} = {\sum }_{j = 1}^{{n}_{l ( i )}} {h}_{j , l ( i )}$$

where

$${χ}_{l ( i )} = {\sum }_{j = 1}^{{n}_{l ( i )}} {h}_{j , l ( i )}$$

We define the EAQ model as:

χₗ₍ᵢ₎=d₁+d₂ b̅ₗ₍ᵢ₎

where d₁ and d₂ are the same for all loci.

The sum of peak heights χₗ₍ᵢ₎ is assumed to be a linear function of the weighted base-pair average,

$${\overline{b}}_{l ( i )} = \frac{{\sum }_{j = 1}^{n} {b}_{j , l ( i )} {h}_{j , l ( i )}}{{χ}_{l ( i )}} .$$

### 6.7.3—Estimation of Peak Imbalance Parameters d₁ and d₂

The parameters d₁ and d₂ are calculated using least squared estimation. However some loci may behave differently, and therefore the sum of peak heights of these loci can be treated as outlier. We use a Jackknife method to deal with this problem. There are n_{L} loci with peak height and base pair information.
1. We fit the regression model n_{L} times, removing the i^{th} value of the sets

{χₗ₍ᵢ₎:i=1, . . . n_{L}} and { b̅ₗ₍ᵢ₎:i=1, . . . n_{L}}.
2. We use least-squares estimation to produce a prediction interval, \hat{χ}ₗ₍ᵢ₎±2σ, where σ is the standard deviation of the residuals in the fitted regression line.
3. If the sum of peak height χᵢ which was not used for the estimation of the regression line, does not lie within the prediction interval then we consider it an outlier.
4. After the n_{L} models have been produced we remove any outliers from the dataset and re-fit the model. The values of d₁ and d₂ are extracted from the model estimated without outliers.

If the degradation in the profile is negligible, peak height variability may cause the estimated value of to be greater than zero. In this case we set d₂=0 and d₁=1.

### 6.7.4—Deploying the Peak Imbalance Parameter Model

The peak imbalance parameter or EAQ model is used for taking into account EAQ within a locus. EAQ between loci is taken account by conditioning on the sum of peak height per locus. The EAQ model is used when the pdf of the peak heights for single and two-person profiles is deployed. More specifically, it is deployed for each heterozygote donor. In this section we describe the calculation of the EAQ factors δ₁ and δ₂ to be used for deploying pdf for peak heights.

Assume that at locus l(i) we have a putative heterozygote donor with alleles a₁,l(i) and a₂,l(i) with corresponding molecular weights in base pairs b₁,l(i) and a₂,l(i), respectively. If we were not considering EAQ, given the sum of peak heights χₗ₍ᵢ₎ for this locus we can obtain a mean μₗ₍ᵢ₎ and variance σₗ₍ᵢ₎² of a Gamma distribution that models the behaviour of a peak height. In other words, if H_{j,l(i)} denotes the random variable for the height corresponding the allele s_{j,l(i)}, then:

H_{j,l(i)}˜Γ(μₗ₍ᵢ₎,σₗ₍ᵢ₎²|χₗ₍ᵢ₎,j=1,2.

The same Gamma pdf is used for any allele in the locus. The EAQ model issued to adapt the Gamma pdf by taking into account the molecular weight of the allele. The EAQ model is used to calculate a pair of factors δ₁ and δ₂ so that the mean values of the Gamma distribution are adjusted accordingly. The new mean is given by:

μ_{j,l(i)}=δxμₗ₍ᵢ₎,j=1,2.

In the rest of the section we describe a method for calculating δ₁ and δ₂ using the slope d₂ of the EAQ regression line. The first condition that the δ's must fulfill is that the slope of a line going through the coordinates (b_{1,l(i)},μ_{1,l(i)}) and (b_{2,l(i)},μ_{2,l(i)} is the same as the slope d₂ of the EAQ regression line, i.e.:

$$\frac{{μ}_{1 , l ( i )} - {μ}_{2 , l ( i )}}{{b}_{1 , l ( i )} - {b}_{2 , l ( i )}} = {d}_{2}$$

The second condition that the δ's must fulfilled is the preservation of the mean μₗ₍ᵢ₎:

$$\frac{{μ}_{1 , l ( i )} - {μ}_{2 , l ( i )}}{2} = {μ}_{l ( i )}$$

### Substituting

$${μ}_{j , l ( i )} = δ \times {μ}_{l ( i )} , \\ j = 1 , 2 \cdot in \frac{{μ}_{1 , l ( i )} - {μ}_{2 , l ( i )}}{{b}_{1 , l ( i )} - {b}_{2 , l ( i )}} = {d}_{2}$$

$$and$$

$$\frac{{μ}_{1 , l ( i )} - {μ}_{2 , l ( i )}}{2} = {μ}_{l ( i )}$$

we obtain two equations with two unknowns δ₁ and δ₂. The solution of the equations is

$${δ}_{1} = \frac{{d}_{2} ( {b}_{1 , l ( i )} - {b}_{2 , l ( i )} + 2 {μ}_{l ( i )}}{2 {μ}_{l ( i )}}$$

$${δ}_{2} = 2 - {δ}_{1}$$

The stutter associated with the allelic peak will have the same degradation factor because it is the starting DNA molecules of the allele that is affected by degradation.

### 6.7.5—Other Information

1. In the present version of the model we are not using the peak heights of Amelo for calculating the EAQ line, however, it is deployed for this locus.
2. The maximum value that δ₁ can take in 1.9 because if δ₁≧2, δ₂=2−δ₁ is not positive.

### 7. ALTERNATIVE APPROACH

### Model for a Single Allelic and Stutter Peak

### 7.1—Background

In Section 7 and 8 an alternative approach is sued to that set out above. The alternative approach is a development of those set out above and shares a common approach, but with modifications and significant alterations.

In this approach, the model differs and the manner in which the parameters are defined and are determined differs.

The approach uses linear regression to get the parameters. A significant detail is that the mean and the variance of the peak heights observed increase at the same rate for both allelic and stutter peaks heights; as demonstrated in equation New 17 below.

The approach provides an estimate of the κ parameters, as detailed below. A particular method for reaching that estimate is given, but other statistical approaches can be used. The approach is particularly beneficial because of the manner in which it treats the parameters in the dropout region, again discussed further below in section 7.4.

Whilst the values obtained for the parameters etc may be experimental protocol and multiplex specific, the approach is generally applicable and so can be used widely. Experimental data can be collected according to differing protocols and/or multiplexes to feed to the approach and obtain the parameters etc.

### 7.2—Model Specification

The Gamma family of distributions is a flexible class of unimodal, but (usually) asymetric pdf's. The family can be parameterised in different ways. In this case, the shape α and rate β parameters are used. In the model, a peak, whether it is allelic or stutter, is assumed to follow a Gamma distribution:

Hₐ^{(l)}˜Gamma(αₐ^{(l)},βₐ^{(l)}), and Hₛ^{(l)}˜Gamma(αₛ^{(l)},βₛ^{(l)}) (New 13)

where Hₐ^{(l)} and Hₛ^{(l)} are the heights of an allelic and stutter peaks respectively. The corresponding pdf's are denoted ƒₐ and ƒₛ.

The parameters are obtained from the mean μ and the standard deviation σ using the equations:

$$α = \frac{{μ}^{2}}{{σ}^{2}} \\ and \\ β = \frac{μ}{{σ}^{2}} \qquad ( New 14 )$$

The means and variance are modelled with the linear equations:

$$\begin{matrix}{μ}_{a}^{( l )} = {κ}_{1 , a}^{( l )} \times \frac{{χ}^{( l )}}{{bp}_{a}^{( l )}} , \\ {μ}_{s}^{( l )} = {κ}_{1 , s}^{( l )} \times \frac{{χ}^{( l )}}{{bp}_{s}^{( l )}} & ( New 15 ) \\ {( {σ}_{a}^{( l )} )}^{2} = {κ}_{2}^{( l )} \times {μ}_{a}^{( l )} , \\ {( {σ}_{s}^{( l )} )}^{2} = {κ}_{2}^{( l )} \times {μ}_{s}^{( l )} & ( New 16 )\end{matrix}$$

Where χ^{(l)} is the peak height sum at the locus l; bpₐ^{(l)} is the number of base pairs of allele a; and s is the stutter of a. κ_{1,a}^{(l)}, κ_{1,s}^{(l)} and κ₂^{(l)} are the parameters that drive the model, hereinafter referred to as the κ parameters, and are estimated from the profile data described in section 7.3 below.

For computational efficiency, the alleles that are not in a_{c}^{(l)} are collected into allele q^{(l)}. The base count for q^{(l)} the average base count of alleles that have non-zero count in at least one of the ethnic appearance databases of the multiplex.

In contrast to some other linear models, this approach introduces more components, including the model for stutter to work in tandem with the model for alleles and the use of base pair counts for accounting for molecular weight because it is more closely related to the actual molecular weight of the alleles.

The model incorporates the assumption that Hₐ^{(l)} is independent of Hₛ^{(l)} given χ^{(l)} and bpₐ^{(l)} where Hₛ^{(l)} is the stutter of parent allele. This assumption is motivated by the process of DNA duplication using PCR. Allelic peak height and its corresponding stutter height depend upon the starting amount of DNA: the more DNA the bigger the peaks. Here we use χ^{(l)} as a proxy for DNA quantity.

The α and β parameters are obtained from equations new 15 and new 16 using equation new 14 above.

$${α}_{i}^{( l )} = \frac{{κ}_{1 , i}^{( l )}}{{κ}_{2}^{( l )}} \times \frac{{χ}^{( l )}}{{bp}_{a}^{( l )}} , \\ i = a , s \\ and \\ \begin{matrix}{β}_{a}^{( l )} = {β}_{s}^{( l )} \\ = \frac{1}{{κ}_{2}^{( l )}}\end{matrix} \qquad ( New 17 )$$

Sharing a common β parameter allows the construction of a pdf for a questioned profile c^{(l)} as described in section 8 below, through the addition of independent Gamma variables and the analytic construction of a Dirichlet pdf:

if χ₁˜Gamma(αᵢ,β),i=1,2, . . . ,n,

$${\sum }_{i = 1}^{n} {X}_{i} \sim Gamma ( {\sum }_{i = 1}^{n} {α}_{i} , β )$$

$$and \\ ( {π}_{1} , {π}_{2} , … , {π}_{n} ) \sim Dirichlet ( {α}_{1} , {α}_{1} , … , {α}_{1} , ) ,$$

where πⱼ=χⱼ/Σᵢ₌₁ⁿXᵢ. This is the fastest way to calculate probability densities for c^{(l)}. The computational complexity in the calculation of likelihood ratios, LR's, for two or three person profiles is high and so this feature becomes important.

Notice that the condition for βₛ^{(l)}=βₐ^{(l)} is fulfilled if equation new 16 holds. The functions that link μₐ^{(l)} and μₛ^{(l)} with DNA quantity proxy χ^{(l)} and the proxy for molecular weight bpₐ^{(l)} do not have restrictions other than representing the data; moreover the linking functions of μₐ^{(l)} and μₛ^{(l)} do not need to be the same. In this approach, a linear function has been chosen with an adjustment for the dropout region. The approach can be used for a wide range of multiplexes and protocols for producing profiles, but the linking function can be different in those and/or the values obtained may vary between different multiplexes and protocols.

### 7.3—Parameter Estimation

In this approach, dropout probabilities are obtained from the cumulative probability distribution (cdf) of a Gamma distribution. The κ parameters of the model are estimated using the whole data set, which contains peak heights where allelic dropout is possible. To address the accuracy of dropout probabilities the κ parameters are adjusted for the dropout region, as explained in section 7.4 below.

The κ parameters are estimated from a set of profiles produced under laboratory conditions using the protocol applicable and the multiplex which is applicable.

In this instance, profiles were produced using SGMPlus™ multiplex kit from Applied Biosystems. Fourteen volunteers donated buccal swabs of DNA. The DNA was extracted and diluted to simulate the starting amount of DNA in questioned samples. The range of target quantities, in picograms, were 50, 100, 150, 200, 300, 400, 500, 750, 1000, 1500. The diluted samples were amplified in duplicate at 28 cycles using a Tetrad™ thermocycler from Genetic Technologies Inc of Miami, Fla. Detection was performed in duplicate using capillary electrophoresis on a 3100-XL Genetic Analyser from Applied Biosystems with injection parameters of 1.5 keV for 10 seconds. The resulting profiles were analysed using DNAInsight v2 software from Forensic Science Service Limited to obtain the allele designations and peak height. The detection threshold selected was 30 rfu; i.e. peaks below 30 rfu were recorded as zero because peaks below this threshold are too close to the signal noise of an EPG. A total of 500 profiles were produced.

To estimate the variability of peak heights of stutters and alleles separately, the peak height data was collected only from non-adjacent heterozygotes; that is one of the alleles is not in stutter relative to the other. For example, a donor with genotype 16, 18 is a non-adjacent heterozygote while a donor with genotype 15, 16 is an adjacent heterozygote. A total of 1108 heterozygotes loci were used to estimate the κ parameters.

For each locus where the genotype of the donor is {aₐ,a₂} the data consisted of

{h_{a,1}^{(l)},h_{s,1}^{(l)},bp_{a,1}^{(l)},h_{a,2}^{(l)},h_{s,2}^{(l)},bp_{a,2}^{(l)}}

where h_{a,i} and h_{s,i} is the height of the alleles and stutters, respectively and bp_{a,i} is the base pair count of allele aᵢ,i=1,2. The data is augmented with χ^{(l)} calculated as the sum of the peak heights i.e. χ^{(l)}=h_{a,1}+h_{s,1}+h_{a,2}+h_{s,2}. The data set is split into two: one for alleles and the other for stutters. Each locus contributed to two rows in these data sets: {h_{a,1},bp_{a,1},χ^{(l)}} and {h_{a,2},bp_{a,2},χ^{(l)}} for alleles and {h_{s,1},bp_{a,1},χ^{(l)}} and {h_{s,2},bp_{a,2},χ^{(l)}} for stutters. Hereafter, the allele and the stutter data are denoted

{h_{a,i}^{(l)},bp_{a,i}^{(l)},χᵢ^{(l)}:i=1,2, . . . ,nₐ} and {h_{s,i}^{(l)},bp_{a,i}^{(l)},χᵢ^{(l)}i=1,2, . . . ,nₛ} (new 18)

respectively, where the index h_{a,i} now denotes a row number.

The estimation of the κ parameters is achieved iteratively using the EM algorithm (Dempster et al., Maximum likelihood from incomplete data via the EM algorithm. Journal of the Royal Statisitcal Society, Series B, 39(1):1-38, 1977). The components are described in the sub-sections below.

### Replace Zero Peak Heights

In the first iteration peak heights recorded as zeros, in both the allele and stutter data sets, are replaced with a random sample from a continuous uniform distribution in the interval (0, 30) according to the Gamma distributions estimated in the previous iteration.

### Estimation of κ_{1,a} and κ_{1,s}

Parameter κ_{1,a}^{(l)} is estimated from the allele data set using least squared estimation where Hₐ is the response variable and χ^{(l)}/bpₐ^{(l)} is the covariate and the intercept is set to zero. FIG. 27a shows an example of the estimated κ_{1,a}^{D16} for locus D16. The regression line through the data is determined by κ_{1,a}^{D16}. Parameter κ_{1,s} is estimated in the same way using the stutter data set. FIG. 27b shows an example of the estimated κ_{1,s}^{D16} for locus D16.

### Estimation of κ₂^{(l)}

Parameter κ₂^{(l)} is calculated by minimising a joint negative log-likelihood function

$$NLL ( {κ}_{2}^{( l )} ) = - {\sum }_{{h}_{a}^{( l )}}^{ } log \{ {f}_{a} ( {h}_{a}^{( l )} \vert {α}_{a}^{( l )} , {β}_{a}^{( l )} ) \} - {\sum }_{ {h}_{s}^{( l )}}^{ } log \{ {f}_{s} ( {h}_{s}^{( l )} \vert {α}_{s}^{( l )} , {β}_{s}^{( l )} ) \}$$

where ƒₐ and ƒₛ are Gamma pdfs for allelic and stutter peak heights, respectively, and the \dot{α} and β parameters are given in equation new 17.

The κ parameter estimates are given in Table Y1. A diagrammatic representation of the estimation process is given in FIG. 31

TABLE Y1

| Locus | κ_{1,a}^{(l)} | κ_{1,s}^{(l)} | κ₂^{(l)} |
|---|---|---|---|
| D3 | 60.76 | 4.15 | 5.4 |
| VWA | 85.22 | 5.46 | 5.9 |
| D16 | 123.91 | 6.92 | 6.1 |
| D2 | 145.38 | 10.23 | 4.5 |
| Amelo | 54.95 | | 4.1 |
| D8 | 69.59 | 3.89 | 4.7 |
| D21 | 99.72 | 5.78 | 4.7 |
| D18 | 138.23 | 10.39 | 6.4 |
| D19 | 58.65 | 4.34 | 4.3 |
| THO | 89.96 | 1.85 | 3.1 |
| FGA | 111.34 | 6.77 | 3.2 |

### 7.4—Parameters in the Dropout Region

Allelic dropout may be of concern to courts considering forensic evidence. In this section, the behaviour of the model in the dropout region is considered further for both allelic and stutter peaks.

The model above provides an estimate based on the whole of the distribution. However, this can lead to the tail of the distribution, the dropout region, not being a good fit. The approach, therefore, considers this region separately and modifies the position accordingly; as detailed below. This involves using the whole distribution basis for much of the data, but in or near the dropout region making the modification. The modification involves fixing the β parameter and adjusting the α parameter to get a better model. In effect, a pivot point is introduced into the mean line and the gradient is different below that pivot point.

The model for alleles is estimated from data set {χᵢ^{(l)}/bp_{a,i}^{(l)},h_{a,i}^{(l)}: i=1, 2, . . . , n}, where n is the number of data pairs. Dropout probabilities from the model and estimated from the data are compared in the dropout region:

(0,1.5×max{χᵢ^{(l)}/bp_{a,i}^{(l)}:h_{a,i}^{(l)}<30,for_all_{—}i}) (New 19)

The factor 1.5 is selected to look at the transition from the dropout to non-dropout regions. FIG. 28a shows dropout probabilities estimated from data, from the model and from the adjusted model calculated as described below. As can be seen, the model is above the data and so an adjusted model is used to drop the model onto the data.
4. The dropout probabilities from the model are obtained form the cdf of a Gamma distribution F(30|α,β). The α and β parameters are obtained from the κ parameters,
5. The dropout probabilities from the data are calculated from discrete intervals of the dropout region. The intervals were selected suing the method of Friedman et al., On the histogram as a density estimator: L2 theory. Probability Theory and Related Fields 57:453-476, 1981, 10.1007/BF01025868.
6. The calculation of adjusted model dropout probabilities is more involved and follow the following steps:
   a. For each dropout probability \hat{p} estimated from data, an α parameter is obtained so that \hat{p}≈F(30,\hat{α},β) where β=1/κ₂^{(l)}. FIG. 28b shows the \hat{α}̂parameters obtained in this way for D3.
   b. The α parameters for the midpoint of the discrete intervals were obtained and plotted, FIG. 28a.
   c. To correct the α parameters, a straight line was anchored at the α from the model corresponding to the last midpoint plus twice the bin size. This was done to cover an area of transition. The intercept of the line was selected so as to minimise the Euclidean distance of the α from the line and the \hat{α}. The resulting line was plotted with a dashed line in FIG. 28b. The adjusted dropout probabilities are also plotted with a dashed line, FIG. 28a. This provides the pivot point and change in gradient.

The same process was applied to allelic and stutter peaks. FIG. 29b shows the plot of the α parameter for stutter and FIG. 29a the plot of the dropout probabilities, as adjusted.

The adjusted α parameters are calculated from the intercept and the slope of the fitted line in the dropout region. If χ^{(l)}/bpₐ^{(l)} is smaller than the upper limit of the dropout region for alleles

$${α}_{i}^{( l )} = intercept + slope x \frac{{χ}^{( l )}}{{bp}_{a}^{( l )}} \qquad ( New 20 )$$

where i=a and intercept and slope are estimated as described above and reported in Table X1 below. Similarly, if χ^{(l)}/bpₐ^{(l)} is smaller than the upper limit of the dropout region for the stutters, we use the same equation with i=s and intercept and slope taken from Table X1 below. The dropout probabilities for stutters for locus THO1 were not adjusted because they are mostly 1.

The above approach estimates dropout parameters from experimental data and so includes an account for all sources of variation that led to allelic dropout, and not just those selected and built into a theoretical model. The consideration of stutter dropout in the model is also estimated from data.

### 8. ALTERNATIVE APPROACH

### Construction of the Factor

### 8.1—Background

In the sections above, an approach to the construction of the factor ƒ(Cₗ₍ᵢ₎|gₗ₍ᵢ₎,χₗ₍ᵢ₎,δ) where gₗ₍ᵢ₎ is the genotype of the donor of sample Cₗ₍ᵢ₎, δ is an effect parameter and χₗ₍ᵢ₎ denotes the quantitative measure, for instance peak-height sum or peak area sum, for the locus i was provided. In a particular form, this factor was defined as: ƒ(cₗ₍ᵢ₎|g_{1,l(i)},g_{2,l(i)},ω,χₗ₍ᵢ₎,δ) where g_{1,l(i)} is one of the genotypes of the donor of sample cₗ₍ᵢ₎,g_{2,l(i)} is another of the genotypes of the donor of the sample cₗ₍ᵢ₎, δ is an effect parameter and χₗ₍ᵢ₎ denotes the quantitative measure, for instance peak-height sum or peak area sum, for the locus i and ω is the mixing proportion.

In this section, the construction of an alternative form for the factor is provided. That factor can be expressed as ƒ(c^{(l)}|g₁^{(l)},ω,χ^{(l)}) where g₁^{(l)} is the genotype of the donor of sample c^{(l)}, χ^{(l)} denotes the quantitative measure, for instance peak-height sum or peak area sum, for the locus i and ω is the mixing proportion.

More specifically the factor can be expressed as: ƒ(c^{(l)}|g₁^{(l)},g₂^{(l)},ω,χ^{(l)}) where g₁^{(l)} is one of the genotypes of the donor of sample c^{(l)}, g₂^{(l)} is another of the genotypes of the donor of the sample c^{(l)}, and χ^{(l)} denotes the quantitative measure, for instance peak-height sum or peak area sum, for the locus i and ω is the mixing proportion.

The nomenclature used differs between the above sections and this approach, but the fundamentals of the approach and terms in the factor are related.

χ^{(l)} as the sum of all the peak heights in a locus is a proxy for the DNA quantity at that locus. By considering the size of the alleles in and across the loci, and considering the loci themselves, the modified approach is able to better account for degradation as that is locus and size dependant. By considering the size of the alleles in and across loci, the modified approach is able to better account for amplification efficiency as that is size dependant. The modified approach is also better able to account for inhibition arising from the quantity of DNA present, as that can inhibit lower sizes to a greater extent than larger ones. The modified approach is also better able to account for chemical inhibition, for instance when this arises from the environment the sample was collected from, for instance the presence of a particular dye.

Through the use of Gamma distributions for each allele and the parameters used to define those, the modified approach offers significant improvement. Generally, the β parameter is the same for alleles in a locus, but differs between loci. Generally, the α parameter is the parameter which is used to effect the changes within a locus. The same approach is taken for allelic and stutter peaks.

### 8.2—Details

The construction of ƒ(c^{(l)}|g₁^{(l)},g₂^{(l)},ω,χ^{(l)}) is achieved in two steps. In the first step, the α parameters for the alleles and stutters of genotypes g₁^{(l)} and g₂^{(l)} are calculated. In the second step, the factors of the probability density functions, pdf's, are determined.

The genotypes of the major and minor donors in the mixture are denoted as gₗ₍ᵢ₎={a_{gi,1}, a_{gi,2}}, i=1,2 respectively. The base pair counts of the alleles are denoted with the same indices, i.e. bp_{gi,j}

Is the base count of a_{gi,j}. A total of eight α parameters are obtained:

A_{g1,g2}^{(l)}={α_{a,g1,1}^{(l)},α_{s,g1,1}^{(l)}α_{a,g1,2}^{(l)}α_{s,g1,2}^{(l)}α_{a,g2,1}^{(l)}α_{s,g2,1}^{(l)}α_{a,g2,2}^{(l)}α_{s,g2,2}^{(l)}}, (New 21)

where a_{i,gi,k}^{(l)} is the α parameter for either an allele (i=a) or a stutter (i=s), for the major (j=1) or the minor (j=2) donors for the first (k=1) or second (k=2) allele of the corresponding genotype.

The calculation of α_{a,g1,1} and α_{s,g1,1} is described below. The other such parameters are obtained in an similar manner. The major donor contributes with (ω×100) % of the DNA, and so, we first calculate ωχ/bp_{g1,1}. If this number is greater than the upper limit of the dropout region for alleles, given in Table X1, then the α parameter is calculated using equation (New 17):

$${α}_{i}^{( l )} = \frac{{κ}_{1 , i}^{( l )}}{{κ}_{2}^{( l )}} \times \frac{{χ}^{( l )}}{{bp}_{a}^{( l )}} , \\ i = a , s \\ and \\ \begin{matrix}{β}_{a}^{( l )} = {β}_{s}^{( l )} \\ = \frac{1}{{κ}_{2}^{( l )}}\end{matrix} \qquad ( New 17 )$$

otherwise it is calculated using equation (New 20):

$${α}_{i}^{( l )} = intercept + slope \times \frac{{χ}^{( l )}}{{bp}_{a}^{( l )}} \qquad ( New 20 )$$

Similarly, if ωχ/bp_{g1,1} is greater than the upper limit of the dropout region for stutter, α_{s,g1,1} is calculated using eqn (New 17) and otherwise using eqn (New 20).

TABLE X1

| | | | Stutter | | | Allele |
|---|---|---|---|---|---|---|
| | Stutter | Stutter | Upper | Allele | Allele | Upper |
| Locus | Intercept | Slope | Limit | Intercept | Slope | Limit |
| D3 | 0.4 | 0.75 | 22.57 | 2.65 | 9.33 | 1.38 |
| VWA | 0.83 | 0.88 | 20.13 | 2.1 | 13.48 | 2.19 |
| D16 | 0.01 | 1.13 | 12.14 | 3.08 | 11.92 | 0.37 |
| D2 | 0.96 | 2.12 | 6.15 | 3.14 | 27.56 | 0.66 |
| Amelo | — | — | — | 2.53 | 12.5 | 2.82 |
| D8 | 0.43 | 0.8 | 16.0 | 2.18 | 14.03 | 2.82 |
| D21 | 0.8 | 1.18 | 15.17 | 2.47 | 19.71 | 1.64 |
| D18 | 0.69 | 1.56 | 10.2 | 3.37 | 15.27 | 0.53 |
| D19 | 0.63 | 0.97 | 15.87 | 4.1 | 10.25 | 1.21 |
| THO | — | — | — | 5.26 | 27.09 | 0.68 |
| FGA | 0.26 | 2.09 | 9.53 | 3.86 | 24.89 | 0.93 |

The α parameters for donor 2 are calculated using the same method using (1−ω)χ/bp_{g2,k} instead of ωχ/bp_{g1,k}, k=1,2.

The α parameters are grouped, according to the shared positions of alleles and stutters of the donor genotypes. Formally, we define the cover of g₁^{(l)} and g₂^{(l)} as:

cover(g₁^{(l)},g₂^{(l)}=∪_{j=1,2; k=1,2}{a_{gi,k}a_{gi,k}−1} (New 22)

For an allelic position a in cover(g₁^{(l)},g₂^{(l)})

αₐ^{(l)}=ρ{αεA_{g1,g2}^{(l)}:a=a_{gi,j}^{(l)} or a^{(l)}=s_{gi,j}^{(l)},i,j=1,2} (New 23)

In words, the α parameters for alleles and stutters that fall in allelic position a are added up to overall αₐ^{(l)} for this position.

The set of peaks in c^{(l)} correspond to a subset of allelic positions in cover(g₁^{(l)},g₂^{(l)}), i.e. a_{c}^{(l})⊂cover(g₁^{(l)},g₂^{(l)}). Allelic positions in cover(g₁^{(l)},g₂^{(l)})\a_{c}^{(l)} correspond to peaks that have dropped out. The pdf is:

$$f ( {c}^{( l )} \vert {g}_{1}^{( l )} , {g}_{2}^{( l )} , ω , {χ}^{( l )} = [ {\sum }_{a ∈ cover ( {g}_{1}^{( l )} , {g}_{2}^{( l )} ) \backslash {a}_{c}^{( l )}}^{ } F ( 30 \vert {α}_{a}^{( l )} , {β}^{( l )} ) ] \times f ( \{ {π}_{a} \text{:} a ∈ {a}_{{c}^{( l )}} \} \vert {α}_{a} \text{:} a ∈ {a}_{{c}^{( l )}} \} ) \qquad ( New 24 )$$

where F is a Gamma cumulative density function and f is the pdf of a Dirichlet distribution.

### 8.3—Example

Consider the questioned profile c^{vWA} displayed in FIG. 30. The putative donors have genotypes g₁^{vWA}={17,18} and g₂^{vWA}={16,19} and the mixing proportion is ω=0.9. The peak heights of c^{vWA} and the base pair counts of the alleles in g₁^{(l)} and g₂^{(l)} are given in the following table, TABLE X2.

TABLE X2

| Allelic position | Peak height | g₁^{vWA} | g₂^{vWA} | Base pair count |
|---|---|---|---|---|
| 16 | 50 | | ◯ | 177 |
| 17 | 500 | ◯ | | 181 |
| 18 | 400 | ◯ | | 185 |
| 19 | 50 | | ◯ | 189 |
| χ^{vWA} | 1000 | | | |

The peak height sum assigned to donors 1 and 2 are χω^{vWA}=900 and (1−ω)χ^{vWA}=100. The cover of the donor genotypes is cover (g₁^{vWA},g₂^{vWA})={15,16,17,18,19}. The α parameters for stutters and alleles are calculated for each allele of the donors. We show the calculation for allele 17 of donor 1.

We first compute the ratio ωχ/bp₁₇^{vWA}=4.9724. The upper limit for the dropout region of alleles is 2.19 and ωχ/bp₁₇^{vWA} so falls outside the dropout region. The α parameter is thus calculated as

$$\begin{matrix}{a}_{a , g 1 , 1}^{vWA} = \frac{{κ}_{1 , a}^{vWA}}{{κ}_{2}^{vWA}} \times \frac{{ωχ}^{vWA}}{{bp}_{17}^{vWA}} \\ = 71.82\end{matrix} \qquad ( New 25 )$$

The upper limit of the dropout region for stutters is 20.13 and so ωχ^{vWA}/bp₁₇^{vWA} falls inside the dropout regions of stutters. The α parameter for stutter in allelic position 16 is calculated as:

$$\begin{matrix}{α}_{s , g 1 , 1}^{wWA} = intercept + slope \times \frac{{ωχ}^{vWA}}{{bp}_{17}^{vWA}} \\ = 5.21\end{matrix} \qquad ( New 26 )$$

where single intercept and slope are taken from Table X1 above. The resulting a parameters are given in Table X3 vWA below. The columns correspond to the allelic positions in cover (g₁^{vWA},g₂^{vWA}). The rows correspond to alleles in g₁^{vWA} and g₂^{vWA}. The last row contains the α parameters for the allelic positions in the cover, e.g. α₁₇^{vWA}=76.93.

The set cover (g₁^{vWA},g₂^{vWA})={15}∪ₐ_{_{c}}_{^{vWA}} and so the required pdf is:

ƒ(c^{(l)}|g₁^{(l)},g₂^{(l)},ω,χ^{(l)}=F)(30|α₁₅^{vWA},β^{vWA})xƒ(π₁₆,π₁₇,π₁₈,π₁₉,|α₁₆^{vWA},α₁₇^{vWA},α₁₈^{vWA},α₁₉^{vWA}) (New 27)

TABLE X3
(α parameters for the peaks in the profile)

| | 15 | 16 | 17 | 18 | 19 |
|---|---|---|---|---|---|
| 17 | | 5.21 | 71.82 | | |
| 18 | | | 5.11 | 70.27 | |
| 16 | 1.33 | 9.67 | | | |
| 19 | | | | 1.30 | 9.19 |
| αₐ^{vWA} | 1.33 | 14.88 | 76.93 | 71.57 | 9.19 |

1. A method of comparing a test sample result set with another sample result set, the method comprising:
providing information for the first result set on the one or more identities detected for a variable characteristic of DNA;
providing information for the second result set on the one or more identities detected for a variable characteristic of DNA; and
comparing at least a part of the first result set with at least a part of the second result set.

2. A method according to claim 1, in which the method comprises:
a consideration of the size of the alleles in one or more loci; and/or
a consideration of the size of the alleles across two or more loci; and/or
a consideration of the identity of the loci; and
the provision of an adjustment arising there from.

3. A method according to claim 2, wherein the adjustment is provided to account for degradation and/or amplification efficiency and/or inhibition.

4. A method according to claim 1, wherein the method includes the use of a likelihood ratio and the numerator and/or denominator are presented in a form based around the core pdf:
ƒ(c^{(l)}|g₁^{(l)},ω,χ^{(l)})
where g₁^{(l)} is the genotype of the donor of sample c^{(l)}, χ^{(l)} denotes the quantitative measure for the locus i and ω is the mixing proportion; and/or
ƒ(c^{(l)}|g₁^{(l)},g₂^{(l)},ω,χ^{(l)})
where g₁^{(l)} is one of the genotypes of the donor of sample c^{(l)}, g₂^{(l)} is another of the genotypes of the donor of the sample c^{(l)}, and χ^{(l)} denotes the quantitative measure for the locus i and ω is the mixing proportion.

5. A method according to claim 1, wherein the method of comparing includes a comparison in the form of a likelihood ratio in which the denominator is of the form:
Den=ƒ(c|gₛ,H_{d})
where
c is the first or test result set from a test sample;
gₛ is the second or another result set;
H_{d} is one hypothesis; and
the denominator includes the factor ƒ(c^{(l)}|g₁^{(l)},ω,χ^{(l)}), where g₁^{(l)} is the genotype of the donor of sample c^{(l)}, χ^{(l)} denotes the quantitative measure for the locus i and ω is the mixing proportion; and/or the factor ƒ(c^{(l)}|g₁^{(l)},g₂^{(l)},ω,χ^{(l)}), where g₁^{(l)} is one of the genotypes of the donor of sample c^{(l)}, g₂^{(l)} is another of the genotypes of the donor of the sample c^{(l)}, and χ^{(l)} denotes the quantitative measure for the locus i and ω is the mixing proportion.

6. A method according to claim 1, wherein the method provides the use of a Gamma distribution as the form of the distribution used to represent a peak in the method, and the Gamma distribution is defined by one or more parameters, including a shape parameter α and/or a rate parameter β.

7. A method according to claim 4, wherein the method provides that the construction of ƒ(c^{(l)}|g₁^{(l)},g₂^{(l)},ω,χ^{(l)}) includes two or more steps:
in a first step, the a parameters for the alleles and stutters of genotypes g₁^{(l)} and g₂^{(l)} being calculated;
and/or
in a second step, the factors of the probability density functions, pdf's, being determined.

8. A method according to claim 1, wherein the method provides that the genotypes of the major and minor donors in the mixture are denoted as gₗ₍ᵢ₎={a_{gi,1}, a_{gi,2}}, i=1,2 respectively, and the base pair counts of the alleles are denoted with the same indices, bp_{gi,j} is the base count of a_{gi,j}, and in which a total of eight α parameters are obtained of the form:
A_{g1,g2}^{(l)}{α_{a,g1,1}^{(l)},α_{s,g1,1}^{(l)}α_{a,g1,2}^{(l)},α_{s,g1,2}^{(l)}α_{a,g2,1}^{(l)}α_{a,g2,1}^{(l)}α_{s,g2,1}^{(l)}α_{a,g2,2}^{(l)}α_{s,g2,2}^{(l)}},
where a_{i,gi,k}^{(l)} is the α parameter for either an allele (i=a) or a stutter (i=s), for the major (j=1) or the minor (j=2) donors for the first (k=1) or second (k=2) allele of the corresponding genotype and the method defined for the calculation of α_{a,g1,1} and α_{s,g1,1} is used in an equivalent manner to provide the parameters for other alleles and/or loci and/or genotypes.

9. A method according to claim 1, wherein the method provides that the major donor contributes with (ω×100) % of the DNA and in which the method provides for the calculation of ωχ/bp_{g1,1} and where:
if the number from this calculation is greater than the upper limit of the dropout region for alleles, then the α parameter is calculated using equation:
$${α}_{i}^{( l )} = \frac{{κ}_{1 , i}^{( l )}}{{κ}_{2}^{( l )}} \times \frac{{χ}^{( l )}}{{bp}_{a}^{( l )}} , \\ i = a , s$$
$$and$$
$$\begin{matrix}{β}_{a}^{( l )} = {β}_{s}^{( l )} \\ = \frac{1}{{κ}_{2}^{( l )}} ;\end{matrix}$$
and/or
if the number from this calculation is otherwise, then the α parameter is preferably calculated using equation
$${α}_{i}^{( l )} = intercept + slope x \frac{{χ}^{( l )}}{{bp}_{a}^{( l )}}$$

10. A method of comparing a first test, sample result set with a second another sample result set, the method comprising:
providing information for the first result set on the one or more identities detected for a variable characteristic of DNA;
providing information for the second result set on the one or more identities detected for a variable characteristic of DNA; and
wherein the method uses in the definition of the likelihood ratio the factor:
ƒ(c^{(l)}|g₁^{(l)},ω,χ^{(l)}),
where g₁^{(l)} is the genotype of the donor of sample c^{(l)}, χ^{(l)} denotes the quantitative measure for the locus i and ω is the mixing proportion and/or
ƒ(c^{(l)}|g₁^{(l)},g₂^{(l)},ω,χ^{(l)},
where g₁^{(l)} is one of the genotypes of the donor of sample c^{(l)}, g₂^{(l)} is another of the genotypes of the donor of the sample c^{(l)}, and χ^{(l)} denotes the quantitative measure.
